(19) United States
(12) Patent Application Publication
(10) Pub. No.: US 2015/0242416 A1
(43) Pub. Date: Aug. 27, 2015

(54) MANAGEMENT COMPUTER AND RULE GENERATION METHOD

(71) Applicant: HITACHI, LTD., Tokyo (JP)

(72) Inventors: Kaori Nakano, Tokyo (JP); Takayuki Nagai, Tokyo (JP); Masataka Nagura, Tokyo (JP)

(73) Assignee: Hitachi, Ltd., Tokyo (JP)

(21) Appl. No.: 14/427,400

(22) PCT Filed: Oct. 30, 2012
(86) PCT No.: PCT/JP2012/077995

§ 371 Date: Mar. 11, 2015

(51) Int. Cl. G06F 17/30; G06F 11/30

(52) U.S. Cl. CPC G06F 17/30082; G06F 11/3048; G06F 17/30864

(57) ABSTRACT

There is provided a management computer comprising a processor and a storage resource. The processor acquires information on a type of the first management object and the second management object; traces association from the type of the second management object to the type of the first management object; generates a metarule including a condition part and a conclusion part; generates a method of acquiring information on a topology constructed by the association from the type of the second management object to the type of the first management object based on a method of the trace from the type of the second management object to the type of the first management object; acquires the information on the topology based on the generated method; generates an expanded rule from the generated metarule and the acquired information on the topology; and analyzes a detected new failure based on the generated expanded rule.

### BACKGROUND OF THE INVENTION

A technology herein disclosed relates to an operation management method for a computer system.

When the computer system is managed, a phenomenon to be a cause is detected from a plurality of failures or symptoms of the failures detected in the system. Specifically, as disclosed in U.S. Pat. No. 7,107,185 B, management software is used to make various failures in a management subject apparatus or components constituting the management subject apparatus into events, thereby accumulating generation information on the events in an event database (DB). Moreover, the management software includes an analysis engine for analyzing causality of a plurality of events occurred on the management subject apparatus. The analysis engine makes access to a configuration management DB including configuration information on management subject apparatus, and recognizes relationships among a plurality of components across one or a plurality of management subject apparatus on a certain input/output (I/O) path as one group referred to as “topology”. Then, when an event occurs, the analysis engine applies a metarule constructed by a condition sentence and an analysis result defined in advance to a topology including a component on which the event has occurred, thereby constructing an expanded rule for analyzing a failure on each of the topologies. The expanded rule includes a conclusion event which can be a bottom cause, and a condition event group which results from generation of the conclusion event. Specifically, an event described in a THEN part of the rule is the conclusion event which can be a bottom cause, and an event described in an IF part is the condition event.

### SUMMARY OF THE INVENTION

The failure analysis system disclosed in U.S. Pat. No. 7,107,185 B prepares a plurality of correspondences each between a combination of events which can occur in a topology in a certain pattern and events which can be candidates of a cause of a failure in the topology in the certain pattern as rules in an IF-THEN form (hereinafter referred to as metarule).

Then, the failure analysis system searches the configuration management DB for configuration information on the management subject apparatus group having a pattern of topology to which each of the metarules can be applied, and generates a rule (hereinafter referred to as expanded rule) in an IF-THEN form representing a correspondence between a combination of events (including specific information on which apparatus the event occurs on) which can occur on the management subject apparatus and an event (including information on an apparatus of a cause) which can be a cause candidate of the failure if events in the combination occur.

The failure analysis system calculates a generation rate of the condition event described in the IF part of the expanded rule to calculate a certainty degree of the cause candidate described in the THEN part. The calculated certainty degrees and the cause candidates are displayed via a graphical user interface (GUI) as a user requests. Moreover, the condition events described in the IF part are also displayed as an influence range of the cause candidate described in the THEN part. As a result, the user can know that the received event is generated by which failure.

However, in the related-art failure analysis system, unless a rule in the IF-THEN form for the failure analysis is provided in advance, an analysis result appropriate for the user cannot be displayed. In other words, unless a rule corresponding to the received event is prepared in advance, the analysis cannot be correctly carried out. Therefore, an operation administrator for the system subject to the analysis is required to add lacking rules in order to correctly analyze a failure on the management subject system.

However, if a metarule is added, it is necessary to generate means for searching the configuration management DB for a topology to which the metarule can be applied. Therefore, it is necessary to understand how the configuration information such as a data model of the configuration management DB is managed in the failure analysis system for the operation administrator to add the metarule.

Moreover, a method of defining components in a management subject apparatus and types relating to a mutual relationship between the components, and declaring a model of an IT system by combining them, thereby defining policies of the IT system is publicly known. However, if a person who has defined the types and a person who declares the model of the IT system are not the same in this method, the person who declares the model needs to understand meanings of the respective types. Moreover, how to generate means for detecting actual management subject apparatus which match the declared model is not proposed.

Further, a technology of automatically applying effective policy rules depending on a network state is publicly known. However, this technology describes the policy rule for a management subject apparatus. Therefore, the number of rules to be input becomes very large in a large-scale IT system.

The representative one of inventions disclosed in this application is outlined as follows. There is provided a management computer for monitoring a plurality of node apparatus, comprising a processor, and a storage resource. The storage resource stores configuration information on a component included in each of the plurality of node apparatus, the configuration information including a type of the component. The each of the plurality of node apparatus and the component are managed as a management object. The processor receives an input of a combination of information for identifying a first management object relating to a first failure estimated as a cause and a type of the first failure, and an input of a combination of information for identifying a second management object relating to a second failure estimated to be caused by the first failure and a type of the second failure; acquires information on a type of the first management object and information on a type of the second management object; traces association from the type of the second management object to the type of the first management object; generates a metarule including a condition part including at least one condition element determined by a combination of a type of the management object and a type of the failure and a conclusion part including a combination of a type of the management object estimated as the cause and a type of the failure; generates a method of acquiring information on a topology constructed by the association from the type of the second management object to the type of the first management object based on a method of the trace from the type of the second management object to the type of the first management object; acquires the information on the topology based on the generated method; generates an expanded rule from the generated metarule and the acquired information on the topology; and analyzes, in case where a new failure is detected, the detected new failure based on the generated expanded rule.

According to embodiments of this invention, man hours by the user for generating the rules for the failure analysis can be reduced.

Objects, configurations, and effects which have not been described become apparent from a description of the following embodiments.

### BRIEF DESCRIPTION OF THE DRAWINGS

FIGS. 1A and 1B are block diagrams illustrating an example of a hardware architecture and a logical configuration of an information system according to a first example of this invention.

FIG. 2 is an explanatory diagram illustrating an example of a data structure of the event table according to the first example of this invention.

FIG. 3 is an explanatory diagram illustrating an example of a metarule residing in the metarule repository according to this example.

FIG. 4 is an explanatory diagram illustrating a table representing configuration information on apparatus whose type of management object is the server out of tables included in the configuration management DB according to the first example of this invention.

FIG. 5 is an explanatory diagram illustrating a table representing configuration information on apparatus whose type of management object is the FC switch out of the tables included in the configuration management DB according to the first example of this invention.

FIG. 6 is an explanatory diagram illustrating a table representing configuration information on apparatus whose type of management object is the storage out of the tables included in the configuration management DB according to the first example of this invention.

FIG. 7 is an explanatory diagram illustrating a table representing configuration information on component whose type of management object is the HBA out of the tables included in the configuration management DB according to the first example of this invention.

FIG. 8 is an explanatory diagram illustrating a table representing configuration information on component whose type of management object is the disk drive out of the tables included in the configuration management DB according to the first example of this invention.

FIG. 9 is an explanatory diagram illustrating a table representing configuration information on component whose type of management object is the logical volume out of the tables included in the configuration management DB according to the first example of this invention.

FIG. 10 is an explanatory diagram illustrating a table representing configuration information on component whose type of management object is the RAID group out of the tables included in the configuration management DB according to the first example of this invention.

FIG. 11 is an explanatory diagram illustrating a table representing configuration information on component whose type of management object is the storage port out of the tables included in the configuration management DB according to the first example of this invention.

FIG. 12 is an explanatory diagram illustrating a table representing configuration information on component whose type of management object is the storage disk out of the tables included in the configuration management DB according to the first example of this invention.

FIG. 13 is an explanatory diagram illustrating a table representing configuration information on component whose type of management object is the FC switch port out of the tables included in the configuration management DB according to the first example of this invention.

FIG. 14 is a class diagram illustrating associations among the respective management objects of an information system according to the first example of this invention.

FIGS. 15A and 15B are explanatory diagrams illustrating examples of a data structure of the association table according to the first example of this invention.

FIGS. 16A to 16E are explanatory diagrams illustrating examples of the topology acquisition method residing in the topology acquisition method repository according to the first example of this invention.

FIGS. 17A to 17C are explanatory diagrams illustrating examples of the expanded rule stored in the expanded rule repository according to the first example of this invention.

FIGS. 18A and 18B are flowcharts of an example of the metarule generation processing carried out by the metarule generation program on the management computer according to the first example of this invention.

FIG. 19 is an explanatory diagram illustrating an example of a cause event selection screen

FIG. 20 is an explanatory diagram illustrating an example of an influence event selection screen according to the first example of this invention.

FIG. 21 is a flowchart of an example of the topology search processing according to the first example of this invention.

FIGS. 22A and 22B are flowcharts of an example of the association search processing

FIGS. 23A and 23B are flowcharts of an example of the metarule candidate generation processing according to the first example of this invention.

FIG. 24 is a flowchart of an example of the topology acquisition method selection processing according to the first example of this invention.

FIGS. 25A and 25B are flowcharts of an example of the metarule verification information display processing according to the first example of this invention.

FIG. 26 is a flowchart of an example of the rule expansion processing according to the first example of this invention.

FIGS. 27A and 27B are flowcharts of an example of the failure analysis processing according to the first example of this invention.

FIG. 28 is a flowchart of an example of the metarule generation processing according to a second example of this invention.

FIG. 29 is a diagram illustrating an example of an event information input screen according to a second example of this invention.

FIG. 30 is a flowchart of an example of the topology search processing according to the second example of this invention.

FIG. 31 is a flowchart of an example of the association search processing according to the second example of this invention.

FIG. 32 is a flowchart of an example of the metarule candidate generation processing according to the second example of this invention.

FIGS. 33A and 33B are explanatory diagrams illustrating examples of a data structure of the association table according to a third example of this invention.

FIGS. 34A and 34B are flowcharts of an example of the topology acquisition method selection processing according to the third example of this invention.

FIG. 35 is a flowchart of an example of the topology acquisition method selection processing according to the third example of this invention.

FIGS. 36A and 36B are explanatory diagrams illustrating examples of a data structure of the association table according to the third example of this invention.

FIGS. 37A to 37F are explanatory diagrams illustrating examples of the expanded rules that are generated according to the third example of this invention.

### DETAILED DESCRIPTION OF THE PREFERRED EMBODIMENTS

A detailed description of this invention below refers to the accompanying drawings which constitute a part of the disclosure, but the drawings illustrate exemplary embodiments which can embody this invention, and do not limit the scope of this invention. Like numerals throughout a plurality of drawings denote like components in these drawings. Further, the detailed description provides various exemplary embodiments, but, as described and illustrated hereinafter, this invention is not limited to the embodiments described and illustrated herein, and it should be noted that this invention can be extended to other embodiments which are or will be publicly known to a person skilled in the art.

When “an embodiment”, “this embodiment”, or “this example” is herein referred, the reference means that specific characteristics, structures, and attributes described in relation to the embodiment are included in at least one embodiment of this invention, and even if these terms appear in respective parts of a description herein, all of them do not always refer to the same embodiment.

Moreover, many specific detailed items are disclosed for complete understanding of this invention in the detailed description below. However, all of these specific detailed items are not necessary to embody this invention, which is apparent to a person skilled in the art. In other situations, publicly known structures, materials, circuits, processing, and interfaces are not detailed, and/or are illustrated in a form of block diagram in order to avoid this invention from being made to be meaninglessly difficult.

Further, portions detailed hereinafter are described as algorithmic descriptions or symbolic expressions of the operation inside the computer. These algorithmic descriptions and symbolic expressions are means used by a person skilled in data processing technology to communicate gist of his/her invention to another person skilled in the art most effectively. The algorithm is a series of defined steps to reach a desired final state or result. Steps to be executed require to physically operate a tangible quantity to realize a tangible result according to this invention.

It should be noted that each of these quantities takes a form of an electrical or magnetic signal to which operations such as storage, transfer, coupling, and comparison can be applied, which are not usually indispensable. It is known that these signals are sometimes conveniently referred to as bit, value, element, symbol, character, item, number, instruction, and the like for common use in principle. However, it should be noted that all of the items and similar items should be related to appropriate physical quantities, and are simply convenient labels attached to these physical quantities.

A description using terms such as “processing”, “calculating”, “computing”, “determining”, and “displaying” may include operations and processing of other information processing apparatus for operating data represented as a physical (electronic) quantity in a computer system or a register and a memory of the computer system, thereby converting data into other data similarly represented as a physical quantity in the memory or the register of the computer system, other information storage, transmission, or display apparatus throughout the description herein as apparent from the following description unless otherwise specified.

Moreover, this invention relates to an apparatus for carrying out operations described herein. The apparatus may be built specifically for required purposes, or may include at least one general-purpose computer selectively activated or reset by at least one computer program. Such a computer program can be stored in, but not limited to, a computer-readable memory medium such as an optical disc, a magnetic disk, a read-only memory, a random access memory, a solid state device, and a drive, or an arbitrary other medium suitable for storage of electronic information.

In the following description, although pieces of information of this invention are described by using such expressions as “aaa table”, “aaa list”, “aaa DB”, and “aaa queue” in some cases, those pieces of information may be expressed by data structures other than a table, a list, a DB, a queue, and the like. Therefore, “aaa table”, “aaa list”, “aaa DB”, “aaa queue”, and the like are sometimes referred to as “aaa information” in order to show that those pieces of information are independent of their data structures.

In addition, although such expressions as “identification information”, “identifier”, “name”, “ID” are used in some cases in order to describe details of each piece of information, those expressions are interchangeable.

In the following description, although a description is given by using “program” as a subject in some cases, the program is executed by a processor to perform defined processing while using a memory and a communication port (communication control device). Therefore, the description given by using “program” as a subject may also be interpreted as a description given by using “processor” as a subject. Further, processing disclosed while a program is used as a subject may also be interpreted as processing performed by a computer such as a management server or an information processing apparatus. Further, a part or all of a program may also be implemented by dedicated hardware.

Further, various programs may also be installed onto each computer by a program distribution server or computer-readable memory media.

It should be noted that the management computer includes input/output devices. As examples of the input/output devices, a display, a keyboard, and a pointer device are conceivable, but the input/output devices may be other devices. Moreover, a serial interface or an Ethernet interface may be used as an input/output device as an alternative to the input/output devices, and input and display on the input/output devices may be substituted by coupling, to the interface, a computer for display including a display, a keyboard, or a pointer device, transmitting information for display to the computer for display, receiving information for input from the computer for display, thereby carrying out display on the computer for display, and receiving the input.

A set of at least one computer for managing an information processing system and displaying information for display of the invention of this application is sometimes referred to as “management system”. In a case where the management computer displays the information for display, the management computer is the management system. Further, a combination of the management computer and the computer for display is also the management system. Further, processing equivalent to that of the management computer may also be implemented by a plurality of computers in order to speed up management processing and achieve a higher reliability, and in this case, the plurality of computers (including the computer for display in a case where the computer for display performs display) are the management system.

Algorithms and displays described herein do not essentially relate to any specific computer or other apparatus. Various general-purpose systems may be used along with programs and modules disclosed herein, but it is sometimes more convenient to build a more specific apparatus for executing steps of a desired method. Structures of the various systems become apparent from description disclosed hereinafter. Moreover, this invention is not described while a specific program language is considered as a prerequisite herein. As described later, it is understood that various programming languages may be used for carrying out the disclosure of this invention. An instruction in a program language can be executed by at least one processing apparatus such as a central processing unit (CPU), a processor, or a controller.

### Overview of Embodiments

As described in more detail hereinafter, an exemplary embodiment of this invention provides an apparatus, a method, and a computer program for supporting generation of rules for failure analysis having an effect of reducing operation man hour in generation of the rules for failure analysis, and carrying out the failure analysis based on the rules.

According to the exemplary embodiment, a management computer is a computer for managing a plurality of management subject apparatus. The types of the management subject apparatus include a computer including a server, network apparatus such as an IP switch, a router, and a fiber channel (FC) switch, and a storage apparatus such as a NAS. It should be noted that a logical or physical configuration of devices included in the management subject apparatus is referred to as component. Examples of the component include a port, a processor, a storage resource, a storage device, a program, a virtual machine, and a logical volume and a RAID group defined inside a storage apparatus. If the management subject apparatus and the components are used while they are not distinguished from each other, the management subject apparatus and the components are referred to as management objects.

The management computer acquires apparatus information such as configuration information on the management objects, and information referred to as event information representing a state or a change in performance of the management object.

Moreover, the management computer includes an analysis engine for analyzing, when the management computer detects events representing a failure occurrence on the management object, a failure based on a combination of the events, thereby identifying a cause, and a rule generation engine for supporting generation of rules required for analyzing a failure.

The analysis engine makes access to a configuration management DB including configuration information on the management subject apparatus, and recognizes relationships among a plurality of components across one or a plurality of management subject apparatus on a certain input/output (I/O) path as one group referred to as “topology”. Moreover, the rule for failure analysis prepared in advance before a failure is analyzed is referred to as metarule, and describes a correspondence between a combination of events that can occur on a topology in a certain pattern and an event which can be a cause candidate of a failure if the events occur in, for example, an IF-THEN form. When the analysis engine detects a failure event on a certain management object, the analysis engine acquires a metarule relating to the detected failure, and information on a topology including the management object on which the failure occurs from the configuration management DB, identifies cause candidates of the occurred failure from a combination of events and a cause event described in the metarule, and the topology, and notifies the system operation administrator of the cause candidates.

The rule generation engine has a function of supporting the generation of metarules. When a rule creator having knowledge in the system failure inputs a cause event of a certain failure and influence events caused in a linked manner by the cause event, the rule generation engine derives patterns of topology between a component on which the cause event has occurred and a component on which the influence event has occurred based on a data model in the configuration management DB of the management computer. Then, the rule generation engine generates means for searching the configuration management DB for a topology in the derived pattern and acquiring the topology, and generates a metarule by combining the input cause event and influence events.

Thus, if the cause event and the influence events are input in the exemplary embodiment of this invention, the rule generation engine generates a metarule, and also generates the means for acquiring the information on a topology to which the metarule is applied from the configuration management DB. Therefore, the rule creator can generate a metarule without learning an internal structure including the data model of the configuration management DB of the management computer, and the analysis engine can automatically identify a cause of a failure based on the generated metarule.

### First Example

### Hardware and Logical Configuration of Management Computer

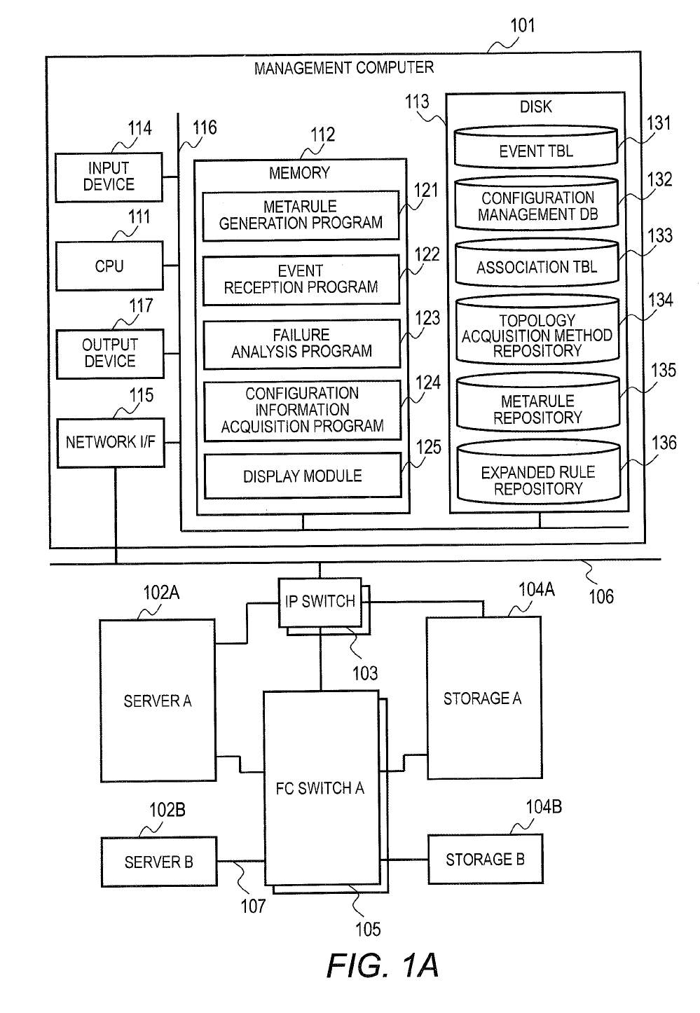

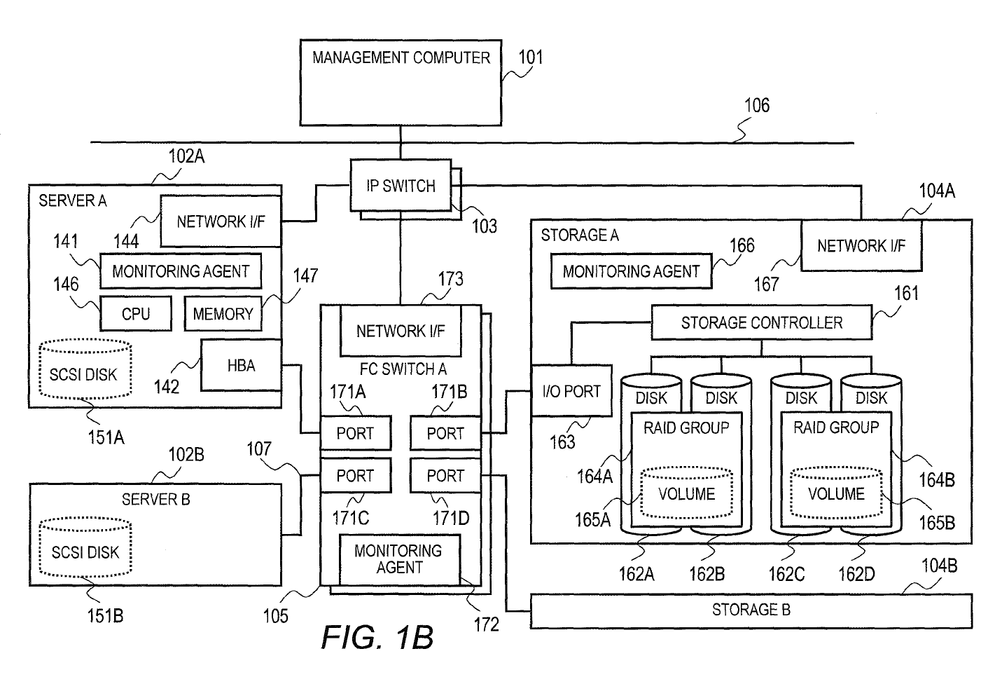

FIGS. 1A and 1B are block diagrams illustrating an example of a hardware architecture and a logical configuration of an information system according to a first example of this invention.

The illustrated system includes a management computer 101, at least one server (or another computer) 102A and 102B, at least one fiber channel (FC) switch (or another network apparatus) 105, at least one storage 104A and 104B, and at least one IP switch (or another network apparatus) 103.

The management computer 101, the servers 102A and 102B, and the FC switch 105 are coupled to each other for communication via a network such as a local area network (LAN) 106. The storages 104A and 104B are coupled via a network such as a storage area network (SAN) 107 to the servers 102A and 102B for communication.

The management computer 101 only needs to be a general purpose computer including a CPU 111, a memory 112, a recording medium such as a hard disk drive (HDD) 113, an input device 114, an output device 117, and a network interface (I/F) 115, and coupling these devices to each other via a system bus 116. Logical modules of the management computer 101 include a metarule generation program 121, an event reception program 122, a failure analysis program 123, a configuration information acquisition program 124, and a display module 125. Moreover, the management computer 101 includes, as data, an event table 131, a configuration management DB 132, an association table 133, a topology acquisition method repository 134, a metarule repository 135, and an expanded rule repository 136.

The metarule generation program 121, the event reception program 122, the failure analysis program 123, the configuration information acquisition program 124, and the display module 125 are stored in the memory 112 or another computer-readable medium, and are executed by the CPU 111. The data such as the event table 131, the configuration management DB 132, the association table 133, the topology acquisition method repository 134, the metarule repository 135, and the expanded rule repository 136 to be described later may be stored in the disk 113 or another appropriate computer-readable medium.

The network interface 115 acquires event information from an operation node subject to management such as the server 102, the IP switch 103, the storage 104, and the FC switch 105 coupled via the LAN 106. The output device 117 is used to present information from the display module 125 to the operation administrator. The input device 114 is used to input an instruction of the operation administrator. For example, a keyboard, a pointer device, and the like can be used as the input device 114, and a display, a printer, and the like can be used as the output device 117, but other devices may be used. Moreover, a serial interface and an Ethernet interface may be used in place of the input device 114 and the output device 117. In this case, a computer for display which includes a display, a keyboard, a pointer device, or the like may be coupled to the interface, information for display may be transmitted to the computer for display, and information for input may be received from the computer for display, thereby carrying out the display on the computer for display, and receiving the input from the computer for display, resulting in substitution of functions of the input device 114 and the output device 117.

Each of the servers 102A and 102B only needs to be a management subject node executing an application and the like as is publicly known in the art. The server 102A only needs to be a general-purpose computer including a CPU 146, a memory (may include a storage) 147, and a network interface 144. The server 102A may include a monitoring agent 141 for monitoring a state of the server 102A, and, if a specific state change is detected, transmitting event information via the LAN 106 to the management computer 101. The each server 102A includes a host bus adaptor (HBA) 142 for coupling to the SAN 107 in the exemplified example. For example, the server 102A can use a disk drive 151A as a virtual local HDD. The disk drive 151A can be realized by the HBA 142 and storage areas of the storages 104A and 104B. Further, other communication and storage protocol may be used in place of or in addition to the SCSI in an alternative example.

Although a description is given of the configuration of the server 102A, the server 102B may have the same configuration.

The storages 104A and 104B only need to be management subject nodes for providing a storage capacity used by an application operating on the server 102 or for other purposes as publicly known in the art. The storage 104A includes a storage controller 161, an I/O port 163 for coupling to the SAN 107, a network interface 167 for coupling to the LAN 106, and RAID groups 164A and 164B, and these devices are coupled to each other via an internal bus or the like. It should be noted that a coupling of the RAID group 164 is, in a more precise sense, a coupling of storage media 162A to 162D constituting the RAID group 164 to other devices.

The storage media 162A to 162D may be hard disk drives in this example, but the storage media 162A to 162D may be other types of storage medium such as solid state storage media (SSDs) and optical storage media. The RAID groups 164A and 164B are respectively constituted by one or a plurality of storage media 162A and the like. If the RAID groups 164A and 164B each include a plurality of storage media 162A and the like, the storage media 162A and the like may constitute the RAID. Moreover, the RAID group 164 constitutes logically a plurality of volumes (LUN) 165A and the like.

In this example, the storage 104A is configured to provide the servers 102A and 102B with logical volumes as storage capacities. Thus, the two servers 102A and 102B are coupled via the FC switch 105 to the storage 104A, and the storage 104A provides each of the servers 102A and 102B with the logical volume in the exemplified example. Moreover, the storage 104A may include a monitoring agent 166 for monitoring a state of the storage 104A, and, if a specific state change is detected, transmitting event information via the LAN 106 to the management computer 101. Alternatively, the monitoring agent 141 of the server 102A may monitor the state of the storage 104A.

Although a description is given of the configuration of the storage 104A, the storage 104B may have the same configuration.

The FC switch 105 may be a management subject node for constituting the SAN 107 for coupling the servers 102A and 102B and the storages 104A and 104B to each other or for other purposes as publicly known in the art. As a result, logical volumes of the storages 104A and 104B are provided as storage areas for the servers 102A and 102B.

The FC switch 105 includes ports 171A to 171D for receiving data transmitted from the server 102 or the storage 104, and transmitting the received data. Moreover, the FC switch 105 may include a network interface 173 for coupling to the LAN 106. Further, the FC switch 105 may include a monitoring agent 172 for monitoring a state of the FC switch 105, and, if a specific state change is detected, transmitting event information via the LAN 106 to the management computer 101. Alternatively, the monitoring agent 141 of the server 102A may monitor the state of the FC switch 105.

### <Event Table>

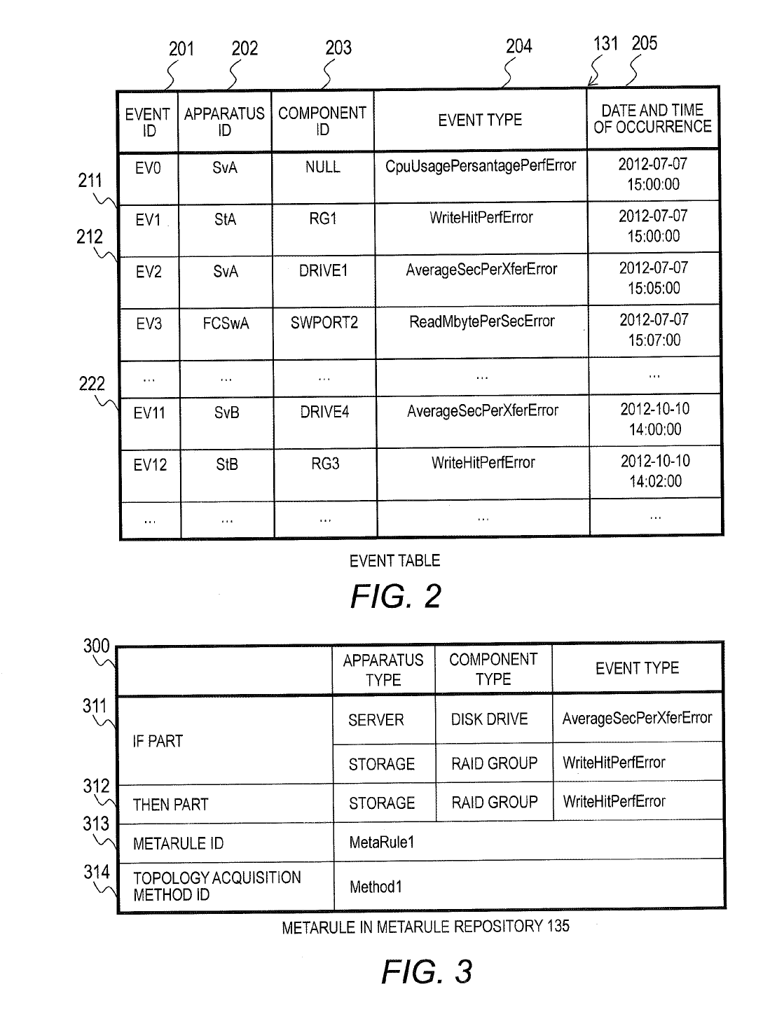

FIG. 2 is an explanatory diagram illustrating an example of a data structure of the event table 131 according to the example. The event table 131 stores event information received by the event reception program 122 from the monitoring agents of the management subject apparatus.

The event table 131 includes five fields, namely, an event ID 201, an apparatus ID 202, a component ID 203, an event type 204, and a date and time of occurrence 205. The event ID 201 is identification information for uniquely identifying each piece of event information. The apparatus ID 202 is identification information for uniquely identifying a management subject apparatus. The component ID 203 is identification information for uniquely identifying a management subject component. The event type 204 is a type of an event occurred on the management object. The date and time of occurrence 205 is a time when the event occurs. The date and time of occurrence may be a time when the management computer 101 receives the event information. If the event is not an event relating to a component, but is an event relating to the apparatus itself, the value of the component ID 203 may be “NULL”.

For example, an entry 211 in FIG. 2 means that “WriteHitPerfError” (cache hit rate performance error in write processing) occurs at 15:00:00 on Jul. 7, 2012 in the RAID group 164 having RG1 as the component ID in the storage 104A having StA as the apparatus ID.

### <Metarule Repository and Metarules>

The metarule is information representing a correspondence between a combination of events which can occur on a topology in a certain pattern and an event which can be a cause candidate of a failure if these events occur at the same timing. The metarule is described in the IF-THEN form according to this example, but other forms may be used as long as a cause phenomenon of a system failure and observed phenomena which are caused by the cause phenomenon are described.

FIG. 3 is an explanatory diagram illustrating an example of a metarule 300 residing in the metarule repository 135 according to this example.

In general, the metarule can be divided into two parts, namely, a first part referred to as IF part 311 and a second part referred to as THEN part 312. The IF part 311 may include at least one condition element.

The metarule 300 represents that, if events (condition events) of the IF part 311 are detected, an event (conclusion event) of the THEN part 312 causes a failure. Thus, if a status of the THEN part 312 becomes normal, it is expected that the problem of the IF part 311 be solved.

According to this example, the event information stored in the event table 131 in FIG. 2 is considered as an observed phenomenon, and, in order to analyze a failure, “APPARATUS TYPE”, “COMPONENT TYPE”, and “EVENT TYPE” are described in each condition element of the IF part 311 of the metarule 300. In other words, the management subject apparatus and the component are classified into some types in the management computer 101, and the condition elements in the IF part 311 represent that a state of a specified event type occurs in a management object of a specified type. If the event is not an event relating to a component, but is an event relating to the apparatus itself, the value of the “COMPONENT TYPE” may be “NULL”.

Moreover, the metarule 300 includes a field 313 including a metarule ID 313 for uniquely identifying each metarule. Moreover, the metarule 300 includes a field 314 for storing an identifier of means (topology acquisition method) for acquiring information on a topology to which the metarule 300 is applied when an expanded rule is generated by applying the metarule 300 to a configuration of an actual management subject system. It should be noted that a plurality of metarules 300 may store the same ID of the topology acquisition method in the fields 314.

For example, the metarule (metarule ID=“MetaRulel”) in FIG. 3 represents such a rule that, if “a transfer time performance error in the disk drive 151A on the server 102A or the like” and “a cache hit rate performance error in the write processing in the RAID group 164 in the storage 104A and the like” are detected as observed phenomena, the cause can be concluded as “a cache hit rate performance error in the write processing in the RAID group 164 in the storage 104A and the like.”

Moreover, if an expanded rule is generated for the metarule having the metarule ID=“MetaRulel”, a topology acquisition method specified by the topology acquisition method ID field 314 is acquired from the topology acquisition method repository 134, and topology information required for generating an expanded rule from the metarule is acquired by means of the acquired method from the configuration management DB or the like. It should be noted that a state where a certain management object is normal (a failure event does not occur) may be defined as a condition element included in the IF part 311. Moreover, the event type of the THEN part 312 may be newly defined, and may not be the event type of an event received by the event reception program 122.

### <Configuration Management DB>

The configuration management DB 132 stores configuration information on management subject apparatus acquired by the configuration information acquisition program 124 from the monitoring agents and the like. The configuration information includes association information representing a relationship of input/output (I/O) of a management subject apparatus and a component, a coupling relationship, a dependency relationship, and the like. In other words, the topology can be represented as a combination of these associations.

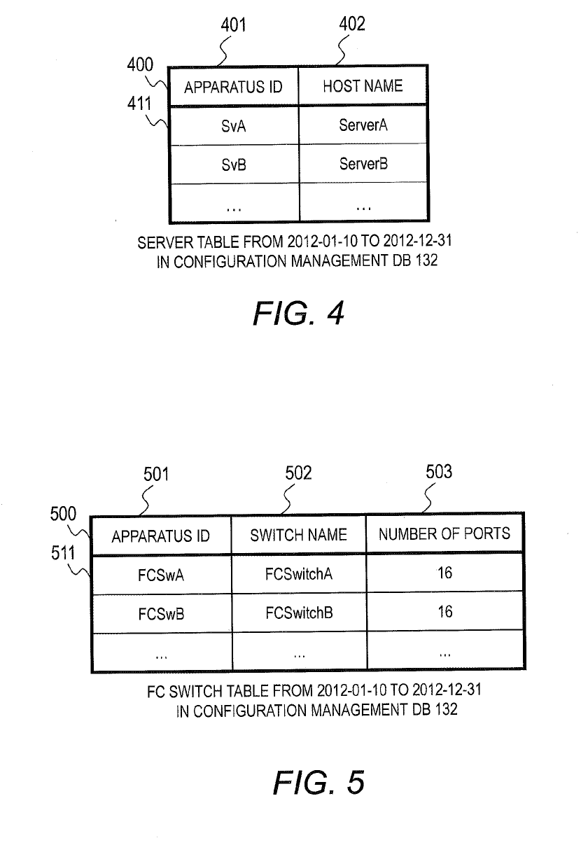

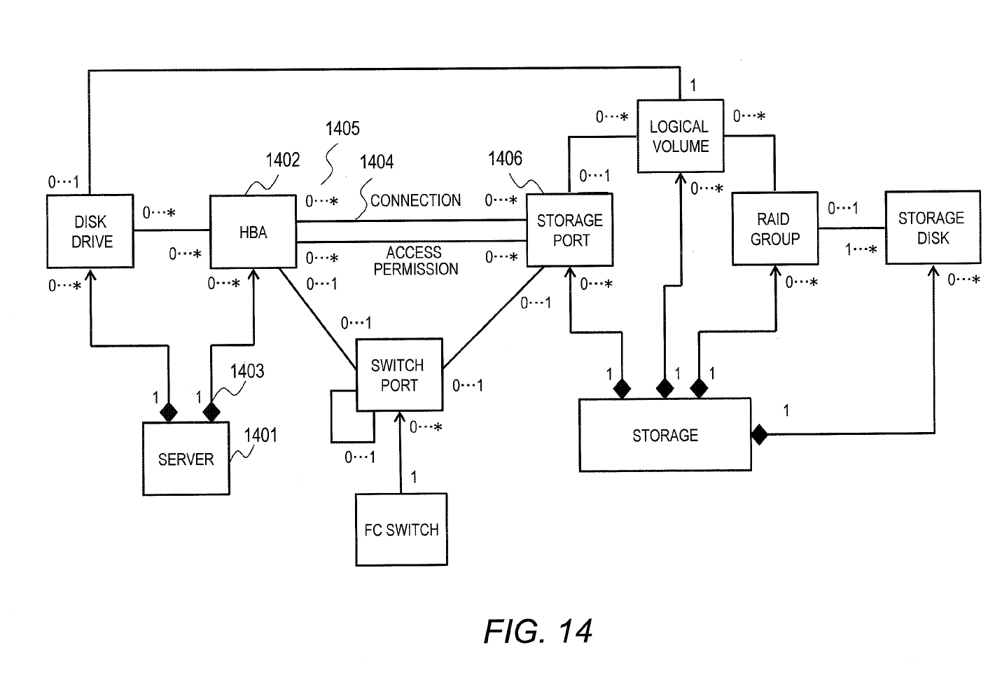

Referring to FIGS. 4 to 13, a description is now given of an example of the configuration information on the server 102, the FC switch 105, and the storage 104 in FIG. 1 stored by the configuration management DB 132. Moreover, FIG. 14 is a class diagram illustrating associations among the respective management objects illustrated in FIG. 1 for each of respective types of the management objects.

Tables are generated for each type of the management object reflecting the class diagram in FIG. 14 in the configuration management DB 132 according to this example. Therefore, each table name represents a management object type name, and one entry of each of the tables represents one management object. It should be noted that it is not necessary to configure a table of the configuration management DB for each of the types of the management object, and information representing the type of a management object may be registered to each entry. Moreover, information on one management object may be registered to a plurality of entries.

Moreover, the association between management objects is represented by the same value in the field in each table according to this example, but a table recording information on the association may be provided separately of the information on the management object.

It should be noted that only a part of the tables and/or a part of items in the table of the configuration management DB 132 may be stored. Moreover, a data representation form and a data structure of each of the items stored in the configuration management DB may be different from a data representation form and a data structure of data held by the management subject apparatus. Moreover, data received by the management computer 101 from a management subject apparatus may have the data structure and the data representation form of the management subject apparatus.

Moreover, the information in the table of the configuration management DB 132 may be updated as the configuration of a management subject apparatus changes. If the information in the table of the configuration management DB is updated, information before the update may be recorded, thereby enabling reference to the past configuration information by means of the history information.

FIG. 4 is an explanatory diagram illustrating a table representing configuration information on apparatus whose type of management object is the server out of tables included in the configuration management DB 132 according to this example.

A server table 400 includes two fields, namely, an apparatus ID 401 and a host name 402. The apparatus ID 401 is identification information for uniquely identifying a management subject apparatus. The host name 402 is identification information for uniquely identifying the server 102 by the operation administrator.

In particular, the server table 400 in FIG. 4 shows configuration information on the servers 102A and 102B subject to management from Jan. 1, 2012 to Dec. 31, 2012. The tables of the configuration management DB 132 record a date and time of change and a content of change each time the information thereof is updated. Moreover, a table representing configuration information in an arbitrary period may be acquired by, for example, periodically acquiring a snapshot of each of the tables. Each of the tables of the configuration management DB 132 described later also only needs to be a table representing configuration information in an arbitrary period.

FIG. 5 is an explanatory diagram illustrating a table representing configuration information on apparatus whose type of management object is the FC switch out of the tables included in the configuration management DB 132 according to this example.

An FC switch table 500 includes three fields, namely, an apparatus ID 501, a switch name 502, and a number of ports 503. The apparatus ID 501 is identification information for uniquely identifying a management subject apparatus. The switch name 502 is a name for uniquely identifying the FC switch 105 by the operation administrator. The number of ports 503 is the number of ports included in the FC switch 105.

In particular, the FC switch table 500 in FIG. 5 shows configuration information on the FC switch 105 subject to management from Jan. 1, 2012 to Dec. 31, 2012.

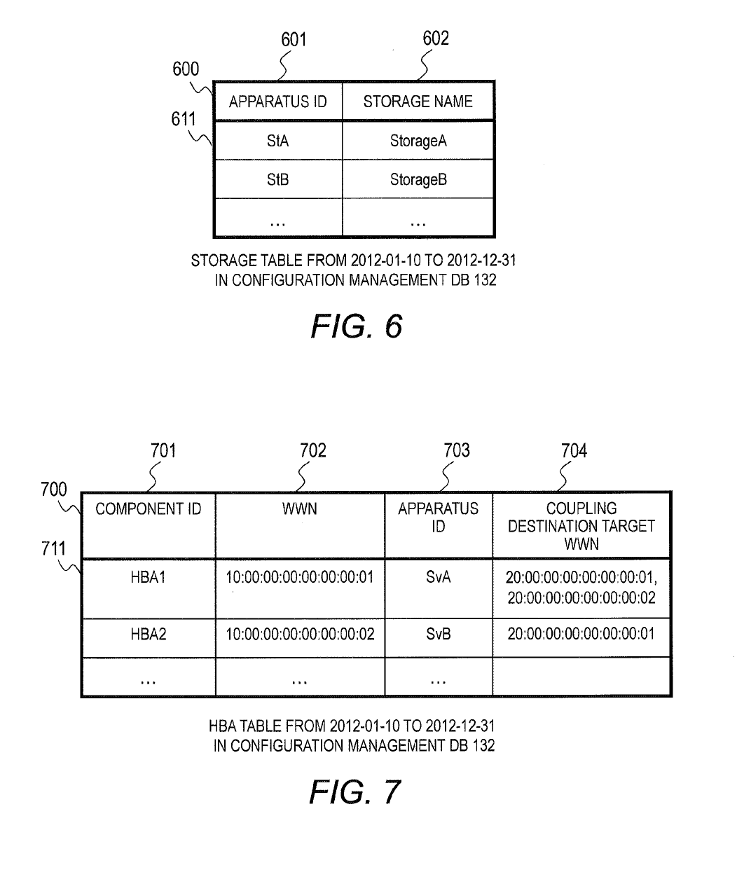

FIG. 6 is an explanatory diagram illustrating a table representing configuration information on apparatus whose type of management object is the storage out of the tables included in the configuration management DB 132 according to this example.

A storage table 600 includes two fields, namely, an apparatus ID 601 and a storage name 602. The apparatus ID 601 is identification information for uniquely identifying a management subject apparatus. The storage name 602 is a name for uniquely identifying the storage 104A and the like by the operation administrator.

In particular, the storage table 600 in FIG. 6 shows configuration information on the storages 104A and 104B subject to management from Jan. 1, 2012 to Dec. 31, 2012.

FIG. 7 is an explanatory diagram illustrating a table representing configuration information on component whose type of management object is the HBA out of the tables included in the configuration management DB 132 according to this example.

An HBA table 700 includes four fields, namely, a component ID 701, a WWN 702, an apparatus ID 703, and a coupling destination target WWN 704.

The component ID 701 is identification information for uniquely identifying a component of a management subject apparatus. The WWN 702 is a world wide name (WWN) assigned to the HBA. The apparatus ID 703 is identification information on the server 102A or the like on which the HBA operates. The same value as the value stored in the apparatus ID 401 of the server table 400 is used for identification information recorded in the apparatus ID 703. The coupling destination target WWN 704 is a WWN of the I/O port 163 of the storage 104A used by the HBA 142 to mount the logical volume 165A or the like of the storage 104A.

In particular, the HBA table 700 in FIG. 7 shows configuration information on the HBA 142 from Jan. 1, 2012 to Dec. 31, 2012.

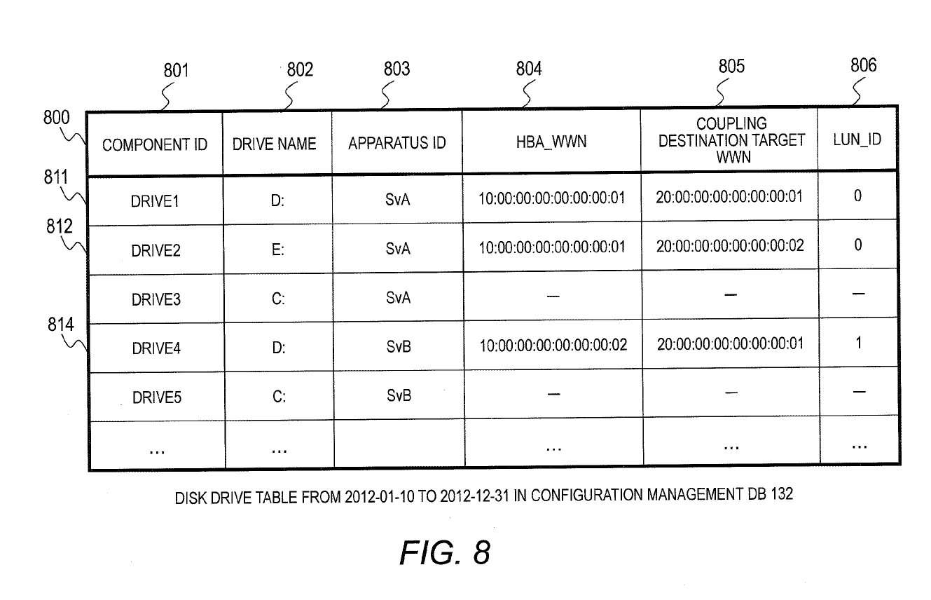

FIG. 8 is an explanatory diagram illustrating a table representing configuration information on component whose type of management object is the disk drive out of the tables included in the configuration management DB 132 according to this example.

A disk drive table 800 includes six fields, namely, a component ID 801, a drive name 802, an apparatus ID 803, an HBA_WWN 804, a coupling destination target WWN 805, and a LUN_ID 806.

The component ID 801 is identification information for uniquely identifying a component of a management subject apparatus. The drive name 802 is a name of the drive (SCSI disk) 151A on the server 102. The apparatus ID 803 is an identifier of the server 102A mounting the drive 151A. The HBA_WWN 804 is a WWN of the HBA 142 used to make access to the disk drive 151A. The coupling destination target WWN 805 is a WWN of the

I/O port 163 of the storage 104A or the like which is made access to so as to use a storage area of the drive such as the storage 104A as the logical volume 165A. The LUN_ID 806 is an identifier of the logical volume 165A or the like associated with the I/O port 163 of the each storage 104A or the like.

In particular, the disk drive table 800 in FIG. 8 shows configuration information on the SCSI disk 151A and the like from Jan. 1, 2012 to Dec. 31, 2012.

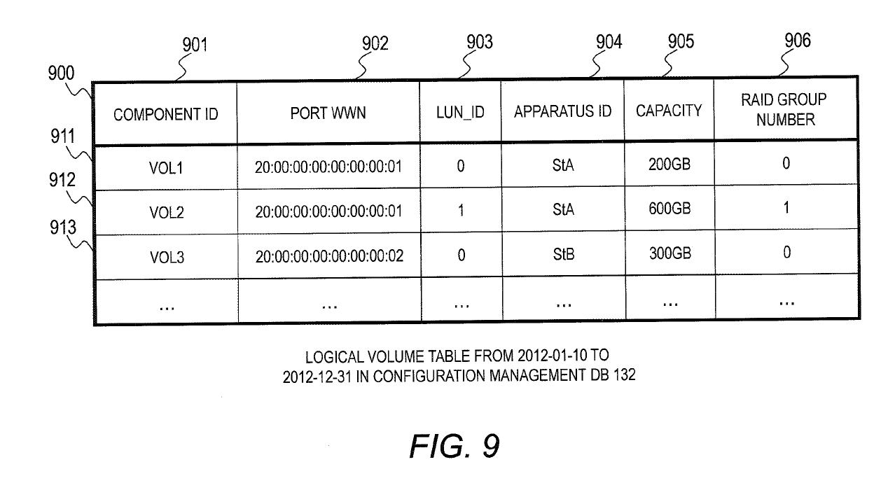

FIG. 9 is an explanatory diagram illustrating a table representing configuration information on component whose type of management object is the logical volume out of the tables included in the configuration management DB 132 according to this example.

A logical volume table 900 includes six fields, namely, a component ID 901, a port WWN 902, a LUN_ID 903, an apparatus ID 904, a capacity 905, and a RAID group number 906.

The component ID 901 is identification information for uniquely identifying a component of a management subject apparatus. The port WWN 902 is a WWN of the I/O port 163 used to provide a storage area such as each logical volume 165A. The LUN_ID 903 is an identifier of the logical volume 165A or the like associated with the I/O port 163. The apparatus ID 904 is an identifier of the storage 104 on which the logical volume 165A or the like is constituted. The capacity 905 is a capacity of the storage area such as the logical volume 165A. The RAID group number 906 is identification information for uniquely identifying the RAID group 164A or the like in the each storage 104A, and is a RAID group for providing the storage area such as the logical volume 165A.

In particular, the logical volume table 900 in FIG. 9 shows configuration information on the logical volume 165A and the like from Jan. 1, 2012 to Dec. 31, 2012.

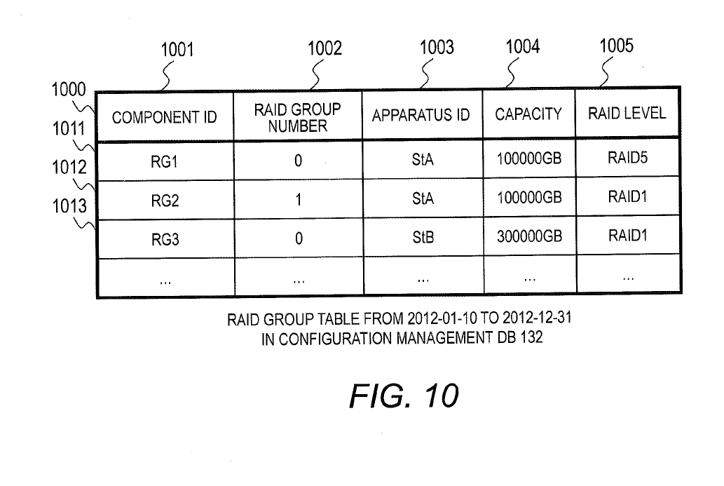

FIG. 10 is an explanatory diagram illustrating a table representing configuration information on component whose type of management object is the RAID group out of the tables included in the configuration management DB 132 according to this example.

A RAID group table 1000 includes five fields, namely, a component ID 1001, a RAID group number 1002, an apparatus ID 1003, a capacity 1004, and a RAID level 1005.

The component ID 1001 is identification information for uniquely identifying a component of a management subject apparatus. The RAID group number 1002 is identification information for uniquely identifying the RAID group 164A or the like in the storage 104A. The apparatus ID 1003 is identification information on the storage 104A including the RAID group 164A or the like. The capacity 1004 is a capacity of a storage area of the RAID group 164A or the like. The RAID level 1005 is a RAID level of the RAID group 164A or the like.

In particular, the RAID group table 1000 in FIG. 10 shows configuration information on the RAID group 164A and the like from Jan. 1, 2012 to Dec. 31, 2012.

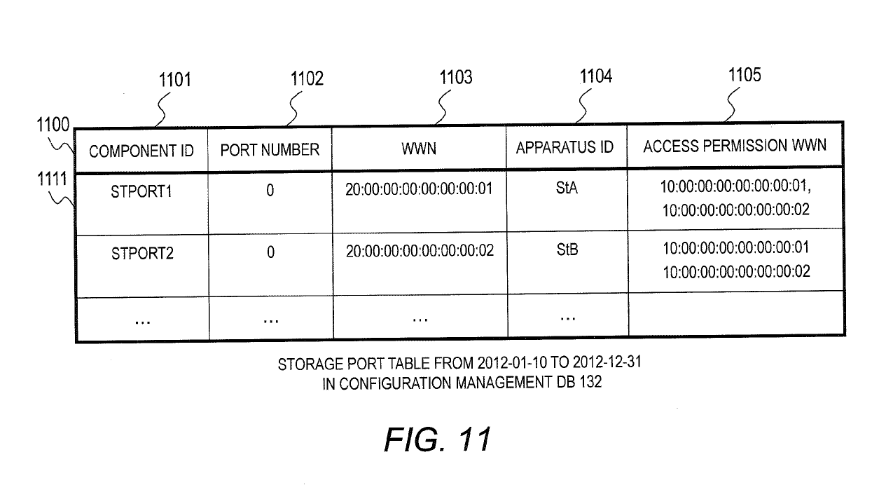

FIG. 11 is an explanatory diagram illustrating a table representing configuration information on component whose type of management object is the storage port out of the tables included in the configuration management DB 132 according to this example.

A storage port table 1100 includes five fields, namely, a component ID 1101, a port number 1102, a WWN 1103, an apparatus ID 1104, and an access permission WWN 1105.

The component ID 1101 is identification information for uniquely identifying a component of a management subject apparatus. The port number 1102 is identification information for uniquely identifying the I/O port 163 on the storage 104A or the like. The WWN 1103 is a WWN assigned to the I/O port 163. The apparatus ID 1104 is identification information on the storage 104A or the like having the I/O port 163. The access permission WWN 1105 is a WWN of an HBA permitted to make access to the I/O port 163.

In particular, the storage port table 1100 in FIG. 11 shows configuration information on the I/O port 163 from Jan. 1, 2012 to Dec. 31, 2012.

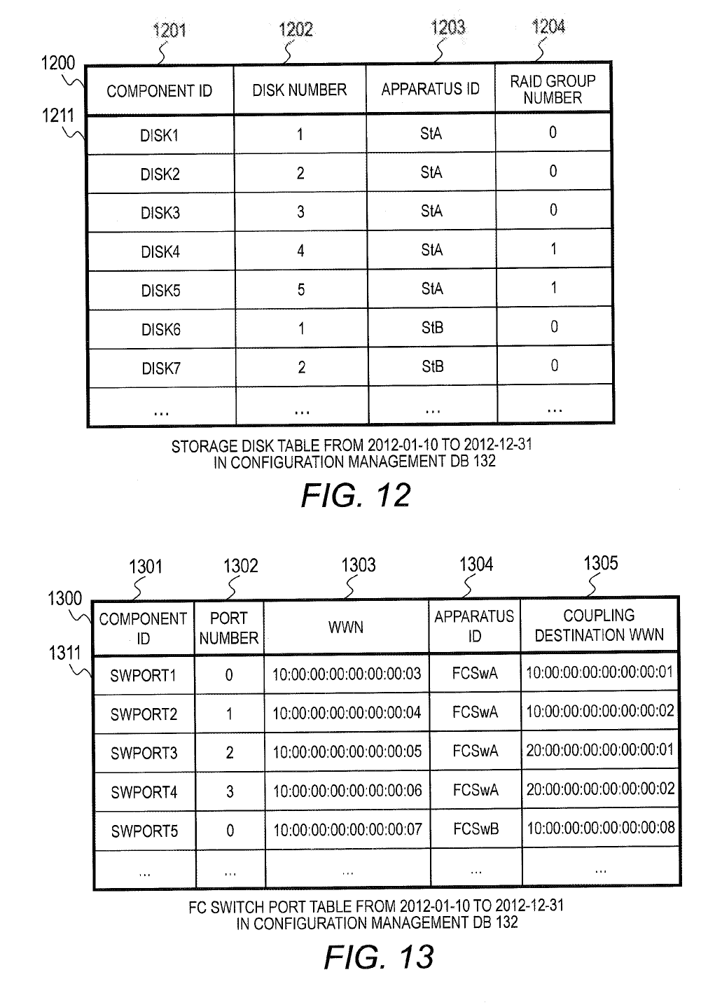

FIG. 12 is an explanatory diagram illustrating a table representing configuration information on component whose type of management object is the storage disk out of the tables included in the configuration management DB 132 according to this example.

A storage disk table 1200 includes four fields, namely, a component ID 1201, a disk number 1202, an apparatus ID 1203, and a RAID group number 1204.

The component ID 1201 is identification information for uniquely identifying a component of a management subject apparatus. The disk number 1202 is identification information for uniquely identifying the storage medium 162A and the like on the storage 104A or the like. The apparatus ID 1203 is identification information on the storage 104A or the like having the storage medium 162A or the like. The RAID group number 1204 is identification information for uniquely identifying the RAID group 164A or the like constituted by the storage medium 162A or the like on the each storage 104A or the like.

In particular, the storage disk table 1200 in FIG. 12 shows configuration information on the storage medium 162A from Jan. 1, 2012 to Dec. 31, 2012.

FIG. 13 is an explanatory diagram illustrating a table representing configuration information on component whose type of management object is the FC switch port out of the tables included in the configuration management DB 132 according to this example.

An FC switch port table 1300 includes five fields, namely, a component ID 1301, a port number 1302, a WWN 1303, an apparatus ID 1304, and a coupling destination port WWN 1305.

The component ID 1301 is identification information for uniquely identifying a component of a management subject apparatus. The port number 1302 is identification information for uniquely identifying the port 171A or the like in the FC switch 105. The WWN 1303 is a WWN assigned to the port 171A or the like. The apparatus ID 1304 is an identifier of the FC switch 105 including the port 171A or the like. The coupling destination port WWN 1305 is a WWN of a port to which the port 171A or the like is directly coupled.

In particular, the FC switch port table 1300 in FIG. 13 shows configuration information on the port 171A of the FC switch from Jan. 1, 2012 to Dec. 31, 2012.

As described before, FIG. 14 is the class diagram illustrating the associations such as the relationship in input/output (I/O), the coupling relationship, and the dependent relationship of the respective management objects illustrated in FIG. 1 for respective types of the management objects.

For example, a server 1401 and an HBA 1402 in FIG. 14 respectively represent types of the management objects. For example, an arrow 1403 represents that the HBA 1402 can be a component of the server 1401. For example, a connector 1404 represents that a coupling relationship between the HBA 1402 and a storage port 1406 can be generated, and a multiplicity 1405 represents that the number of HBAs to which the coupling relationship can be generated is 0, 1, or more if one storage port 1406 exists. Whether the associations represented by the arrow 1403 and the connector 1404 are generated for an actual management object can be derived from the configuration information in the configuration management DB 132.

### <Association Table>

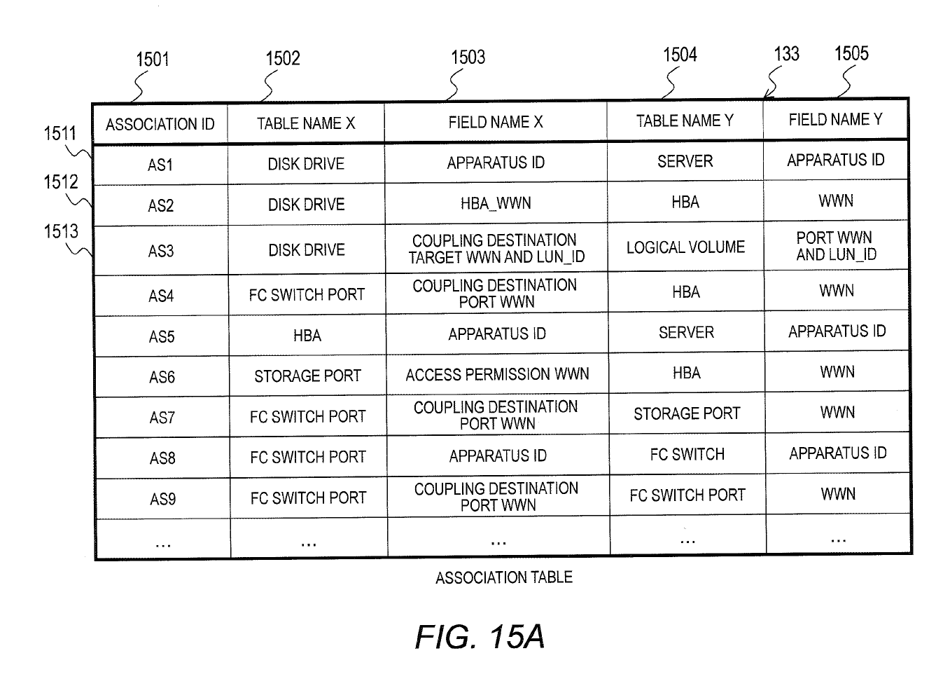

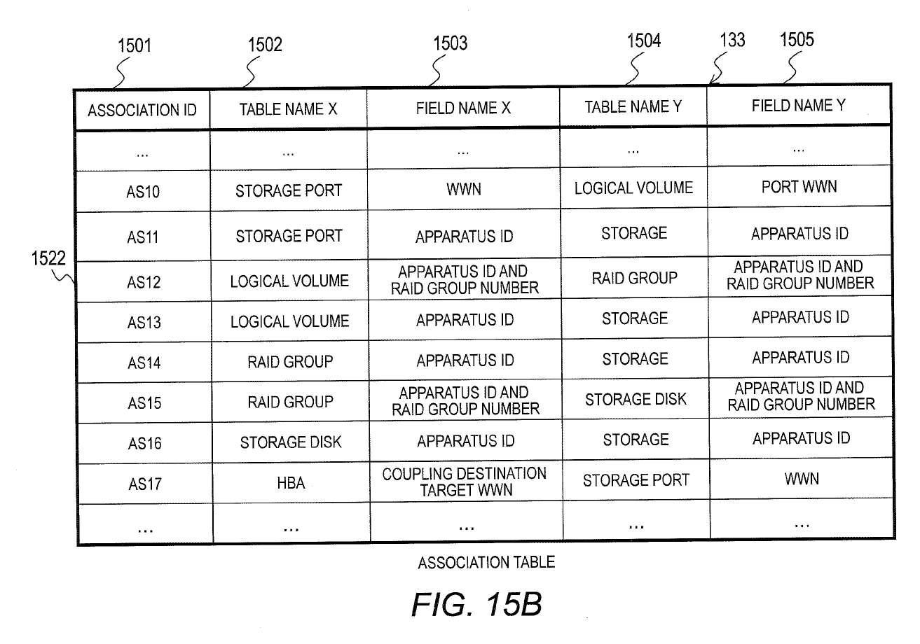

FIGS. 15A and 15B are explanatory diagrams illustrating examples of a data structure of the association table 133 according to this example. The association table 133 according to this example has such a structure that entries shown in FIG. 15A are followed by entries shown in FIG. 15B.

The association table 133 stores information on association which can be generated between types of management object (according to this example, between the tables in the configuration management DB 132), namely, information on the arrows 1403 and the connectors 1404 in the class diagram in FIG. 14. The association table 133 stores correspondences between the respective fields of the respective tables of the configuration management DB 132, and if fields corresponding to each other have the same value, management objects of entries in the tables of the configuration management DB 132 are associated with each other.

Information on a management object having association with a specified management object can be acquired by referring to the association table 133 from the configuration management DB 132. In other words, each entry of the association table 133 represents association for acquiring association information between management objects from the configuration management table DB 132.

The association table 133 includes five fields, namely, an association ID 1501, a table name X 1502, a field name X 1503, a table name Y 1504, and a field name Y 1505.

The association ID 1501 is identification information for uniquely identifying a correspondence between management object types. The table name X 1502 is a table name in the configuration management DB 132. The field name X 1503 is a field name in the table represented by the table name X 1502. The table name Y 1504 is a table name having association with the table represented by the table name X 1502. The field name Y 1505 is a field name in the table represented by the table name Y 1504. If the same value is stored in a field represented by the field name X 1503 and a field represented by the field name Y 1505, the management objects represented by the respective entries have association with each other.

For example, a first entry 1511 shown in FIG. 15A represents that, if entries having the same value in the apparatus ID field 803 in the disk drive table 800 (refer to FIG. 8) and in the apparatus ID field 401 of the server table 400 (refer to FIG. 4) are stored in the respective tables in the configuration management DB 132, the disk drive 151A or the like and the server 102A or the like represented by these entries are associated with each other (in other words, disk drive 151A is a component of the server 102A).

Moreover, a third entry 1513 further uses the AND operator in the fields 1503 and 1505. In other words, the entry 1513 represents that, if entries having the same value in the coupling destination target WWN field 805 in the disk drive table 800 and in the port WWN field 902 in the logical volume table 900, and the same value in the LUN_ID field 806 in the disk drive table 800 and in the LUN_ID field 903 in the logical volume table 900 are stored in the respective tables in the configuration management DB 132, the disk drive 151A or the like and the logical volume 165A or the like represented by these entries are associated with each other (in other words, the logical volume 165A is used as a storage area of the disk drive 151A).

An entry in the association table is prepared for each association between tables in the configuration management DB 132 according to this example, but information on two or more associations may be stored in one entry. For example, as illustrated in the class diagram in FIG. 14, the logical volume and the storage disk are not directly associated with each other. However, the logical volume and the storage disk are associated with each other via the RAID group as a topology, and hence an entry representing association between an entry in the logical volume table and an entry in the storage disk table may be stored in the association table 133.

### <Topology Acquisition Method Repository and Topology Acquisition Methods>

The topology acquisition method is information representing means for searching, when a metarule is actually applied to a management subject system to generate expanded rules, the configuration management DB 132 for topologies to which the metarule can be applied, and acquiring information on the corresponding topologies.

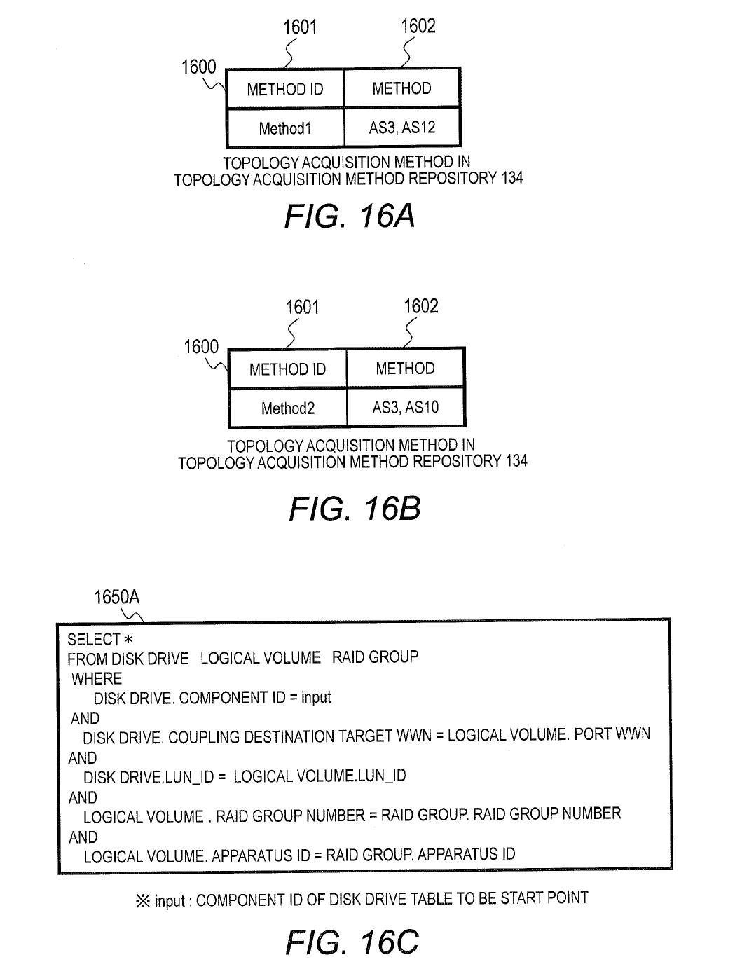

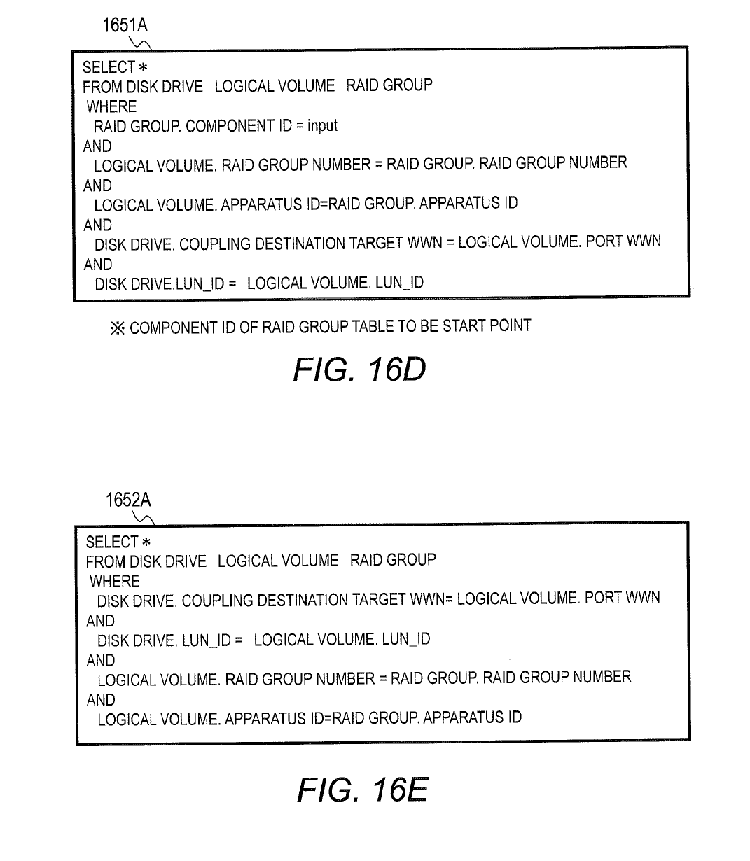

FIGS. 16A to 16E are explanatory diagrams illustrating examples of the topology acquisition method residing in the topology acquisition method repository 134 according to this example.

As illustrated in FIGS. 16A and 16B, the topology acquisition method includes two fields, namely, a method ID 1601 and a method 1602.

The method ID 1601 is identification information for uniquely identifying a topology acquisition method. The method 1602 is identification information (association ID) of one or a plurality of entries in the association table 133. The topology information can be acquired by acquiring entries in the association table 133 having the association IDs stored in the method 1602, and acquiring information on a management object group having all associations represented by the acquired entries from the configuration management DB 132.

It should be noted that a topology acquisition method 1600 may be referred to by a plurality of metarules 300.

Moreover, for example, the topology acquisition method 1600 illustrated in FIG. 16B represents that the identification information is “Method2”, and information on topologies to which the metarules 300 are applied can be acquired from the configuration management DB 132 based on correspondences of fields in the configuration management DB 132 registered to the entries having AS3 and AS10 in the association ID 1501 in the association table 133. When the topology information is actually acquired by means of the topology acquisition method 1600, based on information in an entry having “AS3” in the association ID 1501 and an entry having “AS10” in the association ID 1501 in the association table 133, a combination of entries in the disk drive table 800, the logical volume table 900, and the storage port table 1100 of the configuration management DB 132 which simultaneously satisfy all the following conditions is acquired.

(1) A value in the coupling destination target WWW 805 of the disk drive table 800 and a value in the port WWN 902 of the logical volume table 900 are equal to each other, and a value in the LUN_ID 806 of the disk drive table 800 and a value of the LUN_ID 903 of the logical volume table 900 are equal to each other.
(2) A value in the port WWN 902 of the logical volume table 900 and a value in the WWN 1103 of the storage port table 1100 are equal to each other.

The method 1602 may store processing derived based on information in one or a plurality of entries in the association table 133 so as to acquire topologies from the configuration management DB 132, for example, a database query language such as a program or an SQL.

For example, if the configuration management DB 132 is a relational database publicly known in the art, and data can be acquired by means of the database query language SQL, an SQL 1650A illustrated in FIG. 16C, an SQL 1651A illustrated in FIG. 16D, and an SQL 1652A illustrated in FIG. 16E may be generated based on the correspondences of the fields in the configuration management DB 132 registered to the entries having AS3 and AS12 in the association ID 1501 corresponding to the topology acquisition method 1600 illustrated in FIG. 16A. The SQL 1650A is a SQL sentence for acquiring topology information starting from a component ID belonging to the disk drive table, the SQL 1651A is a SQL sentence for acquiring topology information starting from a component ID belonging to the RAID group table, and the SQL 1652A is a SQL sentence for acquiring information on all topologies having specified associations.

It should be noted that these SQL sentences are preferred to be devised in order to accelerate the processing. For example, a sequence to narrow down entries to be acquired by means of conditions described in WHERE clauses of SQL sentences may be changed depending on multiplicity between tables in the configuration management DB 132.

Moreover, if a topology including multiple stages coupled from a certain apparatus to another apparatus such as switches is acquired in a topology acquisition method, such a definition as “N*AS8” which means that “the association represented by the entry corresponding to AS8 (association ID) is routed N times” may be included in the method 1602.

### <Expanded Rule Repository and Expanded Rules>

The expanded rule is information representing a correspondence between a combination of events that can occur in a management subject system and an event which can be a cause candidate of a failure if these events occur. The expanded rule is a rule generated as a result of searching a management subject system for a topology to which the metarule 300 can be applied based on the configuration information on the management subject system, and applying the metarule 300 to the searched topology.

In this example, the expanded rule is described in the IF-THEN form similarly to the metarule, but other forms may be used as long as a cause phenomenon of a system failure and an observed phenomenon which is caused by the cause phenomenon are described.

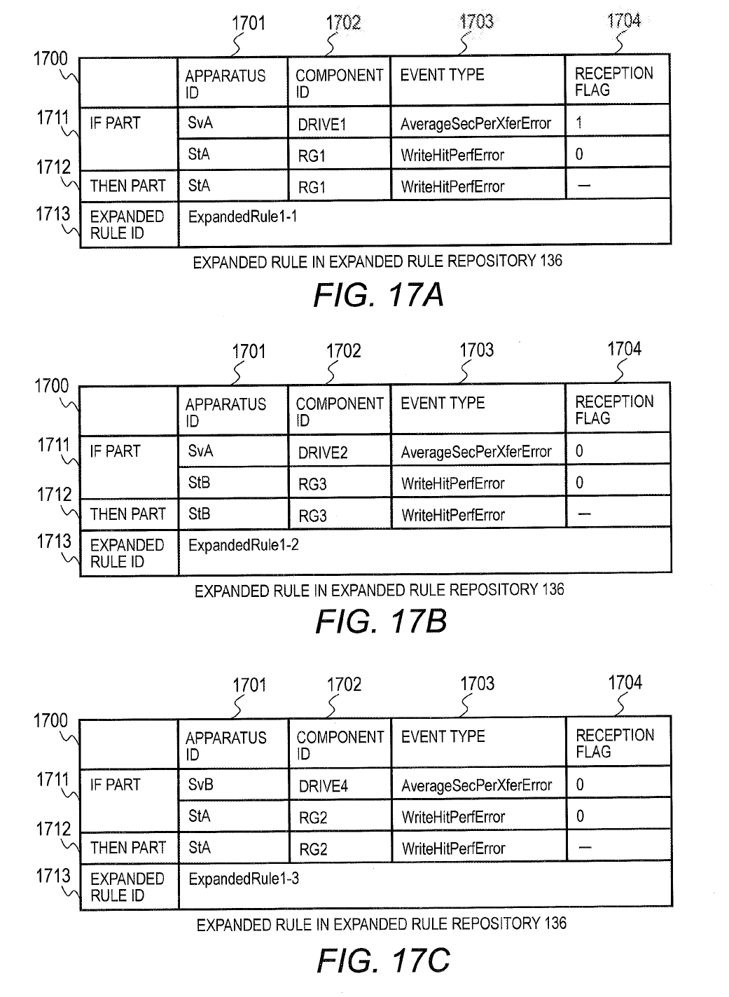

FIGS. 17A to 17C are explanatory diagrams illustrating examples of the expanded rule stored in the expanded rule repository 136 according to this example.

In general, similarly to the metarule 300, the expanded rule can be divided into two parts, namely, a first part referred to as IF part 1711 and a second part referred to as THEN part 1712. The IF part 1711 may include at least one condition element.

An expanded rule 1700 represents that, if events (condition events) of the IF part 1711 are detected, an event (conclusion event) of the THEN part 1712 causes a failure. Thus, if a status of the THEN part 1712 becomes normal, it is expected that the problem of the IF part 1711 be solved.

In this example, the event information stored in the event table 131 in FIG. 2 is considered as an observed phenomenon, and, in order to analyze a failure, an apparatus ID 1701, a component ID 1702, an event type 1703, and a reception flag 1704 are described in each condition element of the IF part 1711 of the expanded rule 1700. In other words, the condition elements in the IF part 1711 represent that a state of the event type 1703 occurs in a management object specified by the apparatus ID 1701 and the component ID 1702. Moreover, the reception flag 1704 is a result of whether an event represented by the condition element is actually received. If the event represented by the condition element is received, “1” is stored in the reception flag 1704, and if the event represented by the condition element is not received, “0” is stored in the reception flag 1704. Processing of returning the value to “0” may be carried out when a predetermined period has passed after “1” was stored in the reception flag 1704.

Moreover, the expanded rule 1700 includes a field 1713 for storing an expanded rule ID for uniquely identifying each metarule.

For example, the expanded rule “ExpandedRule1-1” illustrated in FIG. 17A represents that, if “a transfer time performance error in a D drive (component ID=DRIVE1) on a server A (apparatus ID=SvA) and “a cache hit rate performance error in the write processing in a RAID group 0 (component ID=RG1) in a storage A (apparatus ID=StA)” are detected as observed phenomena, it is concluded that a cause therefor is “the cache hit rate performance error in the write processing in the RAID group 0 in the storage A”. It should be noted that a state where a certain management object is normal (a failure event does not occur) may be defined as a condition element included in the IF part 1711.

### <Generation Processing for Metarules>

In this example, the rule creator (operation administrator of the system) inputs a cause of a failure actually occurred in the management subject system, and events on respective management objects resulting from the cause, and a metarule is generated based on the input information. A more precise rule can be generated by inputting information based on the information on the failure actually generated in the system which the rule creator actually manages. Further, the information required to generate a metarule can be input while internal specifications of the failure analysis function are hidden as much as possible.

For example, if the failure analysis function does not provide a correct analysis result for a failure occurred on the management subject system, it is found that metarules are insufficient. After the failure is handled, if the cause is determined, information required for generating a metarule is input based on the information on the failure to generate a new metarule. In this manner, if the same failure occurs subsequently, the failure can be quickly analyzed.

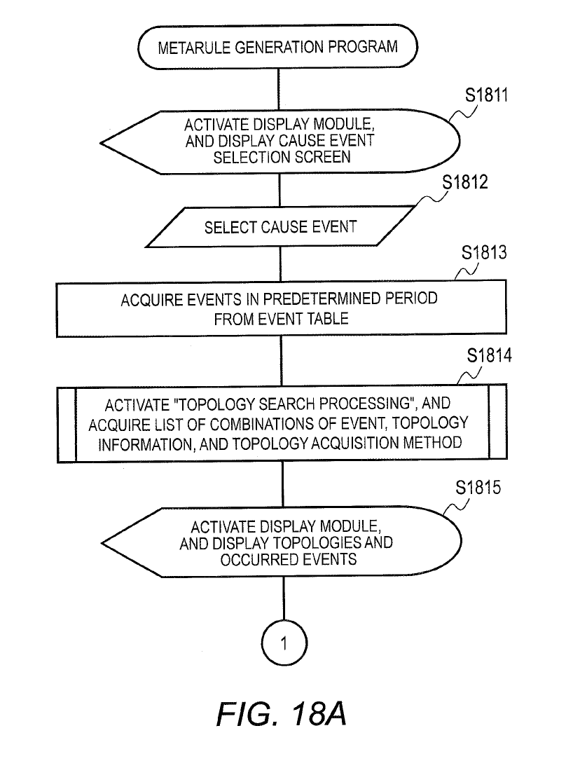

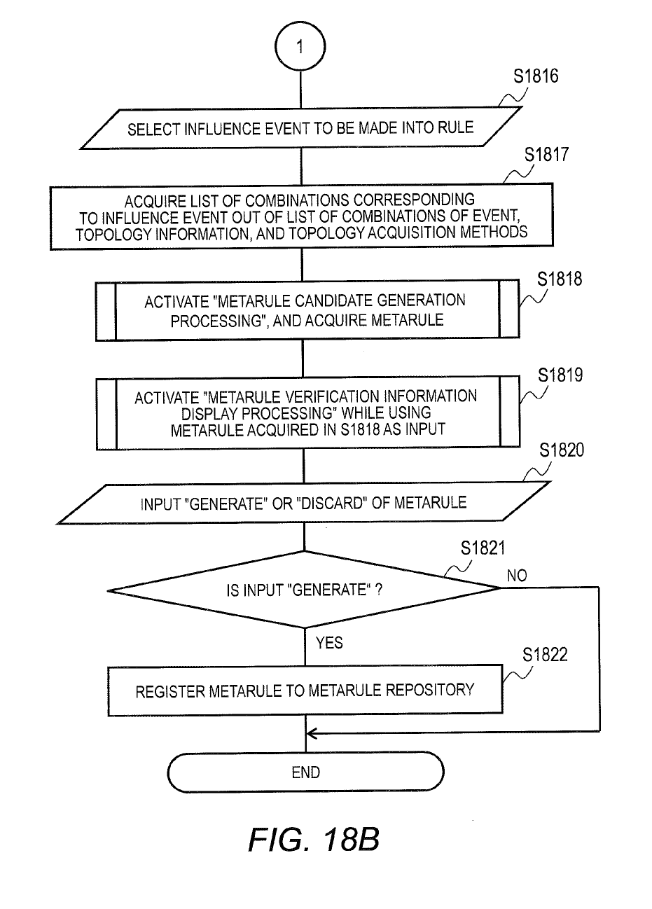

FIGS. 18A and 18B are flowcharts of an example of the metarule generation processing carried out by the metarule generation program 121 on the management computer 101 according to this example.

The metarule generation program 121 is preferred to be activated by an instruction from the input device 114 by the rule creator. Moreover, after a failure occurs on the management subject system, and the failure analysis program 123 analyzes the failure, if a condition which determines that an analysis result is not correct is satisfied, the metarule generation program 121 may be activated by the failure analysis program 123 to start processing.

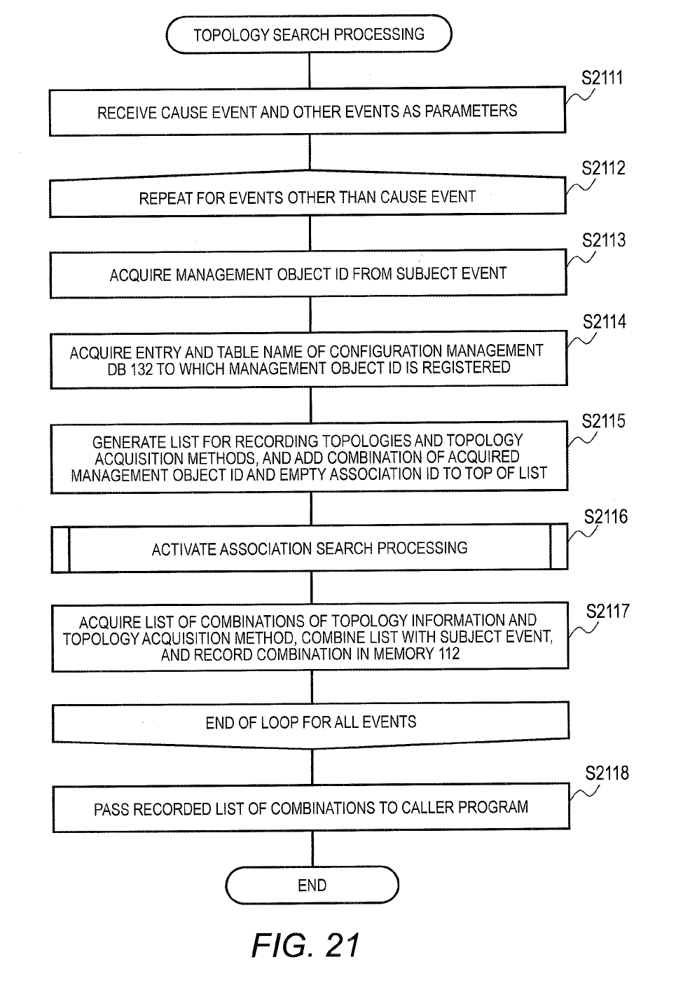

The metarule generation program 121 further invokes and carries out processing illustrated in FIGS. 21 to 27 in the processing in FIG. 18.

In Step S1811, the metarule generation program 121 activates the display module 125, acquires events occurred on the management subject system from the event table 131, and displays a cause event selection screen displaying a list of events on the output device 117.

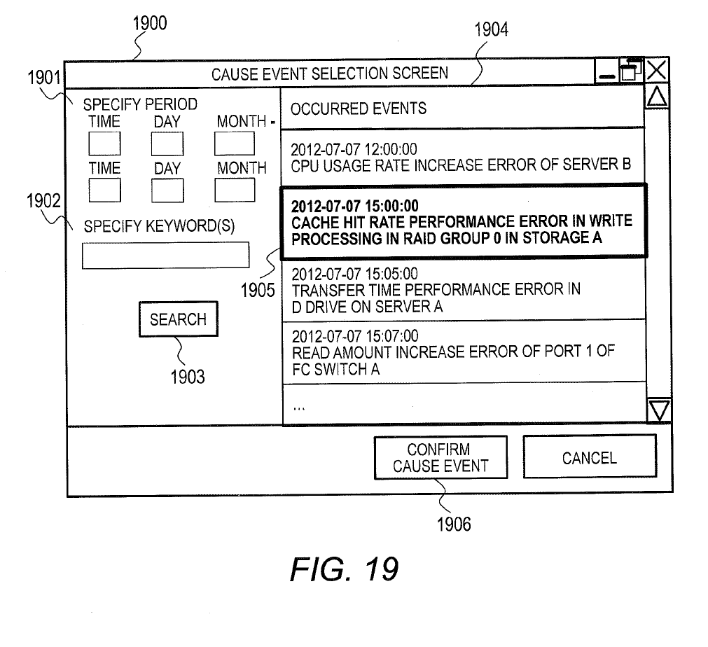

FIG. 19 is an explanatory diagram illustrating an example of a cause event selection screen 1900 according to this example.

As exemplified in FIG. 19, for example, the cause event selection screen 1900 may have a function of searching, when the rule creator inputs a period in an input form 1901, and operates a search button 1903, the event table 141 for events occurred in the input period, and displaying a list thereof on an event display part 1904. Alternatively, as exemplified in FIG. 19, the cause event selection screen 1900 may have a function of searching, when a string is input in the input form 1902 and the search button 1903 is operated, the event table 131 for events including the input string, and displaying a list of the searched events on the event display part 1904. Alternatively, events can be sequentially traced starting from the latest event to older events in the event table 131.

In Step S1812, the metarule generation program 121 receives an event selected by the rule creator as a cause event. For example, when the rule creator selects an event representing a phenomenon to be a cause of a certain system failure out of the list of events displayed on the cause event selection screen 1900 (FIG. 19) and operates a cause event confirmation button 1906, the metarule generation program 121 receives information on the selected event.

In Step S1813, the metarule generation program 121 refers to values of the date and time of occurrence field 205 of the event table 131, thereby acquiring events occurred in a predetermined period starting from occurrence time of the event received in Step S1812. For example, when the event ID of the received cause event is the event ID 201 of “EV1” in the event table 131, and the predetermined period is “within 10 minutes before and after the event,” events respectively having EV2 and EV3 in the event ID 201 are acquired from the event table 131.

In Step S1814, the metarule generation program 121 activates topology search processing while using the cause event received in Step S1812 and the event group acquired in Step S1813 as inputs, thereby acquiring combinations of an event, topology information, and a topology information acquisition method. Each of the combinations is a combination of topology information between management objects on which each of the events acquired in Step S1813 has occurred and management object on which the cause event has occurred, and means for (method of) acquiring the topology.

In Step S1815, the metarule generation program 121 activates the display module 125, and displays each of the events, the topology information, and the cause event out of the combinations of the event, the topology information, and the topology acquisition method acquired in Step S1814 on the output device 117. If a plurality of topologies overlap partially or entirely, the topologies may be unified and displayed.

Labor required for searching for the events caused by the cause event can be reduced, and omission in selection can be further prevented by displaying the events occurred in the predetermined period, and prompting the selection of events out of the occurred events in this way

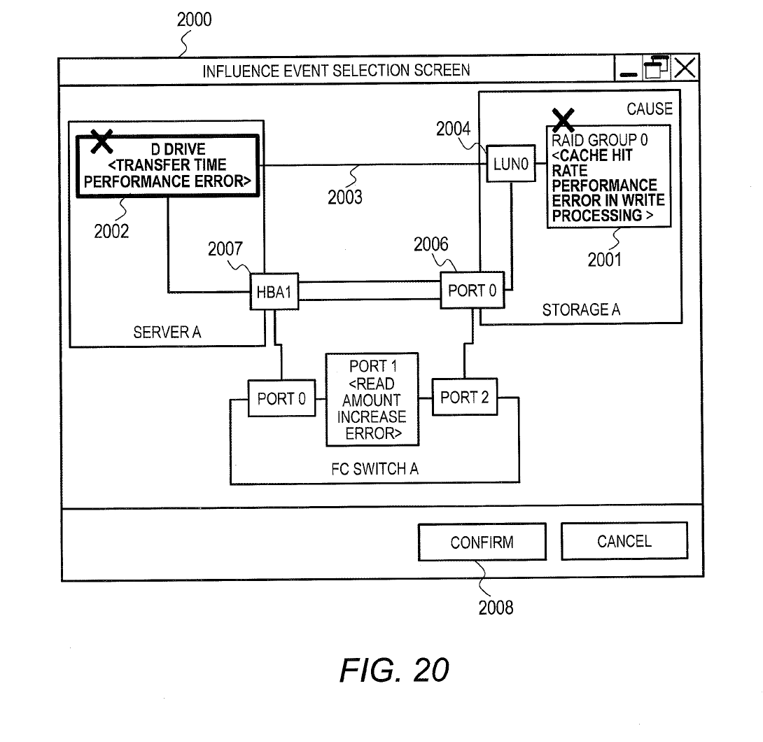

FIG. 20 is an explanatory diagram illustrating an example of an influence event selection screen 2000 displayed in Step S1815.

For example, the influence event selection screen 2000 displays information on the events acquired in Step S1812 or S1814, and information on the management objects on which the acquired events have occurred as icons 2001 and 2002. For example, the icon 2001 represents that the event is “the cache hit rate performance error in the write processing in the RAID group 0 in the storage A”. Moreover, the icon 2001 may include a display representing that the event is a cause event.

Moreover, a connector 2003 represents association between two management objects, and, for example, it is possible to show by coupling the icons 2002, 2004, and 2001 to each other with the connector 2003 that there is a topology between a D drive of a server A and a RAID group of the storage A of the D drive of the server A uses the logical volume on the storage A having 0 in LUN ID as a storage capacity, and further the logical volume having 0 in LUN ID is generated on the RAID group 0″. It should be noted that meaning of the connector (such as “used” and “mounted”) may be displayed on the connector 2003.

Moreover, a plurality of topologies may be displayed for specific two management objects. For example, the D drive of the server A and the RAID group 0 of the storage A also have a topology represented by icons 2002, 2007, 2006, 2004, and 2001, and a connector coupling therebetween. Moreover, if there is an event which has already been made into a rule for a cause event by means of a metarule 300, the event made into a rule may be displayed on the influence event selection screen 2000 in order not to generate the same metarule.

A description now returns to the description of the processing by the metarule generation program 121.

In Step S1816, the metarule generation program 121 receives an event selected by the rule creator as an influence event. A plurality of influence events may be selected.

For example, the rule creator selects an event which is caused by the cause event selected in Step S1812 out of the icons displayed on the influence event selection screen 2000 in FIG. 20, and operates a confirm button 2008. The metarule generation program 121 receives information on the selected event.

In Step S1817, the metarule generation program 121 acquires all combinations of the topology information and the topology acquisition method corresponding to the influence event received in Step S1816 out of the list of the combinations of the event, the topology information, and the topology acquisition method acquired in Step S1814.

In Step S1818, the metarule generation program 121 activates metarule candidate generation processing while using the cause event received in Step S1812, the influence event received in Step S1816, and the combinations of the event, the topology information, and the topology acquisition method acquired in Step S1817 as inputs, thereby acquiring a metarule 300.

In Step S1819, the metarule generation program 121 activates metarule verification information display processing while using the metarule acquired in Step S1818 as an input. The metarule verification information display processing is processing of displaying hint information for verifying whether the generated metarule can be used to carry out correct failure analysis.

In Step S1820, the metarule generation program 121 receives a determination to “generate” or “discard” the metarule input by the rule creator.

In Step S1821, the metarule generation program 121 verifies whether the input in Step S1820 is “generate”. If the condition is satisfied (the input is “generate”), the processing proceeds to Step S1822, and if the condition is not satisfied, the processing is ended.

In Step S1822, the metarule generation program 121 registers the metarule acquired in Step S1818 to the metarule repository 135.

FIG. 21 is a flowchart of an example of the topology search processing carried out in Step S1814 of the metarule generation program 121 according to this example.

The topology search processing is processing of searching the configuration management DB 132 for association from a management object on which an input cause event has occurred to a management object on which each of events other than the cause event has occurred, thereby extracting a topology between the two management objects. Moreover, the topology search processing records how to trace the association when the association is searched for, thereby generating means (topology acquisition method) for acquiring a topology to which a metarule is applied from the configuration management DB 132.

In Step S2111, a topology search subprogram receives, as parameters, an entry in the event table 131 including a cause event and events other than the cause event.

In Step S2112, the topology search subprogram repeats the processing from Step S2113 to S2117 for the events other than the cause event.

In Step S2113, the topology search processing acquires a value of the component ID 203 (if the component ID is NULL, a value of the apparatus ID 202) of a subject event.

In Step S2114, the topology search subprogram acquires a table name and an entry of the configuration management DB 132 to which the management object ID (the component ID 203 or the apparatus ID 202) acquired in Step S2113 is registered. The table of the configuration management DB 132 from which the entry is acquired may be a table of the configuration management DB 132 representing configuration information at an occurrence time of the subject event or an occurrence time of the cause event. Moreover, all of the entries acquired from the configuration management DB 132 may be entries of a table of the configuration management DB 132 representing the configuration information at the occurrence time of the subject event or the occurrence time of the cause event for processing including association search processing which is invoked subsequently.

The tables of the configuration management DB 132 are generated for the respective types of the management object according to this example. Therefore, the table name is acquired in Step S2114, but another piece of identification information representing the type of the management object may be acquired in place of the table name.

In Step S2115, the topology search subprogram generates a list including topology information and a topology acquisition method, and records a combination of the management object ID of the entry in Step S2113 and an empty association ID as a start point at the top of the list.

In Step S2116, the topology search subprogram activates the association search processing while using the cause event, the entry and the table name acquired in Step S2114, and the list of the combination of the management object ID and the association ID generated in S2115 as inputs. The association search processing is processing of using the entry acquired in Step S2114 as the start point, tracing association of each entry representing each of management objects based on the information in the association table 133, generating a combination of topology information and a topology acquisition method of acquiring the topology information, and recording the combination as a search result memory in the memory 112.

In Step S2117, the topology search subprogram acquires the combinations of the topology information and the topology acquisition method from the search result memory stored in the memory 112, adds information on the subject event to each of the combinations, and records the combinations in the memory 112. It should be noted that the information recorded in the search result memory may be deleted.

In Step S2118, the topology search subprogram reads the combinations of the topology information, the topology acquisition method, and the event recorded in Step S2117, and returns the combinations to a caller program.

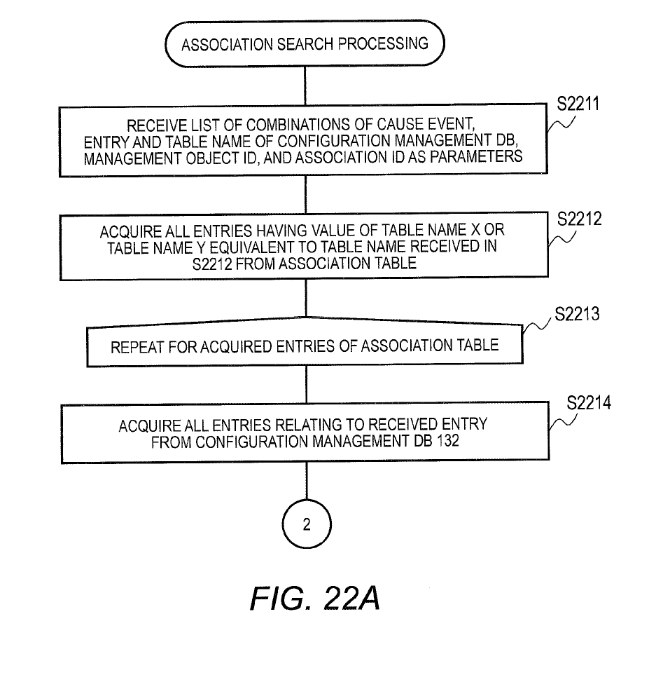

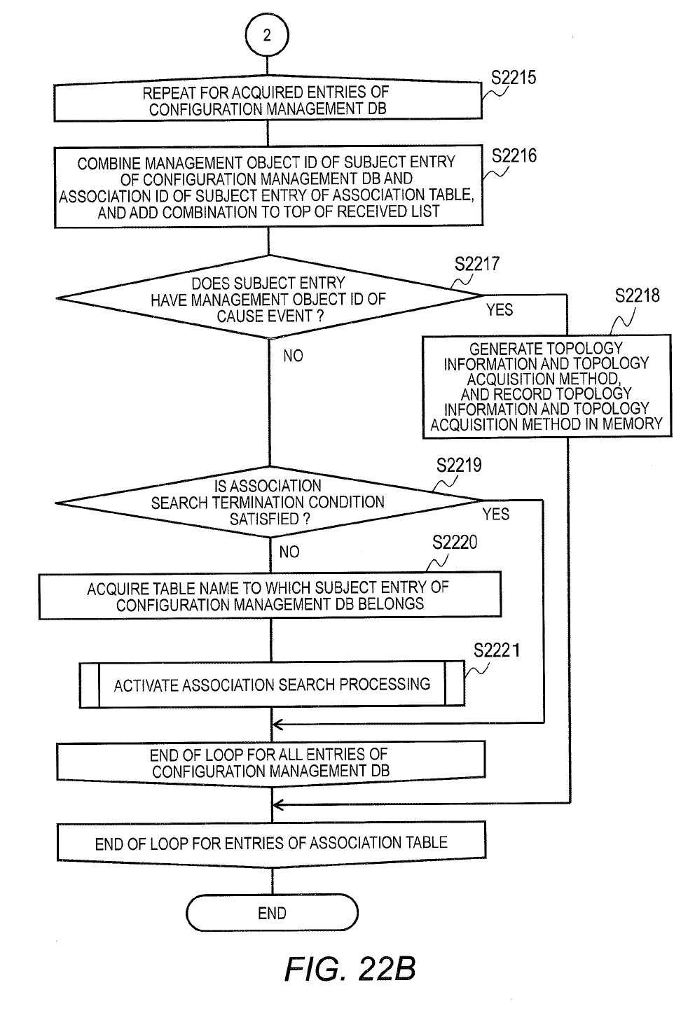

FIGS. 22A and 22B are flowcharts of an example of the association search processing carried out in Step S2116 of the topology search processing according to this example.

The association search processing traces the association from one management object as the start point to the management object on which the cause event has occurred in the configuration management DB 132 based on the information in the association table 133, thereby acquiring the topology information from the start point management object to the cause management object. Moreover, the association search processing is processing of simultaneously generating, when the association is searched for, the topology acquisition method by recording how to trace the association, and recording the combination of the topology information and the topology acquisition method of acquiring the topology information as the search result memory in the memory 112.

If a failure event occurs on a certain apparatus, all management objects on a topology are influenced, but events of all the management objects on the topology may not be detected depending on state information and performance information on the management object which the management computer 101 can acquire. Therefore, a cause management object and influence management objects specified by the rule creator may not always directly associate with each other, and the association between the management objects needs to be traced as the association search processing represents.

In this example, among path search algorithms, an algorithm for the depth-first search publicly known in the art may be used as an algorithm for searching for the association if entries of the configuration management DB 132 are considered as nodes, but other algorithms (such as the breadth-first search) may be used. Moreover, the search may not be started from one node, but the search may start from both the cause management object and the influence management objects.

In Step S2211, an association search subprogram receives, as parameters, the cause event, the entry and the table name of the configuration management DB 132, and the list of combinations of the management object ID and the association ID.

In Step S2212, the association search subprogram acquires all entries equal to the received table name in the value of the table name X 1502 or the table name Y 1504 from the association table 133.

In Step S2213, the association search subprogram repeats processing from Step S2214 to S2221 for the entries in the association table 133 acquired in Step S2212.

In Step S2214, the association search subprogram acquires all entries associating with the received entry of the configuration management DB 132 from the configuration management DB 132 based on the correspondence between the management object types in the configuration management DB 132 registered to a subject entry of the association table 133. In other words, for example, if the received table name is stored in the table name X 1502 of the subject entry, the association search subprogram acquires a field name A stored in the field name X 1503, and acquires a value B stored in a field corresponding to the field name A of the received entry. Then, the association search subprogram acquires the list of the entries storing a value equal to the value B in a field corresponding to the field name stored in the field name Y 1505 from a table of the configuration management DB 132 having a table name stored in the table name Y 1504 of the subject entry.

In Step S2215, the association search subprogram repeats processing from Step S2216 to S2221 for the entries in the configuration management DB 132 acquired in Step S2214.

In Step S2216, the association search subprogram adds a combination of a component ID (an apparatus ID for an entry relating to an apparatus) of a subject entry of the configuration management DB 132 and an association ID 1501 of the subject entry of the association table 133 as information on a leading end management object (leading end node) of the topology being searched for at the top of the received list.

In Step S2217, the association search subprogram determines whether the component ID (or apparatus ID if the component ID is NULL) of the cause event and the component ID (or the apparatus ID) of the subject entry in the configuration management DB 132 are equal to each other. If the condition is satisfied, the processing proceeds to Step S2218. On the other hand, if the condition is not satisfied, the processing proceeds to Step S2219.

In Step S2218, the association search subprogram makes, based on the list of the combinations of the management object ID and the association ID, a list of the management object IDs into the topology information, and a list of the association IDs into the topology acquisition method, and records a combination of the topology information and the topology acquisition method as the search result memory in the memory 112. Moreover, the repeated processing from Step S2115 is ended.

In Step S2219, the association search subprogram verifies whether an association search termination condition is satisfied. If the condition is satisfied, the association search subprogram carries out the repeated processing from the Step S2215 for a next entry of the configuration management DB. On the other hand, if the condition is not satisfied, the processing proceeds to Step S2220.

The termination condition for the association search in Step S2219 may be such a condition that the same management object ID is recorded in the list of the combinations of the management object ID and the association ID, namely, the search returns to the same management object. Moreover, a part of the topology may not be searched for in order to reduce a processing period of the topology search processing, in other words, a subsequent search may be terminated if the number of elements in the list of the combinations of the management object ID and the association ID becomes equal to or more than a certain number. Moreover, if a pattern improbable as a topology in terms of the data model of the configuration management DB 132 can be defined in advance, the pattern may be set to condition to terminate a further search. For example, in case where a condition for terminating a further search can be defined if a trace is made from a component on a certain server via a component on a storage to a component on another server or a component on a switch, the condition may be set to terminate the further search.

In Step S2220, the association search subprogram acquires a table name to which the subject entry belongs from the configuration management DB 132.

In Step S2221, the association search subprogram activates the association search processing for recursive call while using the received cause event, the subject entry of the configuration management DB 132, the table name acquired in Step S2220, and the list of the combinations of the management object ID and the association ID as inputs.

A description is given below of a specific example of acquiring the list of the combinations of the topology information, the topology acquisition method, and the event in the topology search processing and the association search processing.

For example, in Step S2111, the topology search subprogram receives the entry 211 in FIG. 2 as the cause event, and the entry 212 as the event other than the cause event. If the entry 212 is selected in the repeated processing in Step S2112, the topology search subprogram acquires a component ID “DRIVE1” from the component ID 203 of the entry 212 (Step S2113).

Then, the topology search subprogram acquires an entry 811 storing the component ID “DRIVE1” and the name “DISK DRIVE” of the table storing the entry 811 (Step S2114). Then, the topology search subprogram generates the list to record the topology information and the topology acquisition methods, and adds the component ID “DRIVE1” and an empty association ID at the top (Step S2115).

Then, the topology search subprogram activates the association search processing while using the entry 211, the entry 811, the table name “DISK DRIVE”, and the list including the element “DRIVE1” at the top as inputs (Step S2116). The association search processing receives these values as the parameters (Step S2211).

Then, the association search subprogram acquires entries 1511, 1512, and 1513 having “DISK DRIVE” as the value of the field of the table name X 1502 or the table name Y 1504 from the association table 133 (Step S2212). If the entry 1513 is selected in the repeated processing in Step S2213, the association search subprogram acquires a value “20:00:00:00:00:00:00:01” of the coupling destination target WWN 805 and a value “0” of the LUM_ID 806 in the entry 811. Then, the association search subprogram refers to the logical volume table 900 of the configuration management DB, and acquires an entry 911 having “20:00:00:00:00:00:00:01” as the value of the field of the WWN 902 and “0” as the value of the field of the LUM_ID 903 (Step S2214).

If the entry 911 is selected in the repeated processing starting from Step S2214, a component ID “VOL1” of the entry 911 and an association ID “AS3” of the entry 1513 are combined, and are added to the top of the received list (Step S2216). Thus, at this time point, the list has elements and a sequence of “VOL1, AS3”—“DRIVE1, empty”.

Then, in Step S2217, the component ID “VOL1” of the entry 911 and the component ID of the entry 212 of the cause event are different from each other, and the processing thus proceeds to Step S2219. In Step S2219, if the association search termination condition is not satisfied, the processing proceeds to Step S2220.

Then, the association search subprogram acquires the table name “logical volume” to which the entry 911 belongs (Step S2220). Then, the association search subprogram activates the association search processing while using the entry 212 of the cause event, the entry 911, the table name “logical volume”, and the list “VOL1, AS3”—“DRIVE1, empty” as inputs. In the subsequent association search processing, if the association search subprogram selects an entry 1522 in the repeated processing in Step S2213, and selects an entry 1011 in Step S2215, the entry 1011 includes a component ID “RG1” of the cause event in Step S2217, and the processing thus proceeds to Step S2218.

Then, the association search subprogram generates topology information “RG1-VOL1-DRIVE1” and a topology acquisition method “AS12-AS3” from a list “RG1, AS12”—“VOL1, AS3”—“DRIVE1, empty”, combines both thereof, and stores the combination as a search result memory in the memory 112.

In this way, a plurality of the combinations of topology information and a topology acquisition method are recorded in the memory 112. The processing returns to Step S2117 of the topology search processing, and if the topology search subprogram acquires, for example, the combination of the topology information “RG1-VOL1-DRIVE1” and the topology acquisition method “AS12-AS3” from the search result memory, the topology search subprogram combines the combination with the entry 212 representing the event, and stores the combination in the memory 112 (Step S2118). Then, the topology search subprogram passes the information recorded in Step S2117 to a caller program.

A topology is searched for, for the each event, from a management object on which the event has occurred to a cause management object in the “topology search processing” according to this example, thereby generating the topology acquisition method. In contrast, when a topology corresponding to a certain event is searched for, if a management object on which another event has occurred is traced during the search, such processing as omitting the topology search processing for the management object which appears in the course may be carried out to accelerate the processing.

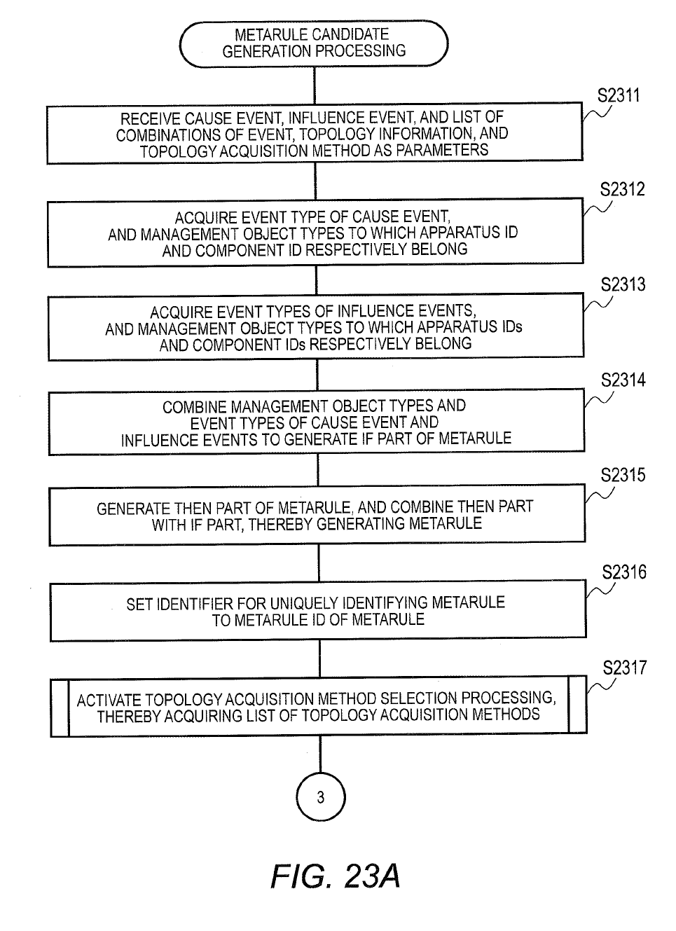

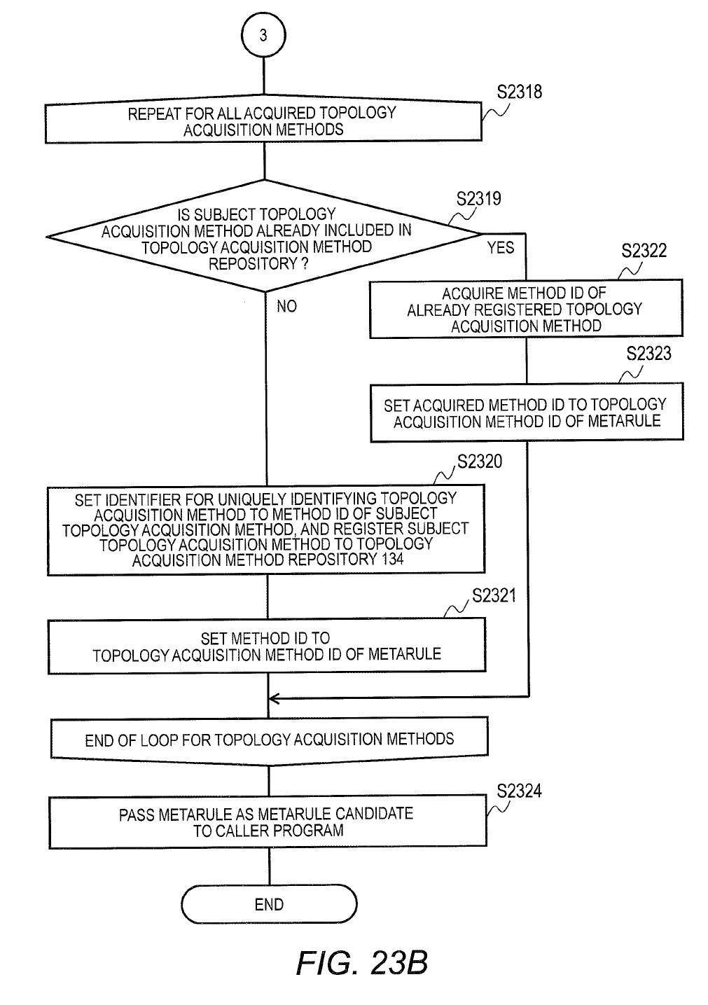

FIGS. 23A and 23B are flowcharts of an example of the metarule candidate generation processing carried out in Step S1818 of the metarule generation program 121 according to this example.

The metarule candidate generation processing is processing of generating a metarule 300 from a topology acquisition method acquired by the topology search processing, and a cause event and an influence event specified by the rule creator, and presenting the metarule 300 as a new metarule candidate to the rule creator.

In Step S2311, a metarule candidate generation subprogram receives an entry of the event table 131 representing a cause event, an entry of the event table 131 representing an influence event, and a list of combinations of an event, topology information, and a topology acquisition method acquired from the topology search processing as parameters.

In Step S2312, the metarule candidate generation subprogram acquires a value of the event type 204 of the cause event, an apparatus type to which a value stored in the apparatus ID 202 belongs, and a component type to which a value stored in the component ID 203 belongs. Each of the tables of the configuration management DB 132 is generated for each of the types of the management object according to this example, and hence a table name of the configuration management DB 132 to which each of the management object IDs belongs is acquired.

In Step S2313, the metarule candidate generation subprogram acquires a value of the event type 204 of the influence event and a management object type (a table name of the configuration management DB 132) to which the apparatus ID 202 or the component ID 203 belongs.

In Step S2314, the metarule candidate generation subprogram combines the apparatus types, the component types, and the event types acquired in Steps S2312 and S2313 to generate the IF part 311 of a metarule.

In Step S2315, the metarule candidate generation subprogram combines the apparatus type, the component type, and the event type of the cause event acquired in Step S2312 to generate the THEN part 312 of the metarule. Then, the metarule candidate generation subprogram combines the IF part 311 generated in Step S2314 and the THEN part 312 generated in Step S2315 to generate the metarule 300.

In Step S2316, the metarule candidate generation subprogram sets an identifier which can uniquely identify a metarule in the metarule repository 135 to the metarule ID 313 of the metarule 300 generated in Step S2315.

In Step S2317, the metarule candidate generation subprogram extracts the list of the combinations of the topology information and the topology acquisition method from the received list of the combinations of the event, the topology information, and the topology acquisition method. Then, the metarule candidate generation subprogram activates topology acquisition method selection processing while using the extracted list as an input. The topology acquisition method selection processing is processing of acquiring a topology acquisition method list used by a metarule out of the input list of the topology acquisition methods.

In Step S2318, the metarule candidate generation subprogram repeats processing from Step S2319 to S2323 for all the topology acquisition methods acquired in Step S2317.

In Step S2319, the metarule candidate generation subprogram determines whether a subject topology acquisition method is included in the topology acquisition method repository 134. If the condition is satisfied, the processing proceeds to Step S2322. On the other hand, if the condition is not satisfied, the processing proceeds to Step S2320.

In Step S2320, the metarule candidate generation subprogram sets an identifier uniquely identifiable in the topology acquisition method repository 134 to the method ID 1601 of the subject topology acquisition method 1600, and registers the subject topology acquisition method 1600 to the topology acquisition method repository 134.

In Step S2321, the metarule candidate generation subprogram sets the identifier set to the method ID 1601 in Step S2320 to the topology acquisition method ID 314 of the metarule 300.

Moreover, if the processing proceeds to Step S2322 in Step S2319, in Step S2322, the metarule candidate generation subprogram acquires a value of the method ID 1601 of a method 1600 equal to the subject topology acquisition method from the topology acquisition method repository 134.

In Step S2323, the metarule candidate generation subprogram sets the value of the method ID 1601 acquired in Step S2322 to the topology acquisition method ID 314 of the metarule 300.

Then, in Step S2324, the metarule candidate generation subprogram passes the generated metarule 300 to a caller program of the metarule candidate generation processing. If a plurality of topology acquisition methods stored in Step S2321 or S2323 are coincident with one another partially or entirely in the list of association IDs, the topology acquisition methods may be combined to generate one topology acquisition method, and the one topology acquisition method may be registered to the topology acquisition method ID 314 of the metarule 300.

For example, in Step S2311, if the entry 211 of the event table 131 is acquired as a cause event, and the entry 212 is acquired as an influence event, and, in Step S2317, the topology acquisition method 1600 illustrated in FIG. 16A is acquired, the metarule 300 illustrated in FIG. 3 is generated.

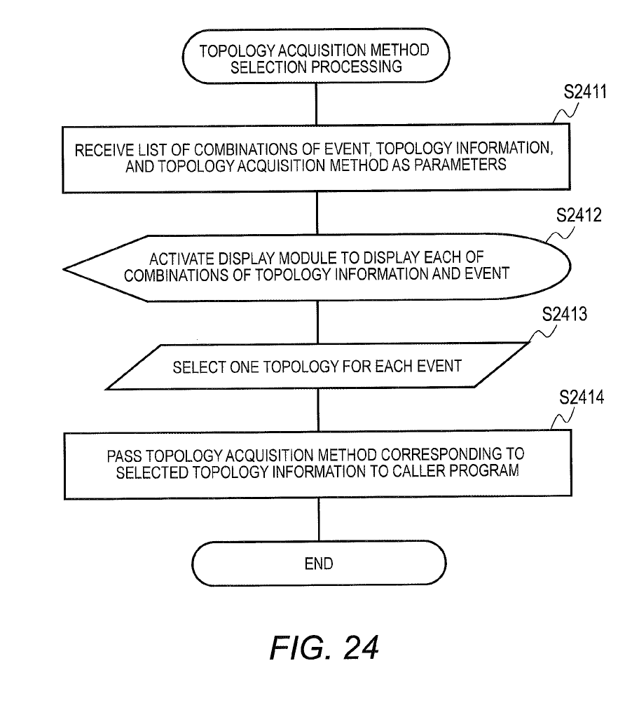

FIG. 24 is a flowchart of an example of the topology acquisition method selection processing carried out in Step S2317 of the metarule candidate generation processing according to this example.

The topology acquisition method selection processing presents topology information corresponding to each of influence events to the rule creator, and permits the rule creator to select one topology acquisition method corresponding to each of the influence events, thereby narrowing down one or a plurality of topology acquisition methods into a method used by the metarule 300.

In Step S2411, a topology acquisition method selection subprogram receives a list of combinations of an event, topology information, and a topology acquisition method as parameters.

In Step S2412, the topology acquisition method selection subprogram activates the display module 125, and displays the received combinations of the event and the topology information on the output device 117.

In Step S2413, the topology acquisition method selection subprogram receives topology information on a topology selected by the rule creator for each of the influence events.

In Step S2414, the topology acquisition method selection subprogram acquires a topology acquisition method corresponding to the topology information received in Step S2413 out of the list of the combinations of the topology information and the topology acquisition method received in Step S2411, and passes the topology acquisition method to a caller program.

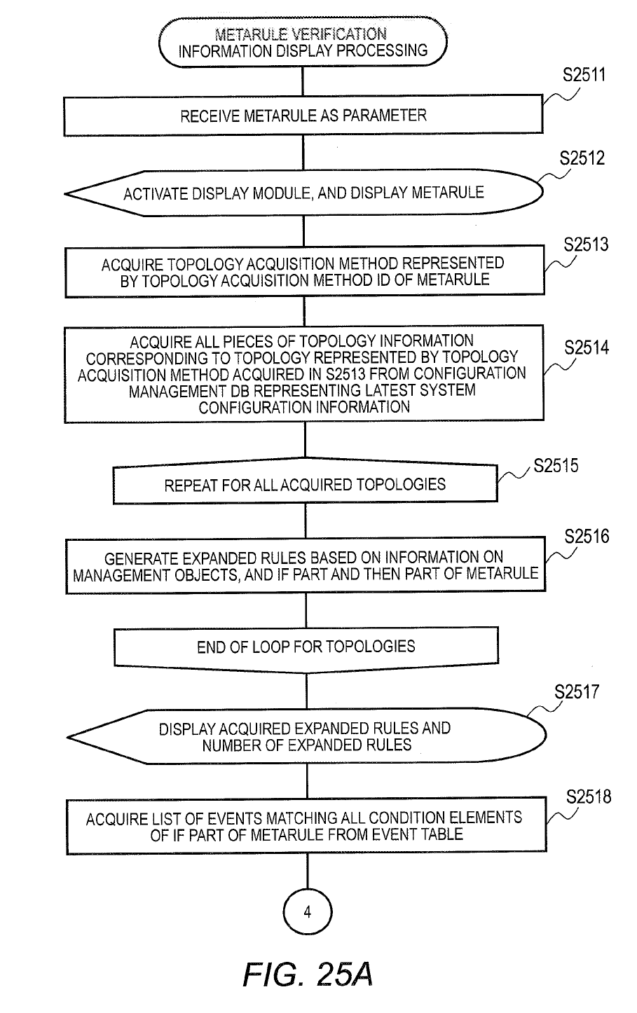

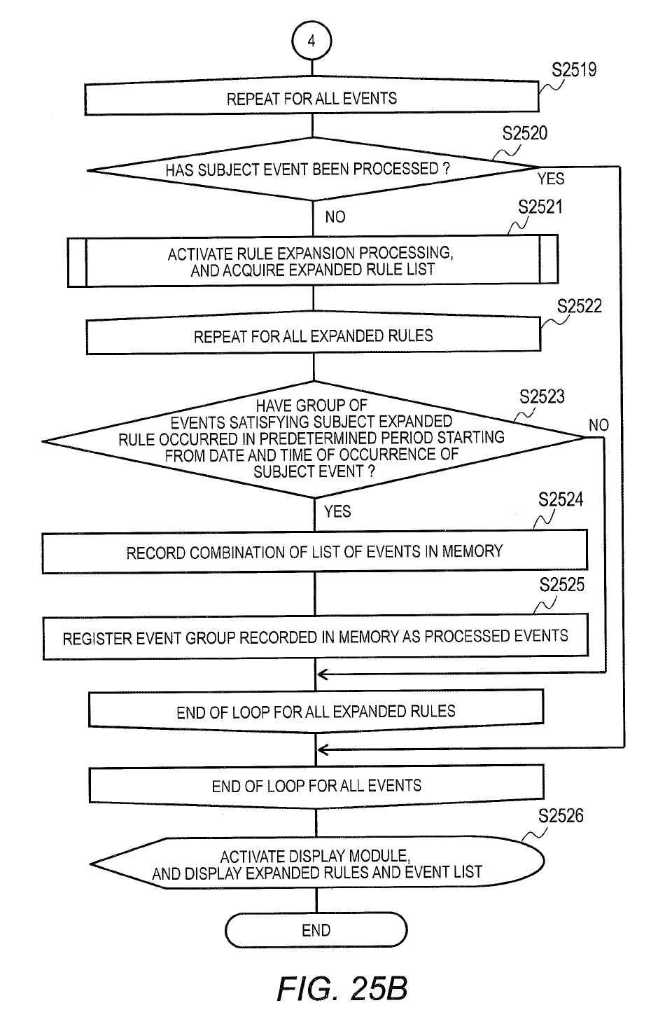

FIGS. 25A and 25B are flowcharts of an example of the metarule verification information display processing carried out in Step S1819 of the metarule generation program 121 according to this example.

The metarule verification information display processing is processing of displaying the hint information for verifying whether the generated metarule can be used to carry out correct failure analysis. The rule creator determines whether to use the metarule 300 generated by the metarule generation program 121 in Step S1818 for subsequent analysis of a failure occurred on the management subject system based on the displayed hint information. Specifically, the following two points are displayed as the information for the verification.

(1) The metarule 300 is applied to a configuration of the latest management subject system, expanded rules are generated, and all or a part of the expanded rules are displayed. Moreover, the number of the expanded rules generated in correspondence to the one metarule 300 is displayed. As a result, whether correct expanded rules are generated and whether the number of expanded rules is larger or smaller with respect to the number of apparatus constituting the management subject system can be verified if the metarule 300 is applied to an actual management subject system configuration based on the topology acquisition method selected by the topology acquisition method selection processing.

(2) Whether the metarule 300 is effective for a failure which has occurred in the past is displayed. In other words, whether such an example that events represented by the IF part 311 of the metarule have occurred at the same timing exists in the past is determined. If such an example that the events have occurred at the same timing exists, the number of times of occurrence is derived based on the information in the event table 131, and the derived number of times of occurrence is displayed. If such an example that the events represented by the IF part 311 of the metarule have occurred at the same timing exists in the past, it is understood that the metarule is effective.

In Step S2511, a metarule verification information display subprogram receives a metarule 300 as a parameter.

In Step S2512, the metarule verification information display subprogram activates the display module 125, and displays the metarule on the output device 117.

In Step S2513, the metarule verification information display subprogram acquires a topology acquisition method 1600 represented by the topology acquisition method ID 314 of the metarule 300 from the topology acquisition method repository 134.

In Step S2514, the metarule verification information display subprogram acquires all pieces of topology information corresponding to topologies represented by the topology acquisition method 1600 in Step S2513 from the configuration management DB 132 representing the latest system configuration information.

In Step S2515, the metarule verification information display subprogram repeats processing in Step S2516 for all the topologies acquired in Step S2514.

In Step S2516, the metarule verification information display subprogram extracts entries corresponding to condition elements in the IF part 311 and entries corresponding to a component type or an apparatus type specified by the THEN part 312 of the metarule 300 from a list of entries in a subject topology information. Then, the metarule verification information display subprogram generates expanded rules 1700 by combining the extracted entries and the information in the metarule 300.

In Step S2517, the metarule verification information display subprogram displays the expanded rules acquired in Step S2516 and the number of the acquired expanded rules in addition to the information in the metarule displayed in Step S2512.

For example, if the metarule 300 is received in Step S2511, and the tables of the configuration management DB 132 representing the latest configuration information are the tables shown in FIGS. 4 to 13, the topology acquisition method acquired in Step S2513 is the topology acquisition method 1600 illustrated in FIG. 16A, and the topology information acquired in Step S2514 is three pieces of information “Entry 811 (DRIVE1), Entry 911 (VOL1), Entry 1011 (RG1)”, “Entry 812 (DRIVE2), Entry 913 (VOL3), Entry 1013 (RG3)”, and “Entry 914 (DRIVE4), Entry 912 (VOL2), Entry 1012 (RG2)”. In Step S2516, expanded rules 1700A, 1700B, and 1700C illustrated in FIGS. 17A to 17C are generated based on the three pieces of topology information and the metarule 300. Therefore, these three expanded rules and the number of the generated expanded rules “3” are displayed on the output device 117 in Step S2517.

In Step S2518, the metarule verification information display subprogram searches the event table 131 for events matching all condition elements in the IF part 311 of the received metarule 300, and acquires the events.

A search range may be all the entries in the event table 131, or may be limited to events occurred in a specific period. In this case, the rule creator can determine the period.

For example, if the received metarule is the metarule 300 illustrated in FIG. 3, and the event table 131 is the table shown in FIG. 2, the condition elements of the metarule 300 are “storage RAID group WriteHitPerfError” and “server disk drive AverageSecPerXferError”. Thus, events matching the condition elements are the entries 211 and 212 in FIG. 2.

In Step S2519, the metarule verification information display subprogram repeats processing from Step S2520 to S2526 for all the events acquired in Step S2518.

In Step S2520, the metarule verification information display subprogram determines whether a subject event has been processed. If the condition is satisfied, the metarule verification information display subprogram carries out the repeated processing from the Step S2519 for a next event. On the other hand, if the condition is not satisfied, the processing proceeds to Step S2521.

In Step S2521, the metarule verification information display subprogram activates rule expansion processing while using the metarule 300, and the date and time of occurrence 205 of the subject event, the apparatus ID 202, the component ID 203, and the event type 204 as inputs, thereby acquiring an expanded rule list.

In Step S2522, the metarule verification information display subprogram repeats processing from Step S2523 to S2526 for all the expanded rules acquired in Step S2521.

In Step S2523, the metarule verification information display subprogram determines whether all the events described in the IF part 1711 of a subject expanded rule are generated in a predetermined period starting from the date and time of occurrence of the subject event in the event table 131. If the condition is satisfied, the processing proceeds to Step S2524. On the other hand, if the condition is not satisfied, the metarule verification information display subprogram carries out the repeated processing from the Step S2522 for a next expanded rule.

In Step S2524, the metarule verification information display subprogram records a combination of the subject expanded rule and the events matching the events described in the IF part 171 of the expanded rule 1700 (including the subject event) in Step S2523 in the memory 112.

For example, if the expanded rule is the expanded rule 1700 illustrated in FIG. 17A, the event is the event 211 in FIG. 2, and the “predetermined period” is 10 minutes before and after the event, referring to the event table 131 shown in FIG. 2, the event represented by the entry 212 has occurred 5 minutes after the occurrence of the entry 211, and the entries 211 and 212 satisfy all the events described in the IF part 1711 of the expanded rule 1700 illustrated in FIG. 17A. Therefore, the conditions in Step S2523 are satisfied. Thus, in Step S2524, a combination of the expanded rule 1700 and the entries 211 and 212 representing the events is recorded in the memory 112.

In Step S2525, the metarule verification information display subprogram registers the entire list of events recorded in Step S2524 as processed events.

In Step S2526, the metarule verification information display subprogram displays the expanded rules and the list of events (or combinations thereof) and the number of the combinations recorded in Step S2524 in addition to the display in Step S2517.

Thus, the contents and the number of times of occurrence of failure examples to which the metarule 300 previously generated is applied can be presented to the rule creator in Step S2526. Moreover, whether an expanded rule is correct can be verified by comparing the history of the events and the expanded rule.

For example, in the method illustrated in FIGS. 25A and 25B, if the number of failure examples to which the metarule 300 is applied is small, such a determination that condition elements described in the IF part of the metarule 300 may include excessive condition elements can be made. If the IF part includes excessive condition elements, an “event reception rate of expanded rule”, which is described later, becomes less than 100% when a failure is analyzed, and an appropriate failure analysis result cannot be presented.

The method illustrated in FIGS. 25A and 25B displays only failure events represented by the IF part of a metarule out of the event table, but other failure events which occurred in a predetermined period starting from the occurrence times of these failure events may be additionally displayed. As a result, whether condition elements described in the IF part of a generated metarule are insufficient can be determined. If condition elements in the IF part are insufficient, the “event reception rate of expanded rule”, which is described later, becomes more than a value which is originally required to be achieved, and an appropriate failure analysis result cannot be presented.

Moreover, the method illustrated in FIGS. 25A and 25B once generates expanded rules from a metarule in Step S2521, and, then, failure events matching condition elements in the IF part thereof are searched for in the event table. As a result, the search subjects can be limited to topologies to which the metarule is applied, and then whether failure examples corresponding to the metarule have occurred can be presented.

The metarule may not be applied to all pieces of topology information acquired by the subject topology acquisition method, but the metarule may be applied to a part of the pieces of topology information in order to accelerate the processing in Step S2514. In this case, in Step S2517, an approximate value representing a percentage of the extracted pieces of topology information with respect to the number of all pieces of topology information which can be acquired by the subject topology acquisition method may be displayed.

Moreover, in Step S2526, not only the number of combinations of the expanded rule and the event list recorded in Step S2524, but also the number of times (or rate) of satisfaction of the conditions in the IF part of the expanded rule in correspondence to the number of times of past occurrence of events described in the THEN part of the expanded rule may be displayed in Step S2523.

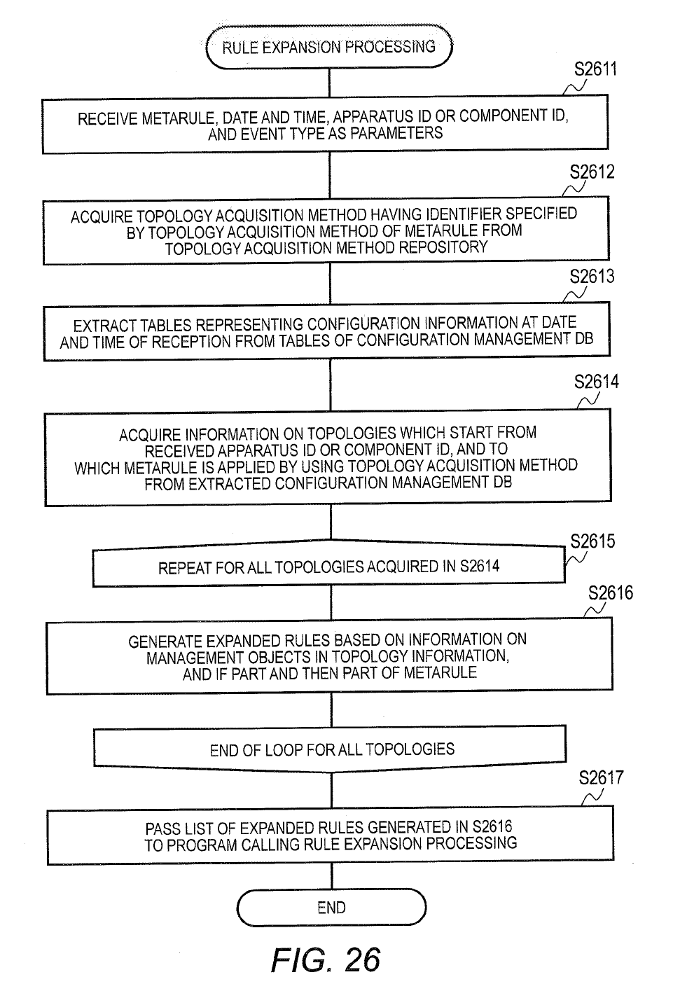

FIG. 26 is a flowchart of an example of the rule expansion processing carried out in Steps 2516 and 2521 of the metarule verification information display processing and Step S2715 of the failure analysis program 123 according to this example.

The rule expansion processing is processing of applying an input metarule to a topology starting from a management object represented by an input component ID (or apparatus ID), thereby generating an expanded rule. An input time point specifies a time point of the configuration management DB 132 used to acquire the topology information.

In Step S2611, a rule expansion subprogram receives a metarule 300, a date and time, a component ID (or apparatus ID), and an event type as parameters.

In Step S2612, the rule expansion subprogram acquires a topology acquisition method 1600 having an identifier specified by the topology acquisition method ID 314 of the metarule 300 from the topology acquisition method repository 134.

In Step S2613, the rule expansion subprogram extracts tables representing configuration information at the date and time received in Step S2611 out of the tables of the configuration management DB 132

In Step S2614, the rule expansion subprogram acquires topology information starting from the received apparatus ID or component ID to which the metarule is applied from the tables of the configuration management DB 132 extracted in Step S2613 based on the topology acquisition method 1600 acquired in Step S2612.

For example, in Step S2611, the rule expansion subprogram receives the component ID “RG1” in Step S2611 and the topology acquisition method 1600 illustrated in FIG. 16A in Step S2612. Then, if the tables of the configuration management DB 132 extracted in Step S2613 are the tables shown in FIGS. 4 to 13, one topology “Entry 1011 (RG1), Entry 911 (VOL1), Entry 811 (DRIVE1)” is acquired.

In Step S2615, the rule expansion subprogram repeats processing in Step S2616 for all the pieces of the topology information acquired in Step S2614.

In Step S2616, the rule expansion subprogram extracts entries corresponding to condition elements of the IF part 311 or a component type (or apparatus type) specified by the THEN part 312 of the metarule 300 from an entry list in a subject topology information, and combines information on the extracted entry and information in the metarule 300, thereby generating an expanded rule 1700.

For example, if the rule expansion subprogram receives the metarule 300 in FIG. 3 in Step S2611, and selects the topology “Entry 1011 (RG1), Entry 911 (VOL1), Entry 811 (DRIVE1)” in the repeated processing in Step S2616, the component type is the RAID group in the THEN part 312 of the metarule 300, and hence the rule expansion subprogram acquires the component ID “RG1” and the apparatus ID “StA” of the entry 1011 from the topology information, and generates “StA RG1 WriteHitPerfError” as the THEN part 1712 of the expanded rule. Similarly, the rule expansion subprogram also generates the condition element of the IF part, thereby generating an expanded rule 1700A.

In Step S2617, the rule expansion subprogram passes a list of the expanded rules 1700 generated in Step S2616 to a program calling the rule expansion processing.

### <Failure Analysis Processing>

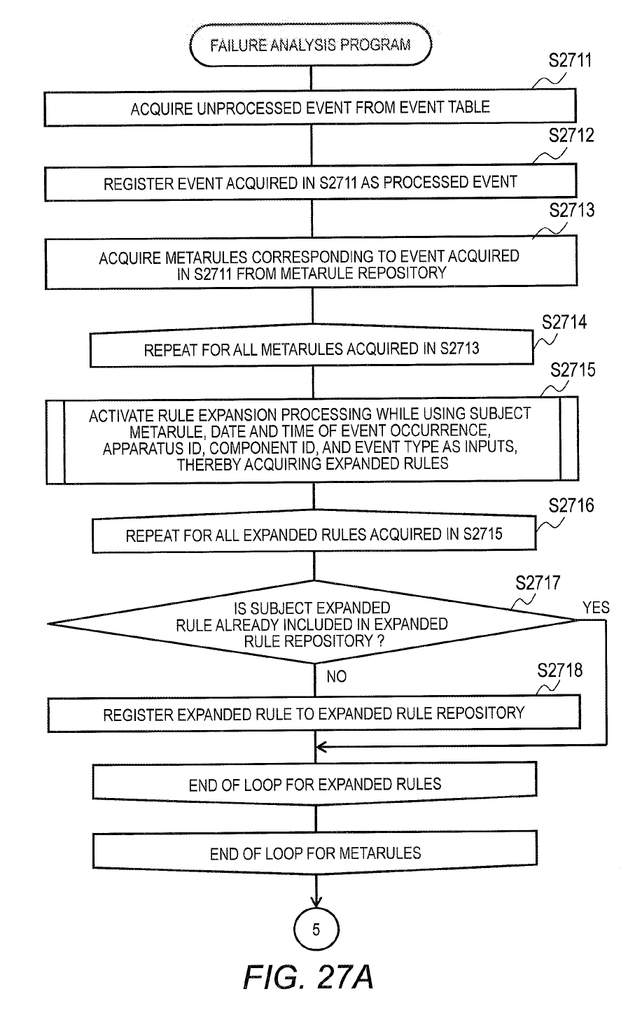

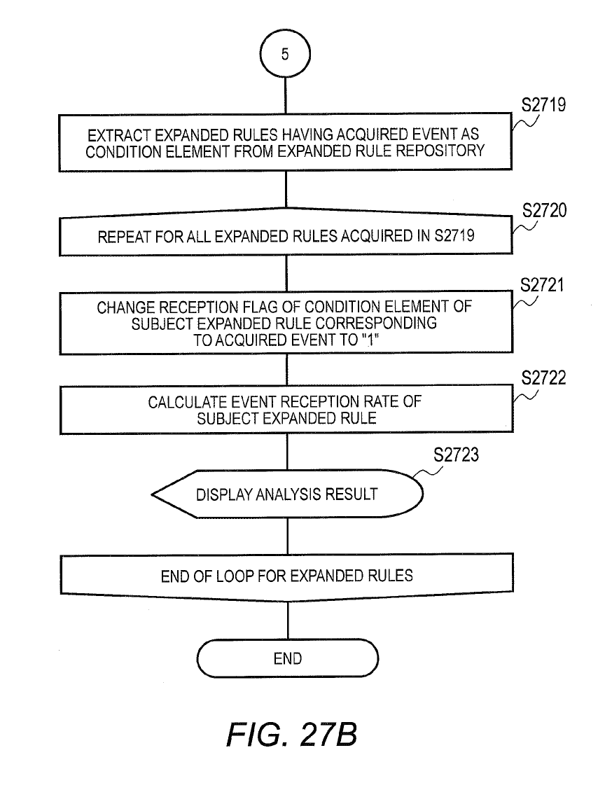

FIGS. 27A and 27B are flowcharts of an example of the failure analysis processing carried out by the failure analysis program 123 in the management computer 101 according to this example.

The failure analysis program 123 may start the processing by being invoked after the event reception program 122 receives an event from a management subject apparatus, and writes event information in the event table 131.

The failure analysis program 123 generates required expanded rules 1700 based on the received event and a metarule 300 in the metarule repository 135, and carries out the failure analysis processing to present failure cause candidates and influence range thereof to the operation administrator of the system.

In Step S2711, the failure analysis program 123 acquires an unprocessed event from the event table 131.

In Step S2712, the failure analysis program 123 registers the event acquired in Step S2711 as a processed event.

In Step S2713, the failure analysis program 123 acquires metarules 300 corresponding to the event acquired in Step S2711 from the metarule repository 135.

For example, if the failure analysis program 123 acquires the event represented by the entry 222 in Step S2711, the value of the apparatus ID 202 is “SvB”, the value of the component ID 203 is “DRIVE4”, and, thus, the apparatus type and the component type thereof are respectively “server” and “disk drive”. Therefore, the metarule 300 including the condition element “server, disk drive, AverageSecPerXferError” in the IF part of the metarule in FIG. 3 is acquired.

In Step S2714, the failure analysis program 123 repeats processing from Step S2715 to S2718 for all the metarules acquired in Step S2713.

In Step S2715, the failure analysis program 123 activates the rule expansion processing while using a subject metarule, and the date and time of occurrence 205 of the event acquired in Step S2711, the apparatus ID 202, the component ID 203, and the event type 204 as inputs, thereby acquiring an expanded rule list.

In Step S2716, the failure analysis program 123 repeats processing from Step S2717 to S2718 for all the expanded rules acquired in Step S2715.

In Step S2717, the failure analysis program 123 determines whether the subject expanded rule is already included in the expanded rule repository 136. If the condition is satisfied, the failure analysis program 123 carries out the repeated processing from the Step S2714 for a next expanded rule. On the other hand, if the condition is not satisfied, the processing proceeds to Step S2718.

In Step S2718, the failure analysis program 123 registers the subject expanded rule to the expanded rule repository 136.

In Step S2719, the failure analysis program 123 acquires a list of expanded rules including the event acquired in Step S2711 as the condition elements of the IF part 1711 from the expanded rule repository 136.

In Step S2720, the failure analysis program 123 repeats processing from Step S2721 to S2723 for all the expanded rules acquired in Step S2719.

In Step S2721, the failure analysis program 123 changes the reception flag 1704 of the condition element of the subject expanded rule corresponding to the event acquired in Step S2711 to “1”

In Step S2722, the failure analysis program 123 calculates an event reception rate of the subject expanded rule. The event reception rate of each expanded rule can be calculated by using the following equation. Event reception rate=number of condition elements having “1” in reception flag 1704/total number of condition elements.

For example, in the expanded rule 1700 illustrated in FIG. 17A, the number of condition elements is two, and the number of condition elements having “1” in the reception flag 1704 out of the two condition elements is one, and hence the event reception rate is 1/2 (50%).

In Step S2723, the failure analysis program 123 activates the display module 125, sets the THEN part 1712 of the subject expanded rule as a cause candidate of the failure, sets the respective condition elements of the IF part as an influence range corresponding to the cause candidate, further sets the event reception rate calculated in Step S2722 as a probability of the cause candidate, and displays them as an analysis result on the output device 117.

If a failure in the THEN part 1712 is already displayed as a cause candidate on the output device 117, a higher event reception rate may be displayed.

As described before, if a failure occurs on a management subject system, the processing carried out by the failure analysis program 123 can automatically derive a failure cause candidate and an influence range, and present them to the system operation administrator.

Expansion history may be generated so that whether the expanded rule to be generated has already been included in the expanded rule repository 136 can be found before the expanded rules are generated in Step S2715 in order to accelerate the processing by the failure analysis program 123.

Moreover, a publicly known technology (one disclosed in Japanese Patent Translation Publication No. 2011-518359) for accelerating the failure analysis processing may be applied. Moreover, an expanded rule may not be generated each time an event is received, and all expanded rules may be generated before a failure occurs.

Moreover, the processing carried out by the failure analysis program 123 illustrated in FIGS. 27A and 27B generates only the expanded rules including the occurred event. However, the rule expansion processing may be activated while using information on the events described in the THEN part of the expanded rules acquired in Step S2715 and a metarule associating with the event as inputs, all expanded rules including the events in the THEN part may be generated, the processing of Step S2720 and subsequent steps may be carried out for the expanded rules including these generated expanded rules, and an analysis result may be presented. As a result, all the failure events which may occur by the influence of a certain cause candidate can be displayed.

Metarules can be generated from the information on the cause event and the information on the influence events specified by the rule creator, and a failure occurred on a topology same in pattern can be analyzed based on the generated metarule by the processing carried out by the metarule generation program 121 and the failure analysis program 123 as described above.

For example, if the system operation administrator selects, in Step S1812 carried out by the metarule generation program 121, the entry 211 (the cache hit rate performance error in the write processing in the RAID group 0 in the storage A) of the event table 131 as a cause event, selects, in Step S1816, the entry 212 (the transfer time performance error in the D derive on the server A) as an influence event, and selects, in Step S2413 carried out by the topology acquisition method selection processing, a topology corresponding to “DRIVE1, VOL1, RG1,” the metarule generation program 121 generates the metarule 300 illustrated in FIG. 3 and the topology acquisition method 1600 illustrated in FIG. 16A. Then, for example, if the event represented by the entry 222 of the event table 131 occurs on the server B of the management subject system, the failure analysis program 123 generates the expanded rule 1700 illustrated in FIG. 17C from the metarule 300 and the topology acquisition method 1600 illustrated in FIG. 16A, and presents, as failure analysis results, such an analysis result that “the cache hit rate performance error in the write processing in the RAID group 1 in the storage A is the cause”, and such an analysis result that an influence range includes “the cache hit rate performance error in the write processing in the RAID group 1 in the storage A” and “the transfer time performance error in the D driver on the server B” to the operation administrator.

As described above, according to the first example of this invention, if the system operation administrator selects one cause event and one or a plurality of influence events, types of management objects on which the respective events have occurred are derived, and a metarule and a topology acquisition method of applying the metarule to other management objects are automatically generated. As a result, the system operation administrator can generate a metarule by specifying only the information on a system actually managed and actually generated events without knowing internal specifications of the failure analysis function.

### Second Example

In the first example described above, the rule creator inputs the necessary information based on the information on an actually occurred failure, thereby generating a metarule. According to a second example, information to be input by the rule creator to generate a metarule and an input screen are different in order to generate a rule even if a failure does not actually occur.

Moreover, in the first example, an actual topology between the cause management object and influence management objects is searched for, thereby generating a topology acquisition method. As a result, if a topology in the management subject system is complex, an amount of calculation for the topology search processing increases, and a period required for generating a metarule may increase. According to the second example, the topology information is acquired not by tracing actual association between management objects, but the topology information which the management object may take is acquired by tracing association which the management object registered to the association table may take as another method of the topology search processing in order to accelerate the topology search processing. As a result, a topology acquisition method is generated.

Specifically, inputs of not an event of a failure actually occurred, but of an management object type to be a cause, an event type to be a cause, types of management object to be influenced, and event types to be influenced are requested. Then, table names of the association table 133 are traced starting from an input influence management object type, thereby acquiring information on topologies which the influence management object types and the cause management object type may take.

In the second example, out of system configurations, configurations of respective apparatus, and processing carried out by the respective programs, a description of the same items as those of the first example is omitted. Exemplary hardware architecture and logical configurations of the management subjects for describing the second example may be those (FIG. 1) described before in the first example. Moreover, the event table 131 may have the configuration example shown in FIG. 2, the metarule of the metarule repository 135 may have the configuration example illustrated in FIG. 3, the tables in the configuration management DB 132 may have the configuration examples shown in FIGS. 4 to 13, the association table 133 may have the configuration example shown in FIGS. 15A and 15B, the topology acquisition method of the topology acquisition method repository 134 may have the configuration example illustrated in FIGS. 16A to 16D, and the expanded rule in the expanded rule repository 136 may have the configuration example illustrated in FIGS. 17A to 17C.

Moreover, in the second example, as in the first example, the topology acquisition method selection processing may be the same as the processing illustrated in FIG. 24, the metarule verification information display processing may be the same as the processing illustrated in FIGS. 25A and 25B, the rule expansion processing may be the same as the processing illustrated in FIG. 26, and the processing carried out by the failure analysis program 123 may be the same as the processing illustrated in FIGS. 27A and 27B.

### <Processing for Metarule Generation>

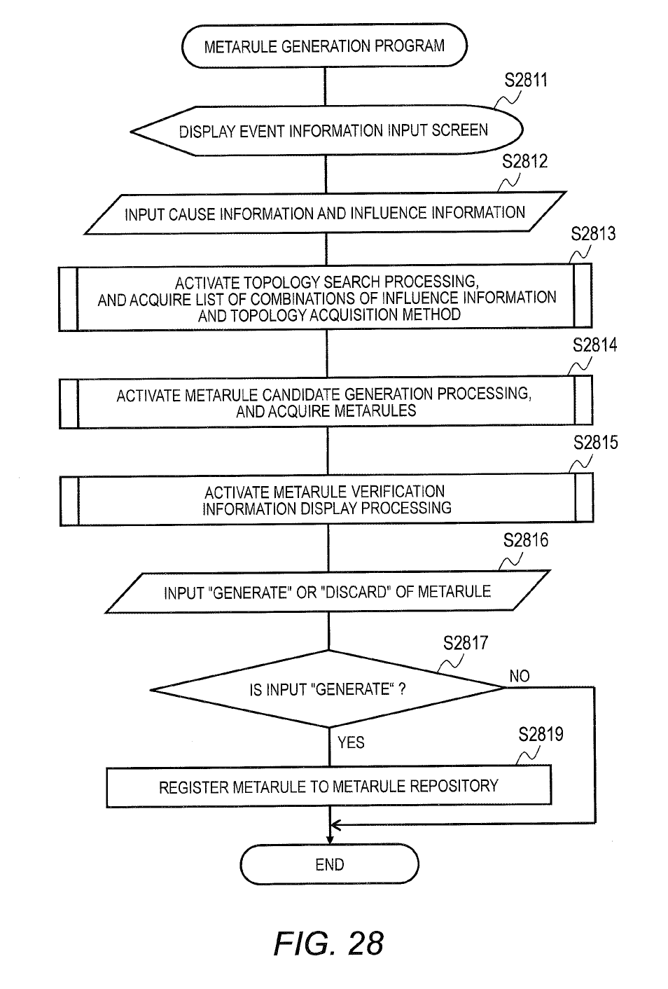

FIG. 28 is a flowchart of an example of the metarule generation processing carried out by the metarule generation program 121 on the management computer 101 according to the second example.

The metarule generation program 121 is preferred to be activated by an instruction from the input device 114 by the rule creator.

In the second example, unlike the first example, the metarule generation program 121 requests inputs of not an event of a failure actually occurred, but of a management object type to be a cause, a management event type to be a cause, types of management object to be influenced, and event types to be influenced in order to generate a rule even if a failure does not actually occur, and generates a metarule based on the input information.

In Step S2811, the metarule generation program 121 activates the display module 125, and displays an event information input screen on the output device 117.

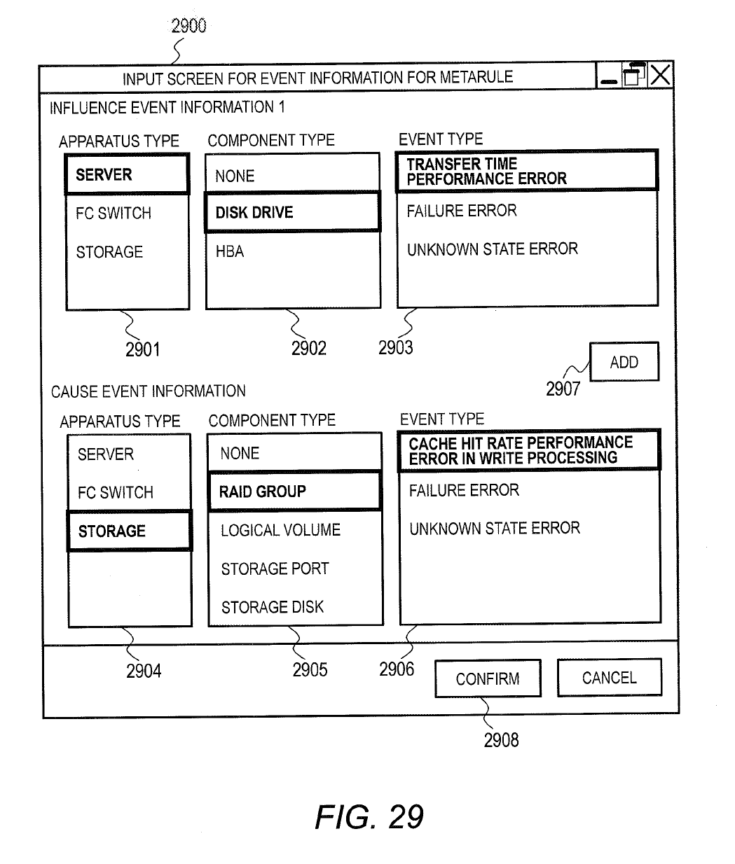

FIG. 29 is a diagram illustrating an example of an event information input screen 2900 according to the second example.

The event information input screen 2900 is preferred to permit selections of the apparatus type, the component type, and the event type of the influence event, and the apparatus type, the component type, and the event type of the cause event from respective list boxes 2901 to 2906, for example, as exemplified in FIG. 29. Moreover, if a plurality of pieces of influence event information of a metarule are set for cause event information, the event information input screen 2900 is preferred to have a function of adding the influence event information by operating an add button 2907.

Moreover, the event information input screen 2900 is preferred to have a function of displaying, if one apparatus type is selected in the list boxes 2901 and 2904 for the apparatus type, types of only components included in the selected apparatus type are displayed in the respective list boxes 2902 and 2905. Moreover, the event information input screen 2900 is preferred to have a function of displaying, if the apparatus type and the component type are selected from the list boxes 2901, 2902, 2904, and 2905, only even types which may occur on the selected apparatus type or the component type in the list boxes 2903 and 2906.

On the event information input screen 2900, when a management subject apparatus and components thereof actually managed are selected on a screen for displaying the configuration information, the metarule generation program 121 may automatically derive types of the apparatus and the components.

In Step S2812, the metarule generation program 121 receives cause event information and influence event information selected by the rule creator. Specifically, in case where the rule creator selects the influence event information and the cause event information respectively in the list boxes 2901 to 2906, and operates a confirmation button 2908 on the event information input screen 2900 in FIG. 29, the metarule generation program 121 receives the information on the selected events.

In Step S2813, the metarule generation program 121 activates the topology search processing while using the cause event information and the influence event information received in Step S2812 as inputs, thereby acquiring a list of combinations of influence event information and a topology information acquisition method.

In Step S2814, the metarule generation program 121 activates the metarule candidate generation processing while using the cause event information and the influence event information received in Step S2812 and the list of combinations of the influence event information and the topology acquisition method acquired in Step S2813 as inputs, thereby acquiring a metarule 300.

In Step S2815, the metarule generation program 121 activates the metarule verification information display processing while using the metarule 300 acquired in Step S2814 as an input. The metarule verification information display processing is processing of displaying the hint information for verifying whether the generated metarule can be used to carry out correct failure analysis, and the processing described in the first example can be used.

In Step S2816, the metarule generation program 121 receives a determination to “generate” or “discard” the metarule input by the rule creator.

In Step S2817, the metarule generation program 121 determines whether the input in Step S2816 is “generate”. If the condition is satisfied, the processing proceeds to Step S2819. On the other hand, if the condition is not satisfied, the processing is ended.

In Step S2819, the metarule generation program 121 registers the metarule 300 acquired in Step S2814 to the metarule repository 135.

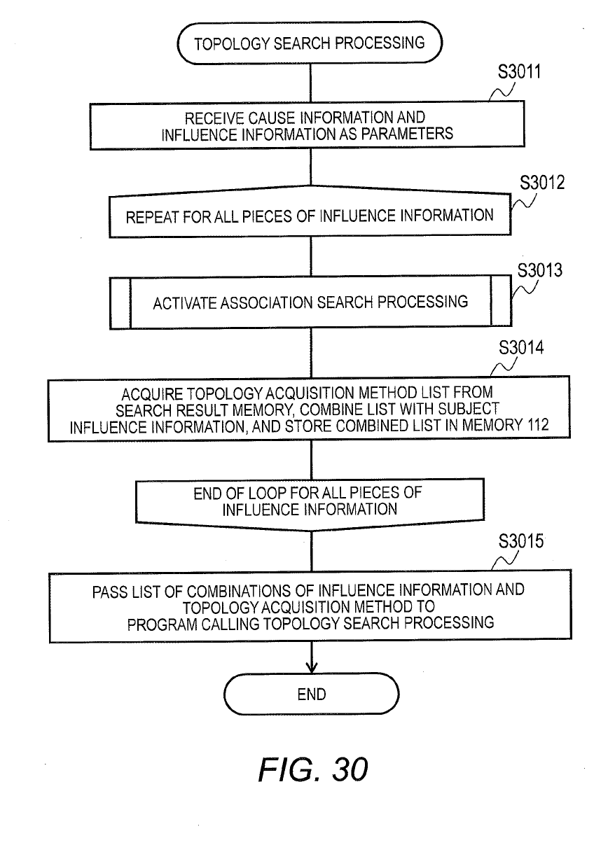

FIG. 30 is a flowchart of an example of the topology search processing carried out in Step S2813 of the metarule generation program 121 according to the second example.

The parameters received by the topology search processing according to the second example include the apparatus types and the component types, which are different from the apparatus IDs and the component IDs input in the first example. Therefore, the metarule generation program 121 derives topologies which apparatus and components included in the apparatus types and the component types input as the parameters may take based on the association table 133, thereby acquiring topology acquisition methods to be used by the metarule.

Specifically, the topology acquisition method is acquired by tracing entries in the association table 133 starting from a management object type in the influence event information to a management object type in the cause event information.

In Step S3011, the topology search processing receives cause event information and influence event information as parameters. The received parameters are the management object types and the event types of the cause event and the influence event received in Step S2812 of the metarule generation program 121.

In Step S3012, the topology search processing repeats processing from Step S3013 to S3014 for all pieces of the influence event information received in Step S3011.

In Step S3013, the topology search processing activates the association search processing while using the cause event information, a management object type (a component type or an apparatus type if a component type is not specified) in subject influence event information, and a list recording association IDs as inputs. It should be noted that the table name of the configuration management DB 132 is equivalent to the management object type name, and the input management object type represents the table name of the configuration management DB 132 according to this example. The association search processing is processing of tracing association starting from the input table name to the table name represented by the management object type in the cause event information based on the information in the association table 133, generating topology acquisition methods, and recording the topology acquisition methods as a search result memory in the memory 112.

In Step S3014, the topology search processing acquires a list of topology acquisition methods from the search result memory recorded by the association search processing in the memory 112, combines the acquired list of topology acquisition methods with the subject influence information, and records the combined list in the memory 112.

In Step S3015, the topology search processing passes the list of combinations of the influence information and the topology acquisition method recorded in Step S3014 to a program calling the topology search processing.

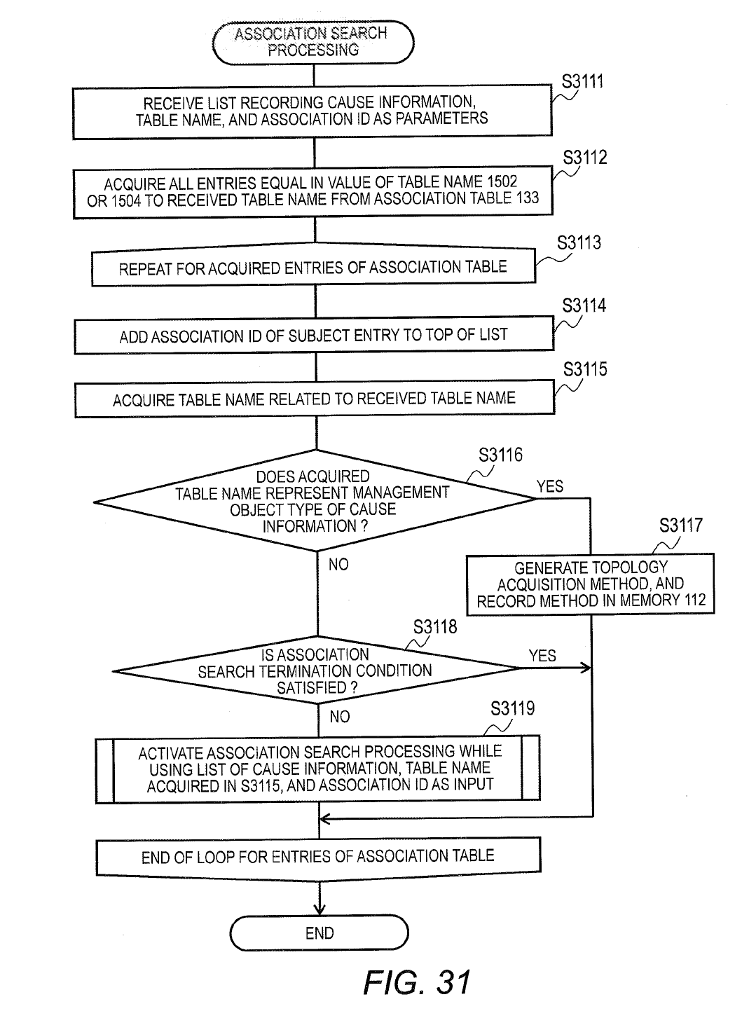

FIG. 31 is a flowchart of an example of the association search processing carried out in Step S3013 of the topology search processing.

The association search processing according to the second example is processing of tracing table names registered to entries in the association table 133, deriving topologies which the management object types (table names) of received influence event information and a management object type (a table name) of received cause event information may take, and generating topology acquisition methods.

In Step S3111, the association search subprogram receives the cause event information, the table name, and the list of association IDs as parameters.

In Step S3112, the association search subprogram acquires all entries equal to the table name received in Step S3111 in the value of the table name X 1502 or the table name Y 1504 from the association table 133.

In Step S3113, the association search subprogram repeats processing from Step S3114 to S3119 for the entries in the association table 133 acquired in Step S3112.

In Step S3114, the association search subprogram adds the association ID of a subject entry of the association table at the top of the list recoding association IDs.

In Step S3115, the association search subprogram acquires a table name associating with the received table name based on the subject entry of the association table.

In Step S3116, the association search subprogram determines whether the table name acquired in Step S3115 represents the management object type of the received cause event information. If the condition is satisfied, the processing proceeds to Step S3117. On the other hand, if the condition is not satisfied, the processing proceeds to Step S3118.

In Step S3117, the association search subprogram generates a topology acquisition method from the list recording the association IDs, and records the topology acquisition method in the memory 112 as a search result memory.

In Step S3118, the association search subprogram determines whether an association search termination condition is satisfied. If the condition is satisfied, the association search subprogram carries out the repeated processing from the Step S3113 for a next entry of the association table. On the other hand, if the condition is not satisfied, the processing proceeds to Step S3119. The association search termination condition is, for example, such a condition that the same association ID is recorded a predetermined number of times or more in the list of association IDs. Moreover, a part of the topology may not be searched for in order to reduce a processing period of the topology search processing, in other words, a subsequent search may be terminated if the number of elements in the list of association IDs becomes equal to or more than a certain number.

In Step S3119, the association search subprogram recursively activates the association search processing while using the received cause information, the table name acquired in Step S3115, and the list of association IDs as inputs.

For example, the topology search processing inputs the apparatus type “storage”, the component type “RAID group”, the event type “the cache hit rate performance error in the write processing” as the cause information, further inputs “disk drive” as the table name in the influence event information in the association search processing, and the association search processing receives them (Step S3111).

In this case, the association search processing acquires the entries 1511, 1512, and 1513 (refer to FIG. 15A) of the association table 133 (Step S3112). If the entry 1513 is selected in the repeated processing in Step S3113, “AS3” is added to the list of association IDs (Step S3114), and the table name “logical volume” is acquired (Step S3115). The acquired table name “logical volume” and the component type “RAID group” of the cause event information do not match each other (Step S3116), the association search processing is thus recursively activated while using the cause event information, the table name “logical volume”, and the list of association IDs as inputs (Step S3119).

The entry 1522 is selected in the repeated processing in Step S3113, and the table name “RAID group” is acquired in the recursively activated association search processing (Step S3115). Therefore, the processing in Step S3116 proceeds to Step S3117. A topology acquisition method is generated from the list of association IDs including “AS3, AS12” as elements, and is recorded as the search result memory in the memory 112.

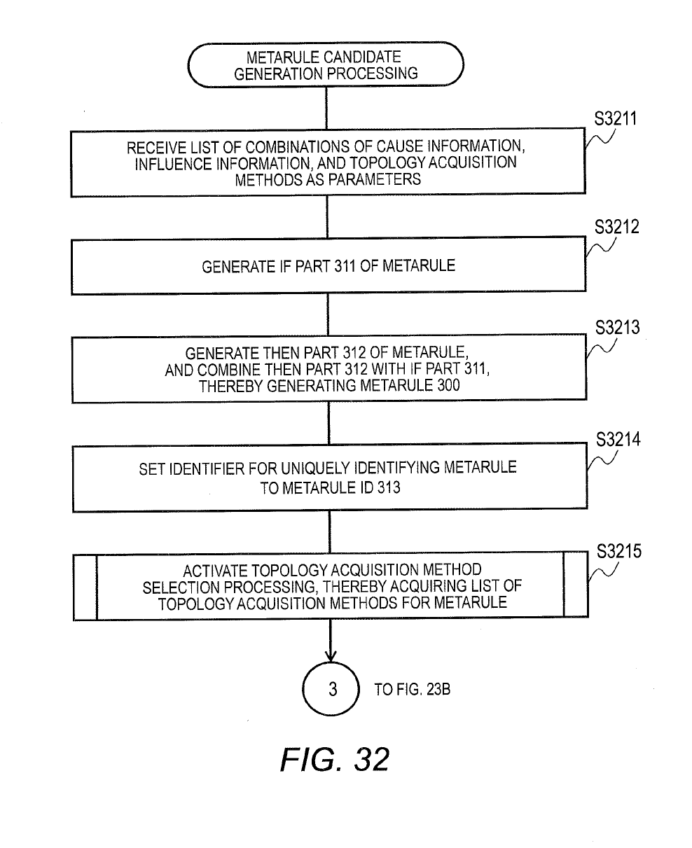

FIG. 32 is a flowchart of an example of the metarule candidate generation processing carried out in Step S2814 of the metarule generation program 121 according to the second example.

In Step S3211, the metarule candidate generation subprogram receives cause event information, influence event information, and a list of combinations of influence event information and topology acquisition method as parameters.

In Step S3212, the metarule candidate generation subprogram combines the apparatus type in the influence event information, the component type in the influence event information, the event type in the influence event information, the apparatus type in the cause event information, the component type in the cause event information, and the event type in the cause event information with one another, thereby generating the IF part 311 of a metarule.

In Step S3213, the metarule candidate generation subprogram combines the apparatus type, the component type, and the event type in the cause event information with one another, thereby generating the THEN part 312 of the metarule, and combines the THEN part 312 with the IF part 311 generated in Step S3212, thereby generating the metarule 300.

In Step S3214, the metarule candidate generation subprogram sets an identifier for uniquely identifying the metarule 300 to the metarule ID 313.

In Step S3215, the metarule candidate generation subprogram activates the topology acquisition method selection processing while using the received list of the combinations of influence information and topology acquisition method as an input, and acquires a list of topology acquisition methods for acquiring topologies to which the metarule is applied.

Processing subsequent to Step S3215 is the same as Step S2318 and subsequent steps of the metarule candidate generation processing (FIG. 23B) of the first example described above.

While the parameters received when the topology acquisition method selection processing is activated are a list of combinations of an event, topology information, and a topology acquisition method in the first example, the parameter received when the topology acquisition method selection processing is activated is a list of combinations of influence event information and a topology acquisition method in the second example. Thus, in the second example, it is preferred that the input pieces of influence event information and patterns of topology which can be acquired be displayed on the output device 117, and the rule creator be permitted to select one pattern of topology corresponding to each of the pieces of the influence event information.

A description has been given of the processing by the metarule generation program 121 for the metarule according to this example.

As described above, a metarule can be generated even if a failure does not actually occur according to the second example of this invention. Moreover, only entries are traced in the association table 133, thereby generating topology acquisition methods without searching for an actual topology of a cause management object and an actual topology of an influence management object based on the information in the configuration management DB 132, resulting in a decrease in calculation amount of the topology search processing. As a result, the processing of metarule generation and the processing of information provision to the rule creator can be accelerated.

### Third Example

In the first and second examples described above, the rule creator is permitted to select an appropriate topology for a generated metarule, and a topology acquisition method associated with the metarule is determined based on the selected topology in the topology acquisition method selection processing.

However, if many topologies are presented as candidates for one metarule, the rule creator has difficulty in selecting an appropriate topology, and the cost for the operation increases.

Therefore, in a third example, if a plurality of topology acquisition methods exist for one metarule, priorities of the topology acquisition methods to be used by the metarule are determined. As a result, the rule creator can more easily select the topology acquisition method to be used for the metarule, resulting in a reduction in the cost of the selection operation.

In the third example, out of system configurations, configurations of respective apparatus, and processing carried out by the respective programs, a description of the same items as those of the first or second example is omitted. Exemplary hardware architecture and logical configurations of the management subjects for describing the third example may be those (FIG. 1) described before in the first example. Moreover, the event table 131 may have the configuration example shown in FIG. 2, the metarule of the metarule repository 135 may have the configuration example illustrated in FIG. 3, the tables in the configuration management DB 132 may have the configuration examples shown in FIGS. 4 to 13, the topology acquisition method of the topology acquisition method repository 134 may have the configuration example illustrated in FIGS. 16A to 16D, and the expanded rule in the expanded rule repository 136 may have the configuration example illustrated in FIGS. 17A to 17C.

Moreover, in the third example, as in the first example, the processing carried out by the metarule generation program 121 may be the same as the processing illustrated in FIGS. 18A and 18B, and the processing carried out by the failure analysis program 123 may be the same as the processing illustrated in FIGS. 27A and 27B. It should be noted that the processing carried out by the metarule generation program 121 may also be the same as the processing illustrated in FIG. 28 according to the second example.

In the third example, the topology acquisition method selection processing or the association table 133 is changed in order to determine a priority of a topology acquisition method to be used by a metarule. A description is given of five methods for determining the priority according to this example. Thus, in the third example, a description is given of examples of a plurality of pieces of the topology acquisition method selection processing and association tables.

### <Processing of Topology Acquisition Method Selection and Processing of Topology Acquisition Method Priority Determination>

In the third example, if a plurality of topology acquisition methods exist as candidates, the priorities of the topology acquisition methods are determined as a method of acquiring a topology from a cause management object to an influence management object where the objects constitute a combination for one metarule.

The topology acquisition method is used to restrict application destinations of the metarule. Even if a certain apparatus fails, irrelevant apparatus are not influenced. Further, some failures propagate only through management objects on a restricted specific topology (such as a topology in which a disk drive of a server mounts a logical volume of a storage). The topology acquisition method is used to restrict the application of a metarule only to a combination of management objects on the specific topology on which the failure may propagate. If the restriction is not used, an unnecessary or wrong expanded rule is generated. The range of the application of the metarule can be restricted by the topology acquisition method, thereby preventing an unnecessary cause candidate or a wrong cause candidate from being presented to the operation administrator, and further preventing an unnecessary expanded rule from being generated, resulting in a reduction of a processing load on the management computer 101.

In this example, the topology acquisition methods are ranked in the order of appropriateness in range of application of the metarule, and the ranking is presented as the priorities to the rule creator.

A description is given below of the five determination methods for the priority.

In this example, a description is given of examples of the five methods of determining the priority, but the method is not limited to the exemplified five methods as long as the method evaluates the topology acquisition method by using a criterion defined in advance based on characteristics of the failure analysis, and determines the priority.

### <Method 1: Priority Determination Method Using Multiplicity of Association as Evaluation Criterion>

A first method of determining the priority of the topology acquisition method is a method of using a multiplicity of association between management objects as the evaluation criterion. Specifically, a topology acquisition method acquiring a combination between an influence management object and a cause management object in a one-to-one relationship is prioritized over a topology acquisition method acquiring the combination in a one-to-many relationship, and the topology acquisition method acquiring the combination in the one-to-many relationship is prioritized over a topology acquisition method acquiring the combination in a many-to-many relationship.

This is because, if the combination of the influence management object and the cause management object which can be acquired by the topology acquisition method has the one-to-one relationship, the relationship between the two management objects is more restricted than that in the one-to-many or may-to-many relationship, and highly possibly represents a topology over which a failure propagates.

Thus, the multiplicities of association are registered to each entry of the association table 133 in the method 1 of this example. The multiplicity represents a multiplicity of association between management object types, and is different in meaning from the actual number of associations held between the management objects. Then, as the method of acquiring a topology from an influence management object to a cause management object where the objects constitute a combination, if a plurality of topology acquisition methods exist as candidates, it is determined which of many-to-many, one-to-many, many-to-one, and one-to-one is included in the association between the management object types acquired by the topology acquisition method, thereby determining the priority of the topology acquisition method.

In this example, the priority is determined based on the sequence of one-to-one, one-to-many, and may-to-many, but the multiplicity may be evaluated by using other criteria, thereby determining the priority of the topology acquisition method.

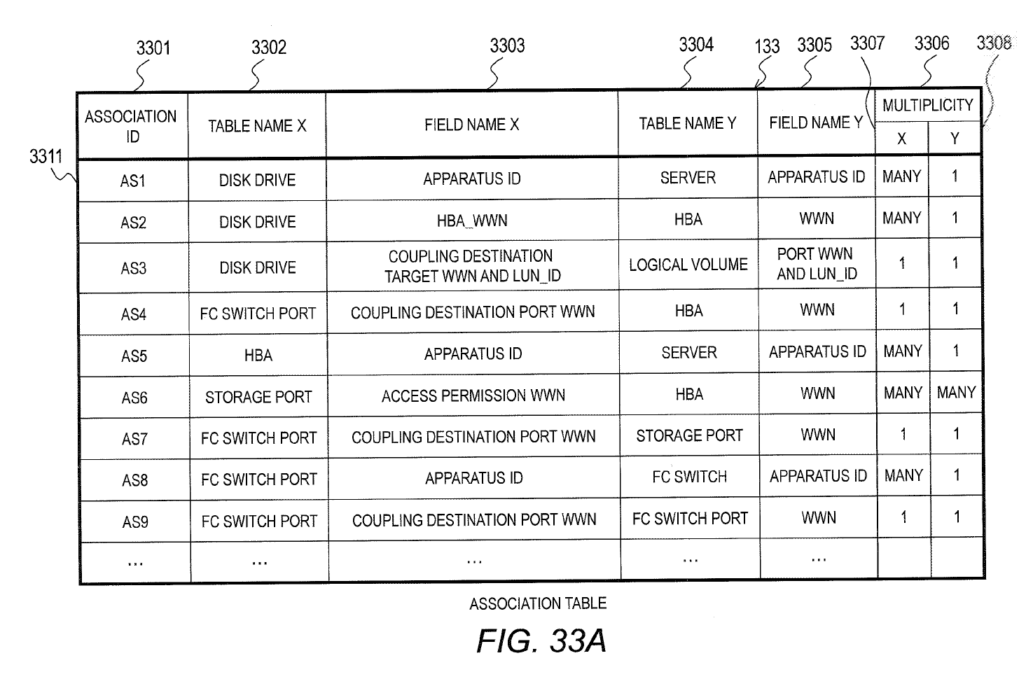

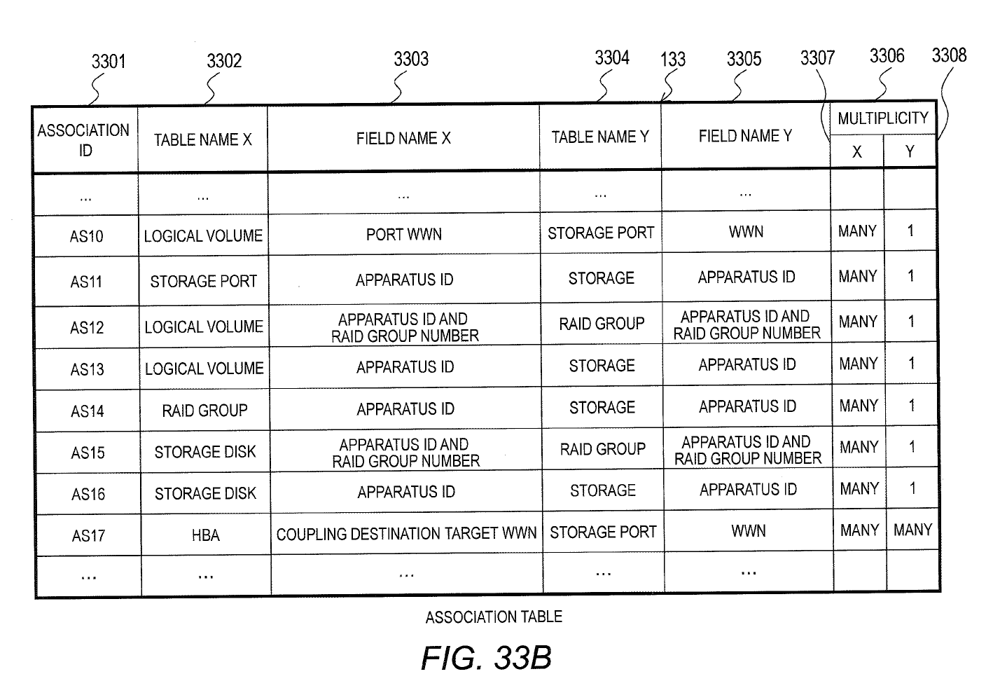

FIGS. 33A and 33B are explanatory diagrams illustrating examples of a data structure of the association table 133 according to the third example. The association table 133 according to this example has such a structure that entries shown in FIG. 33A are followed by entries shown in FIG. 33B.

The association table 133 of the method 1 has six fields. An association ID 3301, a table name X 3302, a field name X 3303, a table name Y 3304, and a field name Y 3305 are respectively the same as the association ID 1501, the table name X 1502, the field name X 1503, the table name Y 1504, and the field name Y 1505 of the association table (FIGS. 15A and 15B) of the first example.

A multiplicity 3306 is the multiplicity of the association between the tables of the configuration management DB 132 represented by each of the entries of the association table 133. In other words, the multiplicity 3306 is information corresponding to the multiplicity 1405 of the class diagram illustrated in FIG. 14. Any one of “many” and “1” is registered to fields 3307 and 3308 constituting the multiplicity 3306. A multiplicity of a table represented by the table name X 3302 starting from a table represented by the table name Y 3304 is registered to the field 3307, and a multiplicity of a table represented by the table name Y 3304 starting from a table represented by the table name X 3302 is registered to the field 3308.

For example, an entry 3311 represents association between a disk drive and a server, the field 3307 stores “many”, while the field 3308 stores “1”. In this case, the number of entries of the server table associating with an entry of the disk drive table is always one or less, and the number of entries of the disk drive table associating with an entry of the server table can be two or more. In other words, the associating server starting from the disk drive has the many-to-one relationship, and the associating disk drive starting from the server has the one-to-many relationship.

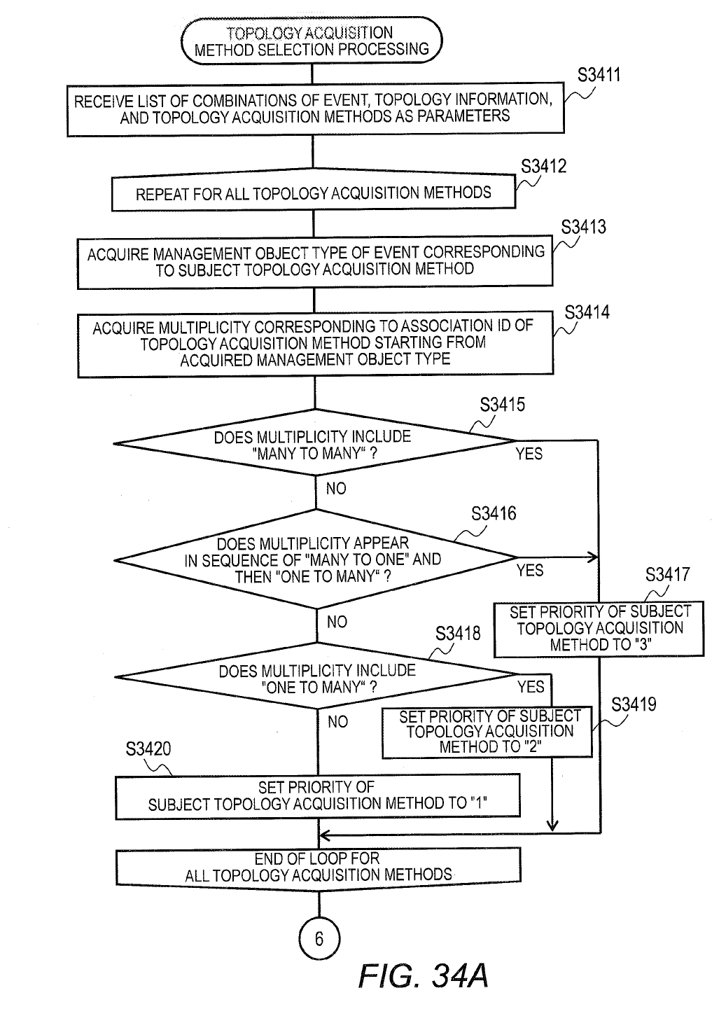

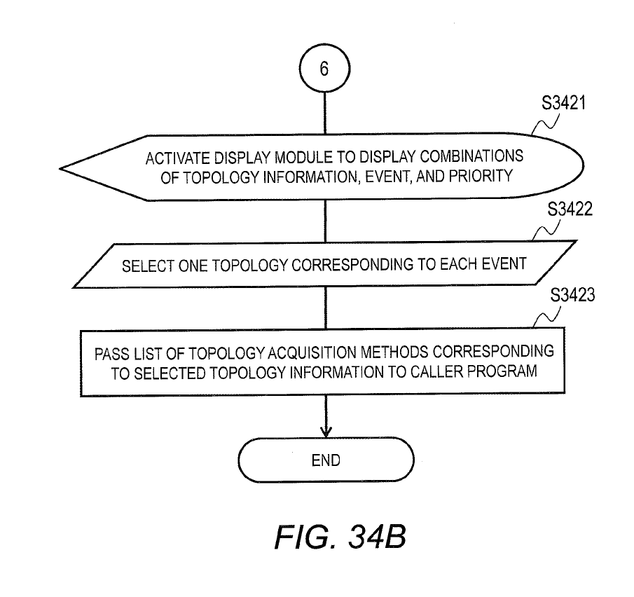

FIGS. 34A and 34B are flowcharts of an example of the topology acquisition method selection processing according to the method 1 of the third example.

In this example, a description is given of the case where the topology acquisition method selection processing is carried out by means of the method according to the first example, and the received parameters are “a list of combinations of an event, topology information, and a topology acquisition method”, but if the topology acquisition method selection processing is carried out by means of the method according to the second example, the received parameters may be “a list of combinations of influence event information and a topology acquisition method”. Moreover, in this example, the priority is represented by a number, and the priority increases as the number decreases, but the priority may increase as the number increases. Moreover, the priority may not be represented by a number, and may be a description representing an order.

In Step S3411, the topology acquisition method selection subprogram receives a list of combinations of an event, topology information, and a topology acquisition method as parameters.

In Step S3412, the topology acquisition method selection subprogram repeats the processing from Steps S3413 to S3420 for all the received topology acquisition methods.

In Step S3413, the topology acquisition method selection subprogram acquires an event corresponding to a subject topology acquisition method from the received list of combinations of an event, topology information, and a topology acquisition method, and acquires the management object type of the event.

In Step S3414, the topology acquisition method selection subprogram acquires entries of the association table 133 corresponding to the association ID registered to the subject topology acquisition method, and traces table names stored in the table name X 3302 and the table name Y 3304 of each of the acquired entries starting from a table name corresponding to the management object type acquired in Step S3413. Further, the topology acquisition method selection subprogram acquires the multiplicity 3306 corresponding to the table name.

For example, in Step S3413, the topology acquisition method selection subprogram acquires the management object type “disk drive”, and if the subject topology acquisition method is the topology acquisition method 1600 illustrated in FIG. 16A, acquires the table name X 3302 “disk driver” of the entry of the association table having “AS3” in the association ID. Moreover, the topology acquisition method selection subprogram acquires the multiplicity “one to one” of “logical volume” with respect to “disk drive” from the multiplicity 3306. Further, the table name Y 3304 of the subject entry of the association table is “logical volume”, and the topology acquisition method selection subprogram thus acquires the entry included in the topology acquisition method 1600, having the association ID “AS12”, and storing “logical volume” in the table name X 3302 from the association table. On this occasion, the topology acquisition method selection subprogram acquires the multiplicity “many to one” with respect to the logical volume from the multiplicity 3306. Thus, the multiplicities are acquired in a sequence of “one to one” and “many to one”.

In Step S3415, the topology acquisition method selection subprogram determines whether the multiplicities acquired in Step S3414 include “many to many”. If the condition is satisfied, the processing proceeds to Step S3417. On the other hand, if the condition is not satisfied, the processing proceeds to Step S3416.

In Step S3416, the topology acquisition method selection subprogram determines whether the multiplicities acquired in Step S3414 appear in a sequence of “many to one” and “one to many”. If the condition is satisfied, the processing proceeds to Step S3417. On the other hand, if the condition is not satisfied, the processing proceeds to Step S3418. Moreover, “one to one” or “many to one” may exist between “many to one” and “one to many”.

In Step S3417, the topology acquisition method selection subprogram sets the priority of the subject topology acquisition method to “3”.

In Step S3418, the topology acquisition method selection subprogram determines whether the multiplicities acquired in Step S3414 include “one to many”. If the condition is satisfied, the processing proceeds to Step S3419. On the other hand, if the condition is not satisfied, the processing proceeds to Step S3420.

In Step S3419, the topology acquisition method selection subprogram sets the priority of the subject topology acquisition method to “2”.

In Step S3420, the topology acquisition method selection subprogram sets the priority of the subject topology acquisition method to “1”.

In Step S3421, the topology acquisition method selection subprogram activates the display module 125, and displays combinations of the topology information, the event, and the priority corresponding to each of the topology acquisition methods on the output device 117.

In Step S3422, the topology acquisition method selection subprogram receives topology information on one topology selected in correspondence to each of the events by the rule creator out of the displayed information in Step S3421.

In Step S3423, the topology acquisition method selection subprogram passes a list of topology acquisition methods corresponding to the topology information received in Step S3422 to a program calling the topology acquisition method selection processing.

The above-described method 1 is not limited in the application target unlike the case of other methods, and is easy to use in any cases.

### <Method 2: Priority Determination Method Using Set of Applied Topologies as Evaluation Criterion>

A second method of determining the priority of the topology acquisition method is a method of using a set of applied topologies as the evaluation criterion. Specifically, as the method of acquiring a topology from an influence management object to a cause management object where the objects constitute a combination, if a plurality of topology acquisition methods exist as candidates, all pieces of topology information which can be acquired by each of the topology acquisition methods are acquired, and are made into a set for each of the topology acquisition methods. Then, combinations of a cause management object and an influence management object which can be extracted from each of the pieces of topology information are considered as elements for the comparison, an inclusion relation of each of the sets is acquired, and the priority increases as the method acquires a lower set.

In other words, if a set of pieces of topology information which can be acquired by a certain topology acquisition method is included in a set of pieces of topology information which can be acquired by another topology acquisition method, the combinations of a cause management object and an influence management object acquired by the first topology acquisition method are more restricted in the range. Thus, the application range of the metarule is restricted, and the topology information acquired by the first method is highly possibly a topology over which a failure propagates. Thus, a possibility of generation of unnecessary expanded rules decreases.

Thus, in this example, as the method of acquiring a topology from an influence management object to a cause management object where these objects constitute a combination, if a plurality of topology acquisition methods exist as candidates, all pieces of information on topologies which can be acquired by each of the topology acquisition methods is acquired, inclusion relations among these sets are calculated, and the priority increases as the method acquires the lower set.

In this example, the priority increases as a topology acquisition method acquires a lower set of pieces of topology information, but the topology information that can be acquired by each of the topology acquisition methods may be evaluated based on another criterion, thereby determining the priority of the topology acquisition method.

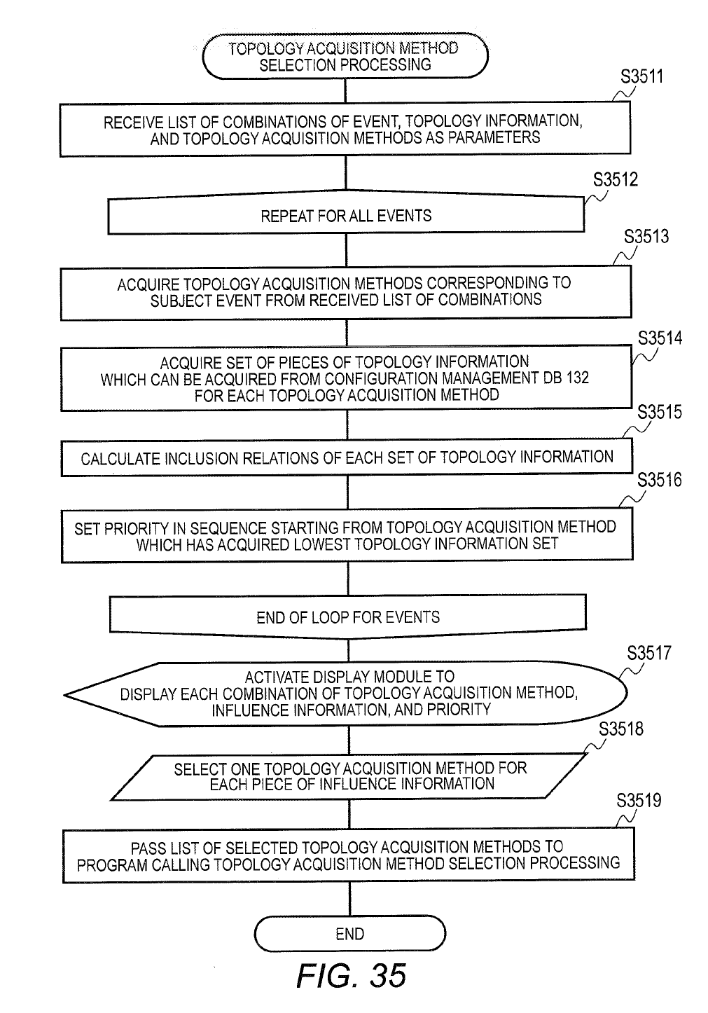

FIG. 35 is a flowchart of an example of the topology acquisition method selection processing according to the method 2 of the third example.

In Step S3511, the topology acquisition method selection subprogram receives a list of combinations of an event, topology information, and a topology acquisition method as parameters.

In Step S3512, the topology acquisition method selection subprogram repeats the processing from Steps S3513 to S3516 for all the received events.

In Step S3513, the topology acquisition method selection subprogram acquires a topology acquisition method corresponding to a subject event from the received list of the combinations.

In Step S3514, the topology acquisition method selection subprogram acquires all pieces of topology information that can be acquired from the configuration management DB 132 for each of the topology acquisition methods, constitutes sets of pieces of topology information for the respective topology acquisition methods, and stores the sets in the memory 112.

In Step S3515, the topology acquisition method selection subprogram calculates the inclusion relation of each of the sets of the topology information acquired in Step S3514. On this occasion, the element used to calculate the inclusion relation is the combinations of a cause management object and an influence management object which can be extracted from each piece of topology information.

In Step S3516, the topology acquisition method selection subprogram sets the priority of the topology acquisition method which has acquired the lowest topology information set to “1”, and sets the priorities in sequence to methods which have acquired lower topology information sets.

In Step S3517, the topology acquisition method selection subprogram activates the display module 125, and displays combinations of the topology information, the event, and the priority corresponding to each of the topology acquisition methods on the output device 117.

In Step S3518, the topology acquisition method selection subprogram receives topology information on one topology selected for each of the events by the rule creator out of the displayed information in Step S3517.

In Step S3519, the topology acquisition method selection subprogram passes a list of the topology acquisition methods corresponding to the topology information received in Step S3518 to a program calling the topology acquisition method selection processing.

In this example, all the pieces of topology information which each of the topology acquisition methods can acquire are acquired from the configuration management DB 132, but some management objects to be start points may be limited and the topology information may be acquired in this state, thereby restricting the range of the topology information to be acquired in order to accelerate the processing. As a result, a part of the topology information is verified, resulting in the acceleration of the processing.

### <Method 3: Priority Determination Method Using Layer as Evaluation Criterion>

A third method of determining the priority of the topology acquisition method is a method of using a layer as the evaluation criterion. Specifically, on which layer the coupling relationship represented by the entry of the association table 133 exists is defined in advance, and the priority decreases as the topology acquisition method acquires topology information including association on a lower layer.

For example, regarding a topology representing a network coupling relationship, a failure on one server propagates another server more possibly on a topology representing such a coupling relationship on an upper layer that “applications on two servers are communicating to/from each other over a TCP connection” than a topology representing such a coupling relationship on a lower layer that “two servers are physically coupled to each other via a switch”.

Thus, the third method of this example registers information on the layer of the association represented by each of the entries of the association table, thereby defining the upper/lower relationship of the layer. Then, as the method of acquiring a topology from an influence management object to a cause management object where these objects constitute a combination, if a plurality of topology acquisition methods exist as candidates, and associations of the topology acquired by the topology acquisition method include association on a lower layer, the priority of the topology acquisition method decreases.

In this example, the priority decreases as the topology acquisition method acquires topology information including association on a lower layer, but the association may be evaluated by another criterion, thereby determining the priority of the topology acquisition method.

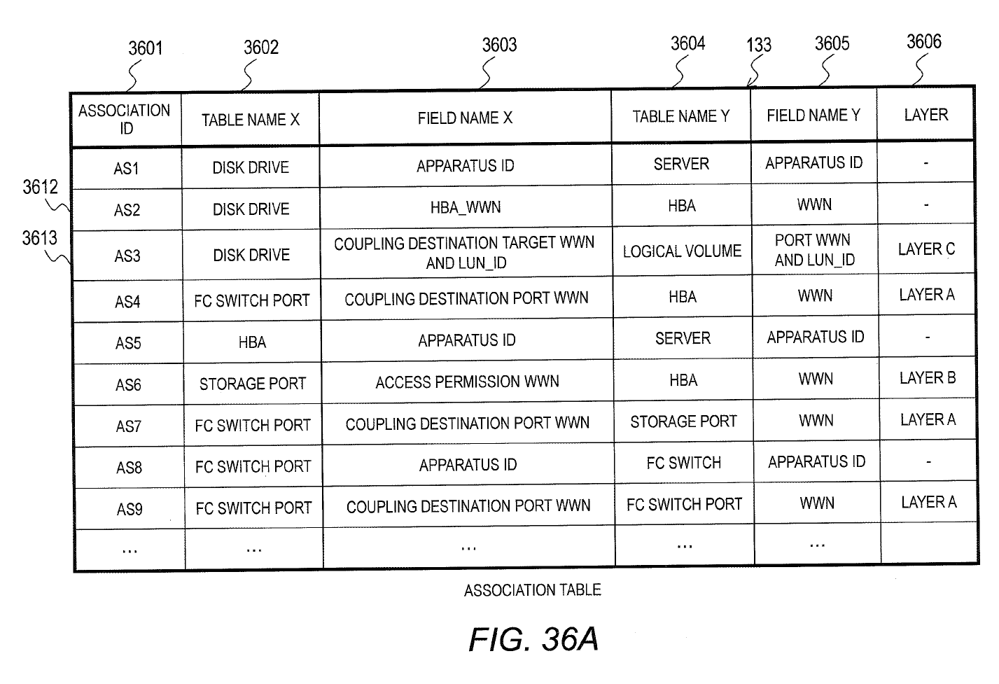

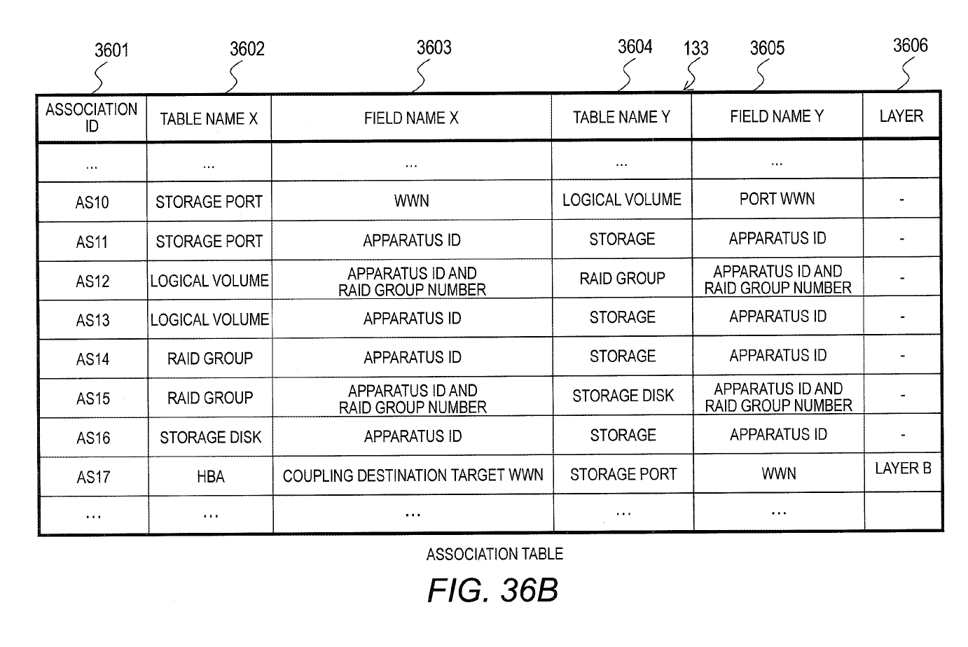

FIGS. 36A and 36B are explanatory diagrams illustrating examples of a data structure of the association table 133 according to the third method of the third example. The association table 133 according to this example has such a structure that entries shown in FIG. 36A are followed by entries shown in FIG. 36B.

The association table 133 of the method 3 has six fields. An association ID 3601, a table name X 3602, a field name X 3603, a table name Y 3604, and a field name Y 3605 are respectively the same as the association ID 1501, the table name X 1502, the field name X 1503, the table name Y 1504, and the field name Y 1505 of the association table (FIGS. 15A and 15B) of the first example.

A layer 3606 is information on a layer including the association between the tables of the configuration management DB 132 represented by each of the entries of the association table 133. In other words, the layer 3606 is information representing the type of a coupling relationship on a layer represented by each of the entries of the association table 133. It should be noted that association may be set without a particular layer.

In this example, layers of a network on which a storage provides a server with logical volumes are classified into three layers, “layer A”, “layer B”, and “layer C”, as an example. The “layer A” is defined for association representing a physical coupling relationship, the “layer B” is defined for association representing a communication relationship by means of the SCSI protocol, and the “layer C” is defined for association representing a relationship of mounting a logical volume.

For example, an entry 3613 represents that the association between the disk drive of the server and the logical volume of the storage is a coupling relationship on the “layer C”. Association closed in one apparatus does not represent a network coupling relationship as in an entry 3612, and hence a value does not need to be stored in the layer 3606.

In this example, the priority of each layer is set higher in the order of “layer C”, “layer B”, and “layer A”.

The layer defined for each association represented by the entry of the association table may be a layer classified by means of the OSI reference model publicly known in the art.

The topology acquisition method selection processing acquires entries of the association table 133 corresponding to all association IDs 1501 stored in the method ID 1602 of each of the received topology acquisition methods, sets the priority of a topology acquisition method in which the acquired entry stores “layer A” in the layer 3606 to “3”, sets the priority of a topology acquisition method in which the acquired entry stores “layer B” in the layer 3606 to “2”, and sets the priority to “1” otherwise. The topology acquisition method selection processing can display the topology information, the event, and the priority corresponding to each of the topology acquisition methods to the rule creator similarly to the topology acquisition method selection processing illustrated in FIGS. 34A and 34B.

In this example, the layer is set for the association, but a layer may be set for the management object type, and the priority may be set based on the type of the management object which can be acquired by each of the topology acquisition methods.

The method 3 described above is preferred for a case where the information on the layer is set for the association of the management object.

### <Method 4: Priority Determination Method Using an Existing Topology Acquisition Method as Evaluation Criterion>

A fourth method of determining the priority of the topology acquisition method is a method of using an existing topology acquisition method as the evaluation criterion. Specifically, as the method of acquiring a topology from an influence management object to a cause management object where these objects constitute a combination, if a plurality of topology acquisition methods exist as candidates, a topology acquisition method which completely or partially coincides with a method already stored in the topology acquisition method repository 134 is prioritized.

A topology acquisition method which is already used is defined as means for acquiring a topology on which a failure propagates in another metarule, and the topology is highly possibly a topology on which a failure cause represented by a newly generated metarule propagates.

In this example, the priority of a method coincident with an existing topology acquisition method is higher, but the relationship with the existing topology acquisition method may be evaluated based on another criterion, thereby determining the priority of the topology acquisition method.

The situation where two topology acquisition methods entirely or partially coincide with each other may be a situation where the association IDs stored in the method 1602 of the topology acquisition method 1600 are entirely or partially equal to each other. Moreover, if two topology acquisition methods are partially equal to each other, the priority may be determined based on a ratio of the number of equal association IDs or the like.

The above-described method 4 is efficient as a method simpler than other methods.

<Method 5: Priority Determination Method Using Relationship with Past Events as Evaluation Criterion>

A fifth method of determining the priority of the topology acquisition method is a method of using a relationship with past events as the evaluation criterion. Specifically, if each of topology acquisition methods is associated with a metarule to be generated, a simulation of analyzing past events by using the metarule is carried out based on the event table 131 and the configuration management DB 132, and in case where an expanded rule is generated from the metarule and each of the topology acquisition methods, a method which can generate an expanded rule without excess or deficiency for past events is prioritized.

For example, the priority can be determined by the following processing.

An event group of events which occurred in a predetermined period and are specified by condition elements described in the IF part of the metarule are acquired from the event table. Topology information is acquired by a topology acquisition method starting from each of management objects on which the event group has occurred, and an expanded rule group is generated from the metarule.

If events which do not correspond to events represented by the condition elements in the IF part of all the generated expanded rules exist in the event group, it is determined that the expanded rules are deficit. Moreover, if condition elements of the expanded rules which are not included in the event group exist, it is determined that the expanded rules are excessive. The above-described processing is carried out for each of the topology acquisition methods, and a higher priority is set starting from a topology acquisition method which is smaller in excess or deficiency in expanded rules.

As the method of acquiring topology information from an influence management object to a cause management object where these objects constitute a combination, if a plurality of topology acquisition methods exist as candidates, the above-described five methods can present the determined priority of each of the topology acquisition methods as the information for determining whether the topology acquisition method is to be associated with the metarule to the rule creator.

For example, if “StA RG1 WriteHitPerfError” is received as a cause event in the processing in Step S1812 of the metarule generation program 121 according to the first example, and “SvA DRIVE1 AverageSecPerXferError” is received as an influence event in Step S1816, the following topology acquisition methods can be acquired as topology acquisition methods of acquiring the same topology as the components “RG1” and “DRIVE1” in Step S1817.

(a) Topology acquisition method having “AS3, AS12” in method 1602
(b) Topology acquisition method having “AS2, AS17, AS10, AS12” in method 1602
(c) Topology acquisition method having “AS2, AS6, AS10, AS12” in method 1602
(d) Topology acquisition method having “AS2, AS4, AS8, AS8, AS7, AS10, AS12” in method 1602

It should be noted that the association search conditions used in Step S2219 of the association search processing illustrated in FIG. 22B are as follows.

(x) If the same management object is traced
(y) If, after a storage or a server is traced, another component in the same apparatus is traced
(z) If, after a component in a storage or a server is traced and then a component of another storage or server is traced, a component of still another apparatus is traced

If the priories are set to the acquired four topology acquisition methods by the first method in the topology acquisition method selection processing, acquired multiplicity information is in a sequence of “one to one” and “many to one”, and the priority of the method of (a) is thus set to “1” in the processing in Step S3414. Similarly, in the method of (b), acquired multiplicity information is in a sequence of “many to one”, “many to many”, “one to many”, and “many to one”, and “many to many” is included. Thus, the priority of the method of (b) is set to “3”. Also in the method of (c), acquired multiplicity information is in a sequence of “many to one”, “many to many”, “one to many”, and “many to one”, and “many to many” is included. Thus, the priority of the method of (c) is set to “3”. In the method of (d), acquired multiplicity information is in a sequence of “many to one”, “one to one”, “many to one”, “one to many”, “one to one”, “one to many”, and “many to one”, and a sequence of “many to one” and “one to many” is included. Thus, the priority of the method of (d) is set to “3”.

If expanded rules are generated from the metarule 300 illustrated in FIG. 3 based on topologies which can be acquired by the topology acquisition method (a) from the configuration management DB 132 shown in FIGS. 4 to 13, three expanded rules illustrated in FIGS. 17A to 17C are generated. The method (a) acquires a topology “a disk drive mounting a logical volume acquired by dividing a RAID group”, and can extract only RAID groups and disk drives in a relationship causing “the transfer time performance error in the disk drive” due to “the cache hit rate performance error in the write processing in the RAID group” to generate expanded rules.

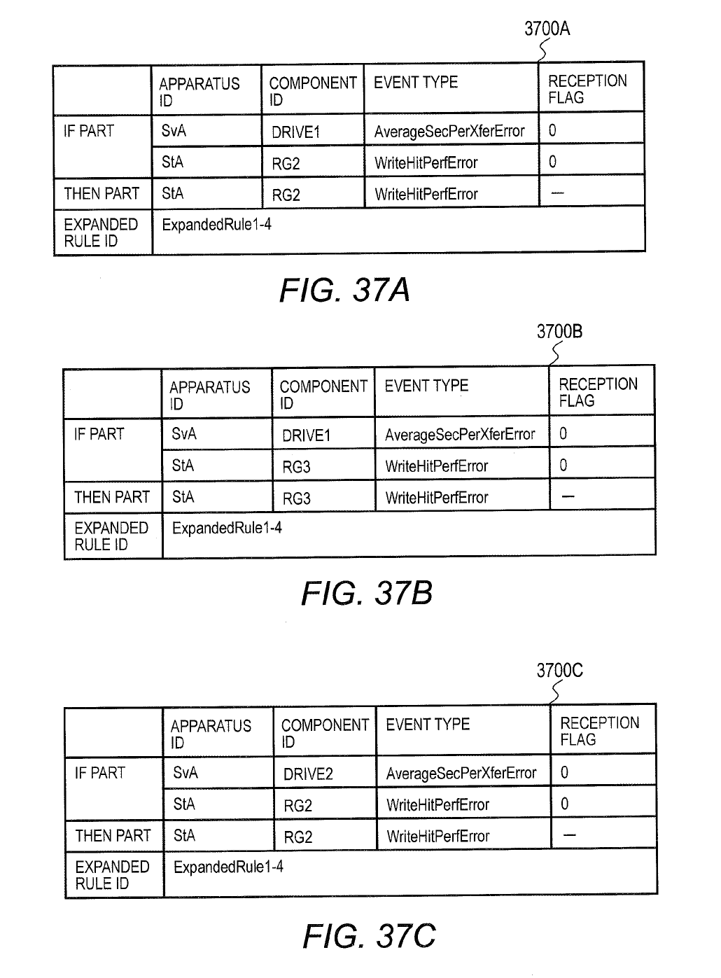

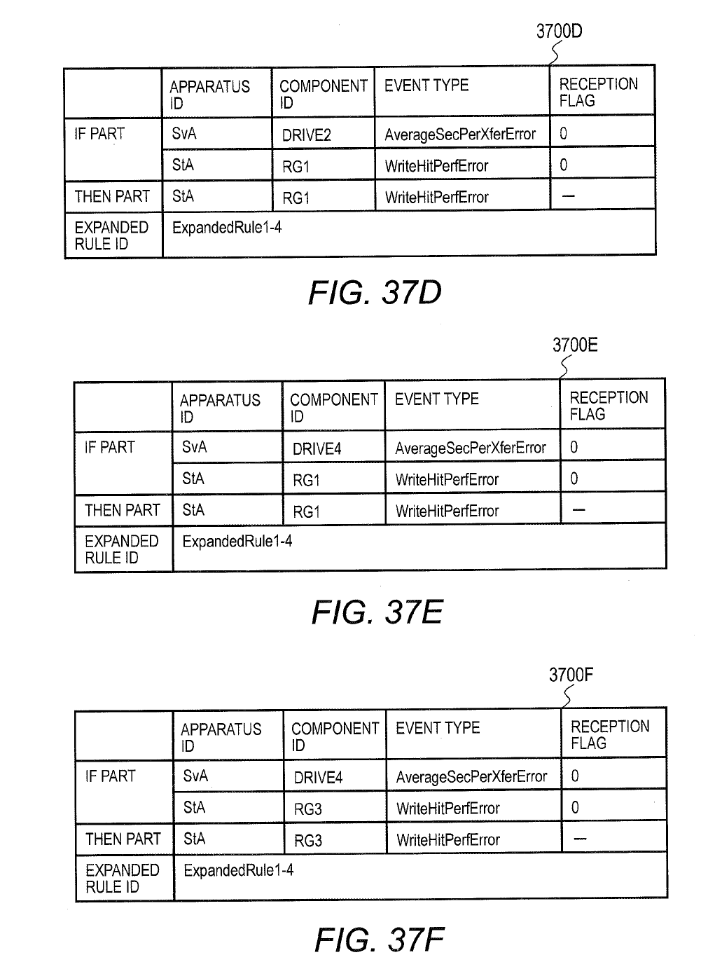

Moreover, for example, if expanded rules are generated by using the topology acquisition method (d) from the metarule 300, all combinations of a RAID group and a disk drive coupling via FC switches to a storage and mounting an external volume are acquired to generate expanded rules. Therefore, a total of nine expanded rules including expanded rules illustrated in FIGS. 37A to 37F in addition to the expanded rules illustrated in FIGS. 17A to 17C are generated.

The expanded rules illustrated in FIGS. 37A to 37F include descriptions of combinations of events which may not occur in an actual management subject system, and are unnecessary expanded rules. Moreover, if events described in the IF part simultaneously occur by any chance, a wrong cause candidate is presented as a cause candidate having an event reception rate of 100%, and a wrong influence range of the failure is presented. Thus, a higher priority can be set to the method (a) of acquiring topologies appropriate as a range to which a metarule is applied, and the method (a) can be presented to the rule creator. Therefore, the accuracy can increase by using occurring patterns.

In this example, a description is given of the five methods of determining priorities. Only one of them may be used, or a plurality of them may be combined to present the priority of each of the methods to the rule creator. Moreover, values of the priorities calculated by the respective methods may be added to or multiplied by each other into a comprehensive priority.

Moreover, in this example, the priorities of the topology acquisition methods are determined in correspondence to an input carried out once by the rule creator to generate one metarule, but other events having the same management object type and event type may be input multiple times for one metarule. Then, a characteristic common to patterns of topology represented by all combinations of the influence events and the cause events may be extracted to determine the priorities of the topology acquisition methods associated with the metarule, thereby increasing the accuracy of the priority.

Moreover, in this example, one method of acquiring topologies from an influence management object to a cause management event where these objects constitute a combination is determined. Alternatively, priorities of a plurality of topology acquisition methods which are candidates may be recorded, occurred failure events may be used starting from a failure event having the highest priority to acquire topology information, and if the topology information cannot be acquired by a certain method, a method having a next highest priority may be used.

Moreover, in this example, the priority of each of the topology acquisition methods is presented to the rule creator, but a method highest in priority may be automatically determined as a method to be associated with the metarule.

Moreover, in this example, the information on all topologies which can be taken between the cause management object and the influence management object and topology acquisition methods corresponding to the topologies are derived by the topology search processing, and priorities are determined. In contrast, the search processing may be interrupted when the topology information and the topology acquisition method being searched for become lower in priority than an already derived topology acquisition method.

As described above, according to the third example of this invention, the priorities can be set to the topology acquisition methods, and the set priorities can be presented to the rule creator, thereby assisting the rule creator in selecting a topology acquisition method to be associated with a metarule, resulting in reduction in an operation cost.

While the present invention has been described in detail and pictorially in the accompanying drawings, the present invention is not limited to such detail but covers various obvious modifications and equivalent arrangements, which fall within the purview of the appended claims.

What is claimed is:

1. A management computer for monitoring a plurality of node apparatus, comprising:
a processor; and
a storage resource, wherein:
the storage resource stores configuration information on a component included in each of the plurality of node apparatus, the configuration information including a type of the component;
the each of the plurality of node apparatus and the component are managed as a management object; and
the processor is configured to:
receive an input of a combination of information for identifying a first management object relating to a first failure estimated as a cause and a type of the first failure, and an input of a combination of information for identifying a second management object relating to a second failure estimated to be caused by the first failure and a type of the second failure;
acquire information on a type of the first management object and information on a type of the second management object;
trace association from the type of the second management object to the type of the first management object;
generate a metarule including a condition part including at least one condition element determined by a combination of a type of the management object and a type of the failure and a conclusion part including a combination of a type of the management object estimated as the cause and a type of the failure;
generate a method of acquiring information on a topology constructed by the association from the type of the second management object to the type of the first management object based on a method of the trace from the type of the second management object to the type of the first management object;
acquire the information on the topology based on the generated method;
generate an expanded rule from the generated metarule and the acquired information on the topology; and
analyze, in case where a new failure is detected, the detected new failure based on the generated expanded rule.

2. The management computer according to claim 1, wherein:
the storage resource stores information on a method of acquiring association information between types of the management object; and
the processor is configured to:
receive, when the processor receives the input of the combination of the information for identifying the management object and the type of the failure, management object identification information as information for identifying the management object; and
trace the association based on the information on the method of acquiring the association information between the type of the first management object and the type of the second management object when the association is traced from the type of the second management object to the type of the first management object.

3. The management computer according to claim 1, wherein the processor receives the type of the management object as the information for identifying the management object when the processor receives the input of the combination of the information for identifying the management object and the type of the failure.

4. The management computer according to claim 1, wherein:
the storage resource stores information on history of a failure occurred before; and
when the processor requests the input of the combination of the information for identifying the management object and the type of the failure, the processor generates data for displaying topology information including the management object and the failure occurred during a specified period.

5. The management computer according to claim 4, wherein the processor is configured to:
generate data for displaying the failure occurred before included in the information on the history of the failure stored in the storage resource;
receive an input of one of the first failure and the second failure selected from the displayed failure; and
generate data for displaying a failure occurred in a predetermined period before and after a time point when one of the input first failure and second failure occurred as the failure occurred in the specified period.

6. The management computer according to claim 1, wherein the processor is configured to:
acquire entire information on all topologies which are acquirable from the configuration information by means of the generated method of acquiring the information on the topology;
generate, from the generated metarule, expanded rules corresponding to all the topologies from which the information is acquired; and
generate data for displaying at least one of the generated expanded rules or a number of the expanded rules.

7. The management computer according to claim 1, wherein:
the storage resource stores information on history of a failure occurred before, and history of configuration information on the management object; and
the processor is configured to:
acquire a third failure representing occurrence of the first failure on the first management object and a fourth failure representing occurrence of the second failure on the second management object in a predetermined period before and after a date and time of occurrence of the third failure;
acquire topology information from the history of the configuration information of a time point when one of the third failure and the fourth failure occurred based on the generated method of acquiring the information on the topology;
determine whether one of the management object identification information on a management object on which the fourth failure occurred and the management object identification information on a management object on which the third failure occurred is included in the acquired topology information; and
generate data for displaying information on the third failure and the fourth failure based on a result of the determination.

8. The management computer according to claim 1, wherein the processor is configured to:
evaluate each of the generated plurality of the methods based on a predetermined criteria based on a characteristic of failure analysis in case where a plurality of the methods of acquiring the information on the topology are generated; and
determine a priority of the each of the plurality of the methods based on a result of the evaluation.

9. The management computer according to claim 8, wherein the processor determines, based on the information on the topology acquired by each of the plurality of the methods of acquiring the information on the topology, the priority of the each of the plurality of the methods.

10. The management computer according to claim 8, wherein:
the storage resource stores a multiplicity of the association between types of the management object; and
the processor determines the priority of the each of the plurality of the methods based on the multiplicity of the association between the types of the management object included in the topology having the information acquirable by the each of the plurality of the methods of acquiring the information on the topology.

11. The management computer according to claim 8, wherein:
the storage resource stores information on a layer of the association between types of the management object; and
the processor determines the priority of the each of the plurality of the methods based on the layer of the association between the types of the management object included in the topology having the information acquirable by the each of the plurality of the methods of acquiring the information on the topology.

12. The management computer according to claim 8, wherein the processor determines the priority of the each of the plurality of the methods based on a coincidence degree with a method of acquiring information on a topology already used.

13. The management computer according to claim 8, wherein:
the storage resource stores information on history of a failure occurred before, and history of the configuration information on the component; and
the processor is configured to:
acquire a third failure representing occurrence of the first failure on the first management object and a fourth failure representing occurrence of the second failure on the second management object in a predetermined period before and after a date and time of occurrence of the third failure;
acquire, based on the generated method of acquiring the information on the topology, topology information from the history of the configuration information of a time point when one of the third failure and the fourth failure occurred; and
determine the priority of the each of the plurality of the methods based on one of a relationship between the management object identification information on a management object on which the fourth failure occurred and the management object identification information included in the acquired topology information and a relationship between the management object identification information on a management object on which the third failure occurred and the management object identification information included in the acquired topology information.

14. A method of generating a rule so as to detect a failure in a management computer for monitoring a plurality of node apparatus,
the management computer including a processor and a storage resource,
the storage resource storing configuration information on a component included in each of the plurality of node apparatus, the configuration information including a type of the component,
the each of the plurality of node apparatus and the component being managed as a management object,
the method including steps of:
receiving, by the processor, an input of a combination of information for identifying a first management object relating to a first failure estimated as a cause and a type of the first failure, and an input of a combination of information for identifying a second management object relating to a second failure estimated to be caused by the first failure and a type of the second failure;
acquiring, by the processor, information on a type of the first management object and information on a type of the second management object;
tracing, by the processor, association from the type of the second management object to the type of the first management object;
generating, by the processor, a metarule including a condition part including at least one condition element determined by a combination of a type of the management object and a type of the failure and a conclusion part including a combination of a type of the management object estimated as the cause and a type of the failure;
generating, by the processor, based on a method of the trace from the type of the second management object to the type of the first management object, a method of acquiring information on a topology constructed by the association from the type of the second management object to the type of the first management object;
acquiring, by the processor, the information on the topology based on the generated method; and
generating, by the processor, an expanded rule from the generated metarule and the acquired information on the topology.
